(19) United States
(12) Patent Application Publication
(10) Pub. No.: US 2021/0000283 A1
(43) Pub. Date: Jan. 7, 2021

(54) BEVERGE MAKER WITH CARTRIDGE RECOGNITION

(71) Applicant: COFFEE SOLUTIONS LLC, PORTLAND, OR (US)

(72) Inventor: Bruce D. Burrows, Valencia, CA (US)

(21) Appl. No.: 16/980,744

(22) PCT Filed: Mar. 15, 2019
(86) PCT No.: PCT/US19/22498

§ 371 Date: Sep. 14, 2020

Related U.S. Application Data
(63) Continuation of application No. 15/922,772, filed on Mar. 15, 2018, now abandoned.

(51) Int. Cl. A47J 31/02; A47J 31/44

(52) U.S. Cl. CPC A47J 31/02; A47J 31/4492

(57) ABSTRACT

Aspects of the present disclosure comprise methods and apparatuses for cartridge recognition within beverage systems. Such recognition may be done with various topologies and/or materials used in manufacture of the beverage cartridge, as well as monitoring the cartridge for changes in successive uses of the cartridge, to avoid counterfeiting and/or spoofing of the beverage system.

### CROSS REFERENCE TO RELATED APPLICATIONS

The present application claims the benefit of U.S. Provisional Application Ser. No. 62/471,912, filed on 15 Mar. 2017 and entitled “Beverage Maker with Cartridge Recognition”, and U.S. Provisional Application Ser. No. 62/486,838, filed on 18 Apr. 2017, entitled “Beverage Maker with Cartridge Recognition”.

The present application is also a continuation-in-part of U.S. application Ser. No. 15/056,131, filed 29 Feb. 2016, a continuation-in-part of U.S. application Ser. No. 15/549,106, filed 4 Aug. 2017, which is a national stage application of App. No. PCT/US2016/016884, filed 5 Feb. 2016, and a continuation-in-part of U.S. application Ser. No. 15/516,894, filed 5 Apr. 2017, which is a national stage application of App. No. PCT/US2015/054312, filed 6 Oct. 2015.

The disclosures, figures, and subject matter of the above-identified patent applications are expressly fully incorporated by reference herein in their entirety.

### BACKGROUND OF THE DISCLOSURE

### Field of the Disclosure

The present disclosure generally relates to liquid delivery systems, and more specifically to apparatuses and methods for making crema and/or beverages based on multiple fluids.

### Description of the Related Art

Single serve coffee machines have become popular with consumers. Such machines often utilize cartridges that contain various beverage mediums, e.g., ground coffee beans, tea leaves, chocolate powder, etc., such that a single serving of beverage, e.g., coffee, tea, hot chocolate, etc., can be made using the machine. Such cartridges have found favor with many consumers, because of the ease of use and relatively easy cleanup compared to other brewing machines.

Manufacturers have created entire lines of cartridge products, where each entry in the line may contains different beverage mediums, different types of filters, etc. to provide consumers with a choice of beverages that single serve machines can produce. For example, one cartridge may contain a dark roast coffee beverage medium, while another cartridge may contain a blond roast coffee beverage medium, such that consumers can prepare the type and/or style of beverage they desire.

As such, each entry in the cartridge product line is designed to produce a single style of beverage, such as dark roast coffee, blond roast coffee, etc. Some machines automatically set the parameters of the machine, e.g., brewing time, amount of water, etc., based on a determination of the type of cartridge that is placed in the machine. However, if a consumer has a particular cartridge, such as a dark roast coffee cartridge, the machine may be incapable of producing certain desired beverages from that cartridge. Although there may be some variation of the amount of water that the machine delivers to the cartridge, the consumer cannot override the machine's ability to, for example, increase the temperature and/or decrease the fluid flow to create espresso and/or an espresso-like beverage from a coffee cartridge.

Further, many people have come to enjoy the taste of espresso and/or espresso-like beverages, and such flavors are at least partially based on the froth, or “crema” that is a combination of carbon dioxide and coffee. Many people also add steamed milk, cream, or other liquids to espresso and/or espresso-like beverages to create drinks known as cappuccino, latte, café au lait, tea latte, etc. Consumers would like to produce such beverages at home, but many machines are unable to produce the desired effects on milk, cream, or other liquids that may be added to coffee, tea, or other beverages.

### SUMMARY OF THE DISCLOSURE

Aspects of the present disclosure comprise methods and apparatuses for cartridge recognition within beverage systems. Such recognition may be done with various topologies and/or materials used in manufacture of the beverage cartridge, as well as monitoring the cartridge for changes in successive uses of the cartridge, to avoid counterfeiting and/or spoofing of the beverage system.

An apparatus in accordance with an aspect of the present disclosure comprises

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same or similar purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The accompanying drawings illustrate some embodiments and/or aspects of the present disclosure. In such drawings:

FIG. 1 illustrates a perspective view of one embodiment of a beverage brewer in accordance with an aspect of the present disclosure;

FIG. 2 is a perspective view of an embodiment of a beverage brewer, illustrating a lid of a brewer head in an open position in accordance with an aspect of the present disclosure;

FIG. 3 is an enlarged front view of the brewer head taken about circle 6 in FIG. 2, further illustrating rotation or spinning motion of an inlet nozzle in an aspect of the present disclosure;

FIGS. 4A-4F illustrate a beverage cartridge and/or brewer head that may be employed with the beverage brewer in an aspect of the present disclosure;

FIG. 4G illustrates a pump in accordance with an aspect of the present disclosure;

FIG. 5 is a cross-sectional view of the brewer head taken about the line 7-7 in FIG. 2, in accordance with an aspect of the present disclosure;

FIG. 6 is a schematic view of one embodiment of a beverage system according to an aspect of the present disclosure;

FIG. 7 is an exploded view of a flow meter for use with a beverage system according to an aspect of the present disclosure;

FIG. 8 is a cross-sectional view of a flow meter according to an aspect of the present disclosure;

FIG. 9 illustrates an electrical circuit associated with the flow meter in an aspect of the present disclosure.

FIG. 10 illustrates a block diagram in accordance with an aspect of the present disclosure.

FIG. 11 is a diagrammatic view of a microcontroller according to the present disclosure that can operate embodiments of brewing systems according to the present disclosure.

FIG. 12 is a diagram in accordance with an aspect of the present disclosure.

FIGS. 13A-13D illustrate an embodiment of the brewing head in accordance with an aspect of the present invention.

FIGS. 14A-14B illustrate views of the impeller in an aspect of the present disclosure.

FIGS. 15A-15B illustrate an embodiment of the second reservoir in an aspect of the present disclosure.

FIGS. 16A-16F illustrate a cartridge reader in accordance with an aspect of the present disclosure.

FIGS. 17A-17B illustrate a reusable cartridge in accordance with an aspect of the present disclosure.

FIG. 18 illustrates a fluid container in an aspect of the present disclosure.

FIG. 19 illustrates a portion of the system in accordance with an aspect of the present disclosure.

FIG. 20 illustrates a liquid container in accordance with another aspect of the present disclosure.

FIG. 21 illustrates a portion of the system in accordance with an aspect of the present disclosure.

FIG. 22 illustrates a steam generator in accordance with an aspect of the present disclosure.

FIG. 23 illustrates a transducer in accordance with an aspect of the present disclosure.

FIG. 24 illustrates a heat exchanger in accordance with an aspect of the present disclosure.

FIGS. 25A-25C illustrate a jaw control in accordance with an aspect of the present disclosure.

FIG. 26 illustrates a cartridge reader in accordance with an aspect of the present disclosure.

FIG. 27 illustrates a cartridge reader in accordance with an aspect of the present disclosure.

FIGS. 28A-28C illustrate beverage cartridges that may be read by the cartridge reader in an aspect of the present disclosure.

FIG. 29 illustrates an output of a cartridge reader in accordance with an aspect of the present disclosure.

FIGS. 30A-30B illustrate beverage cartridges that may be read by the cartridge reader in an aspect of the present disclosure.

FIG. 31 illustrates a cartridge reader in accordance with an aspect of the present disclosure.

### DETAILED DESCRIPTION

For coffee machines (“coffee makers”), some of the most consumed beverages, e.g., brewed coffee, have many different devices employed in consumer homes. Percolators, drip machines, pod machines, presses, and other types of small appliances are often used. These machines allow for some variation in brewing characteristics for individual consumers, e.g., different amounts or types of coffee, different amounts or temperatures of water used in brewing, and different techniques to attempt to extract various flavors from coffee, tea, or other brewing materials. Although the discussions herein are mostly directed to the brewing or other methods of brewing coffee, similar methods may be applied to tea, soup, or other beverages or foods within the scope of the present disclosure. The use herein of a specific beverage material, e.g., ground coffee beans, and a specific type of extraction, e.g., brewing, to assist in the explanation of aspects of the present disclosure does not limit the use, scope, and/or breadth of the present disclosure in the beverage production industry or in any other industry where similar controls or machines may be employed.

More recently, individual servings of coffee in sealed containers have been used with small specialty brewing devices, which may be referred to as “single-serve brewing machines” or “single-serve brewers” to more closely approximate flavors from commercial grade machines. These machines also allow for quick preparation of single servings of coffee or other beverages. Further, the sealed containers allow for easy clean-up after brewing as the coffee grounds are confined within the container after brewing.

Because these single-serve brewing machines are becoming more popular, consumers are attempting to utilize a wider range of materials in the sealed containers. The single-serve brewing machines in the related art are often not capable of this wider range of materials, and, as such, are limited to the types and/or materials provided by certain manufacturers that are solely provided by specific manufacturers.

Further, consumers would like to use their own materials in single-serve brewing machines, where a reusable container may be employed and filled with brewing materials of the consumer's choosing. However, single-serve machines in the related art often do not accept these containers, are not provided with enough capability to determine the type of material the consumer is using, are not equipped to handle variances in user-provided cartridges, and/or are not user-programmable to enable the single-serve brewing machines to vary the characteristics or functions performed by the single-serve brewing machines to process the consumer-selected material in an appropriate fashion.

As described above, many people use single-serve coffee brewers to brew more than one cup of coffee in close succession. As such, measurement of fluid (e.g., water) flow may be important, not only for multiple cup brewing, but also for single-serve beverages. If too much water is used in a brew cycle, the beverage may be too weak; if too little water is used, the beverage may be too strong. If the water is not delivered at the proper rate, the beverage may have different taste characteristics, e.g., bitter, acrid, etc., than if the water were delivered at the proper rate during brewing.

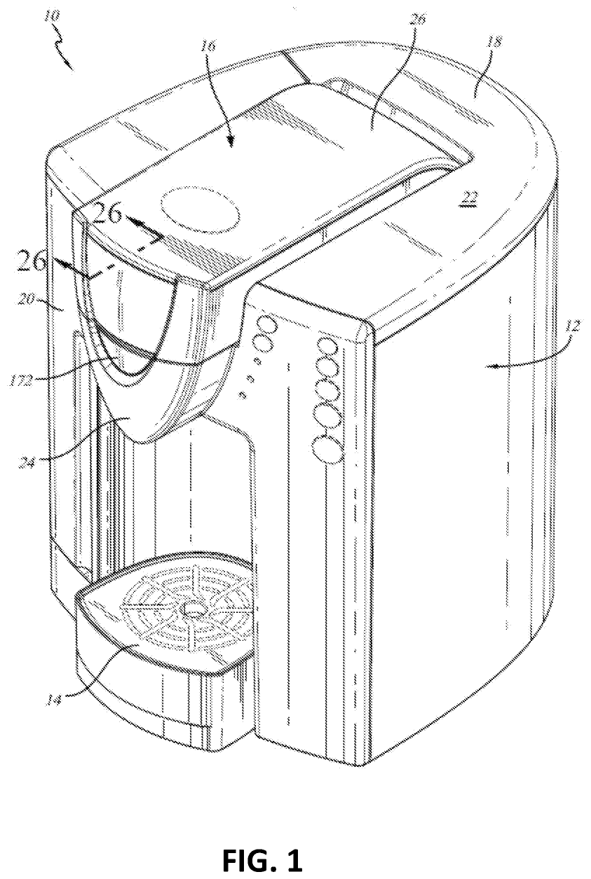

FIG. 1 illustrates a perspective view of one embodiment of a beverage brewer in accordance with an aspect of the present disclosure.

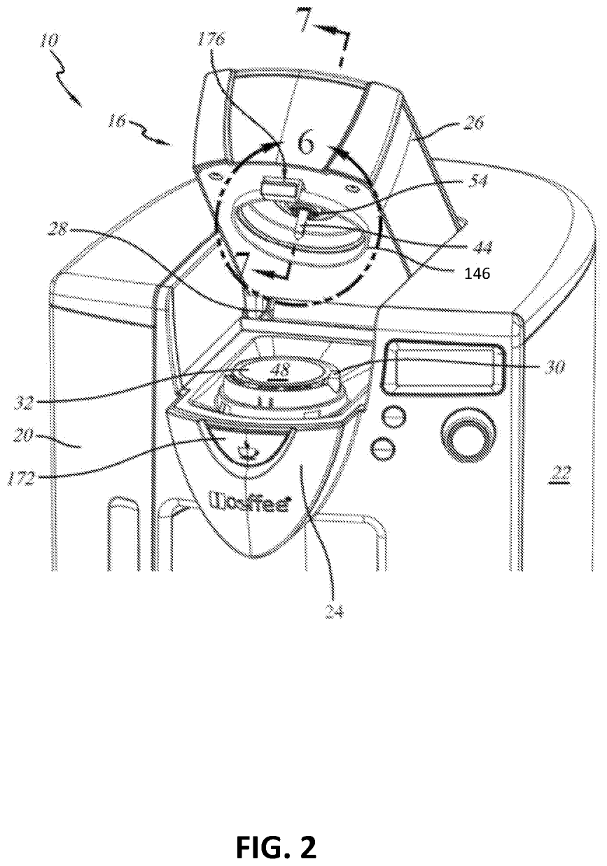

A beverage brewer 10, as shown in FIGS. 1 and 2, may be designed for use with container-based beverage cartridges, such as single-serve coffee cartridges. The beverage brewer 10 may include a generally upright housing 12 having a base or platen 14 extending out at the bottom and positioned generally below an outwardly extending brewer head (also referred to as a “beverage head” herein) 16. The vertical distance between the platen 14 and the brewer head 16 (also referred to as a “brew head 16” or a “beverage head 16” herein) can adequately accommodate a coffee mug or other external receptacle for delivery of the beverage from the beverage brewer 10.

In some aspects of the present disclosure, the receptacle may be capable of retaining at least 6 oz. of beverage, and possibly 10 oz. or more of beverage. The housing 12 may further comprise a rear housing 18 having a gravity-fed and/or other type of water reservoir 20 on one side and an outer shell 22 that houses or protects the internal features of the beverage brewer 10, including, for example, a conduit system between the water reservoir 20 and the brewer head 16. Such features within the housing 12 of the beverage brewer 10 may generally include a fluid conduit system, a pump, and/or a heating element, in order to deliver a fluid from the reservoir 20 (or other source) to the brewer head 16 and/or to the receptacle external to the beverage brewer 10.

FIG. 2 is a perspective view of a beverage brewer, illustrating a lid of a brewer head in an open position (also referred to as a first position, second position, and/or access position herein) in accordance with an aspect of the present disclosure.

As shown in FIG. 2, the brewer head 16 may be a clam-shell structure including a stationary lower support member 24 and a movable upper member or lid 26 that pivots relative to the lower support member 24 about a hinge 28. The scope of the present disclosure includes embodiments where the lower support member 24 and the lid 26 may both be movable, or that the lower support member 24 may be movable relative to a stationary lid 26. Additionally, the lower support member 24 and/or the lid 26 may pivot or rotate about the common hinge 28, or separate hinges or points within the beverage brewer 10.

The lower support member 24 and the lid 26 are selectively opened and closed and form a brew chamber there between during a brew cycle (also known as a preparation cycle) for selective retention of a beverage cartridge 32 in a receptacle 30 of the brewer head 16. The beverage cartridge 32 may include any liquid medium known in the art, including, but not limited to, liquid and/or beverage medium used to form various types of coffee, espresso and/or an espresso-like beverage, tea, hot chocolate, lemonade and other fruit-based drinks, carbonated drinks such as soda, soups and other liquid foods, etc.

In this respect, FIG. 1 illustrates the lid 26 engaged with the lower support member 24 such that the brewer head 16 is in the closed or locked position (also referred to as a brewing position, first position, and/or second position herein). A jaw lock 176 includes an externally accessible release button 172 which may be at or near the brewer head 16 and configured for hand manipulation. To open the brewer head 16, a user presses or otherwise activates the release button 172. Activation of the release button 172 selectively disengages the jaw lock 176 when the brewer head 16 is in the closed position shown in FIG. 1. Once the release button 172 is pressed, so long as the brewer head 16 is not in a preparation cycle or other operational mode that prevents opening of the brewer head 16, the lid 26 is able to pivot away from the lower support member 24 which allows access to the receptacle 30. In the position shown in FIG. 2, a user may selectively insert or remove a beverage cartridge 32.

To close the brewer head 16, the user may again activate the release button 172, and/or may push on the lid 26 to move the lid 26 closer to the lower support member 24. If the beverage brewer 10 senses a beverage cartridge 32 in the receptacle 30, or upon a user initiating closure of the lid 26 and/or a preparation cycle, the jaw lock 176 may selectively lock during a brew cycle and/or preparation cycle to prevent any liquid delivered by the beverage brewer 10 from being expelled by the beverage brewer 10 external to the receptacle located proximate to the platen 14. In this respect, the contact between the lower support member 24 and the jaw lock 176 selectively holds the brewer head 16 closed as shown in FIG. 1.

The beverage brewer 10 also comprises an inlet nozzle 44 that generally extends downwardly out from underneath the lid 26, as shown within the brewer head 16. The inlet nozzle 44 is coupled to, e.g., in fluid communication with, a conduit system, e.g., the pump 112, for injecting at least a first fluid, such as turbulent or laminar hot water and steam, a liquid such as water and/or milk, or other gas and/or other liquid in a fluid or semi-fluid form, into the beverage cartridge 32 through the inlet nozzle 44. Although described as the inlet nozzle 44 herein, the inlet nozzle 44 may be a needle, spine, spout, spigot, jet, projection, spike, and/or other inlet means for delivering the at least first fluid to a beverage medium 78.

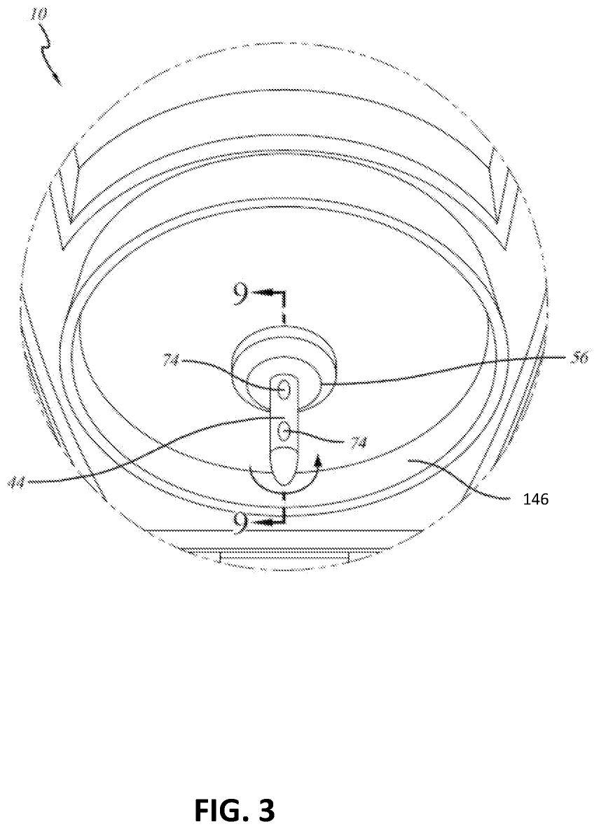

FIG. 3 is an enlarged front view of the brewer head taken about circle 6 in FIG. 2, further illustrating rotation or spinning motion of an inlet nozzle in an aspect of the present disclosure.

As mentioned above, to prepare the beverage brewer 10 for a brew cycle (also referred to a preparation cycle), the lid 26 is moved from a closed position (shown in FIG. 1) to an open position (shown in FIG. 2). When in an open or first position, the beverage cartridge 32 can be inserted into and/or removed from the receptacle 30. The receptacle 30 is configured to selectively receive and accept the beverage cartridge 32 within the receptacle 30 of the brewer head 16 when the brewer head 16 is in the open position shown in FIG. 2. The beverage cartridge 32 generally comprises a sealed container including an outer surface and an inner volume or chamber, although the beverage cartridge 32 can also include unsealed containers. A beverage medium 78, such as coffee, tea, soup, chocolate, etc., is contained within the inner volume of the beverage cartridge 32.

The lid 24 of the beverage brewer 10 may comprise an encapsulation cap 146 having a diameter sized for at least partial slide-fit insertion over the receptacle 30 to encapsulate and retain the beverage cartridge 32 there between. The beverage cartridge 32 may thus be held in a substantially stationary position with respect to the beverage brewer 10 while the brewer head 16 is in the closed position, although it is understood that the beverage cartridge 32 can be held in a substantially stationary position via other means, and/or can be non-stationary.

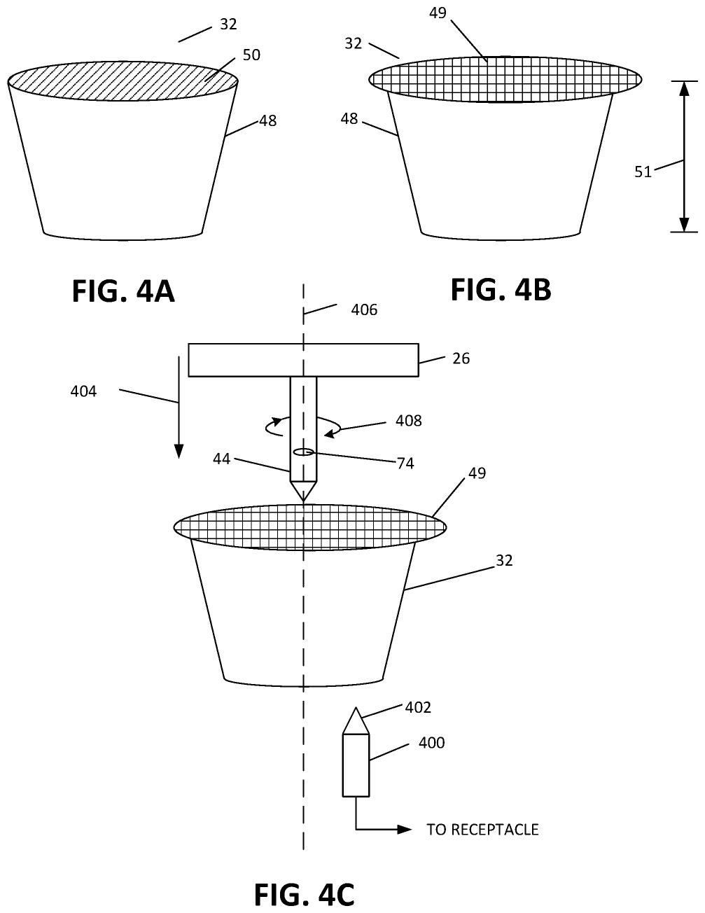

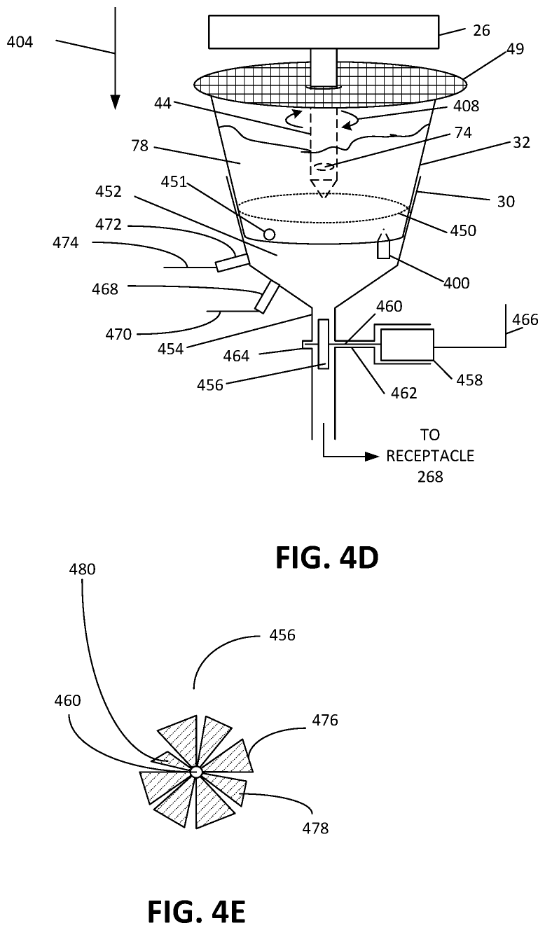

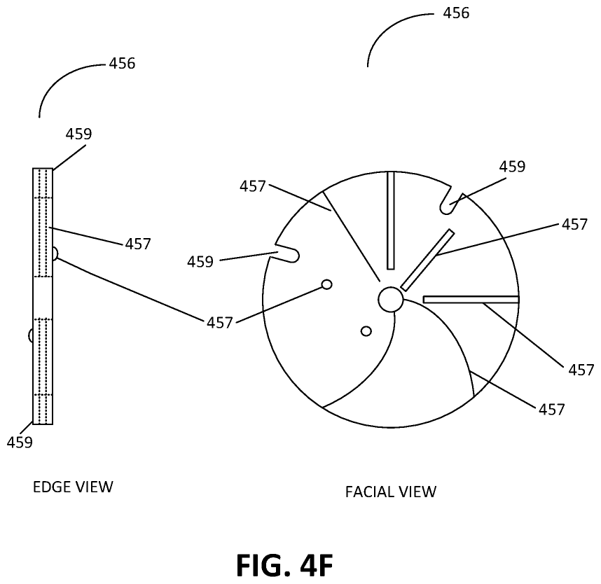

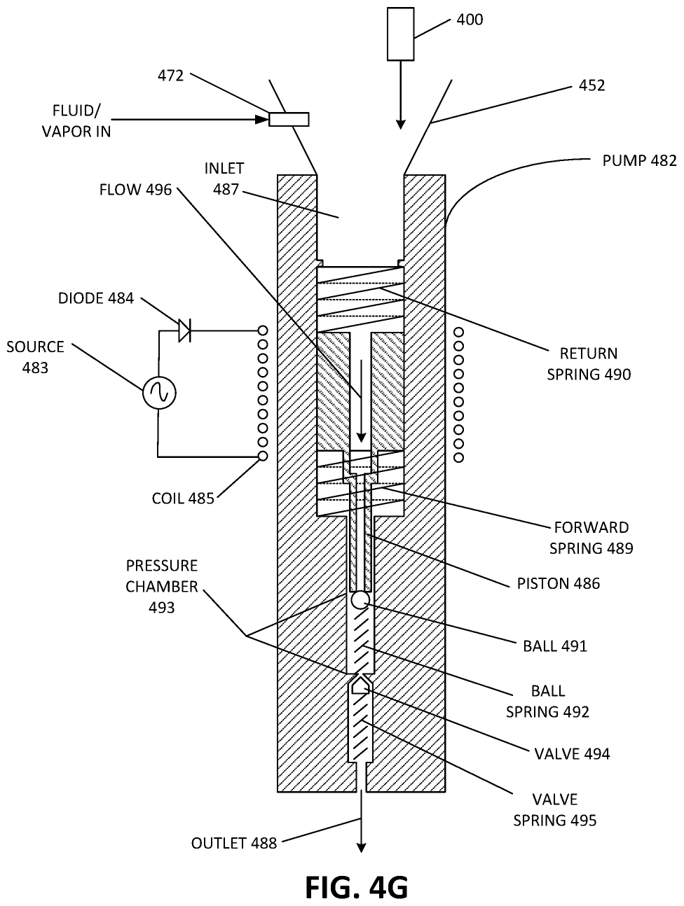

FIGS. 4A-4D illustrate a beverage cartridge and/or brewer head that may be employed with the beverage brewer in an aspect of the present disclosure.

It is understood that a beverage cartridge, such as the beverage cartridge 32, is not required for operation of systems and methods according to the present disclosure. A beverage cartridge 32 may be employed within an aspect of the present disclosure. Further, other types of containers or uncontained mediums can also be used in embodiments of the present disclosure, such as soft pods, sealed or unsealed packets containing a liquid medium (e.g., coffee grounds), tea bags, grounds or leaves, etc. Beverage cartridge 32 may allow for easier brewing or making of beverages. Beverage cartridge 32 may comprise an outer surface 48 and an inner chamber 50. Beverage medium 78 may be contained or otherwise located within the inner chamber 50 (also referred to as an inner volume herein) of the beverage cartridge 32. Other features, such as a filter, etc., may also be included in the inner chamber 50 of the beverage cartridge 32, to filter coffee grounds, tea leaves, etc., that may be part of the beverage medium 78 not desired in a final beverage or liquid.

FIG. 4A illustrates an open or exposed inner chamber 50. As shown in FIG. 4B, beverage cartridge 32 may also comprise a cover 49. Cover 49 may comprise foil or other material to seal the beverage cartridge 32 from external environments that may be deleterious to the beverage medium 78 in the inner chamber 50. As such, beverage cartridge 32 may be sealed against air, water, or other external hazards until one or more entry points are made to access the inner chamber 50. Beverage cartridges 32, such as those that comprise a cover 49 and/or comprise one or more sealed inner chambers 50, may use a needle or other instrument, such as inlet nozzle 44, to direct a fluid into and/or out of the inner chamber(s) 50 of the beverage cartridge 32. Beverage cartridge 32 also comprises a height 51, also referred to as a vertical height herein. It is understood that while the beverage cartridge 32 is a sealed container, many different types of cartridges and/or mediums can be used.

FIG. 4C illustrates an aspect of the present disclosure where the beverage cartridge 32 is accessed by the inlet nozzle 44 and/or the outlet conduit 400. The outlet conduit 400 is coupled to the brewer head 16, and is selectively coupled to the beverage cartridge 32 when the brewer head 16 is in a certain position. The outlet conduit 400 can comprise a point 402 that, when the lid 26 is pushed downward toward the lower support member 24 or the lid 26 is otherwise closed as shown by arrow 404, the beverage cartridge 32 is pressed onto the point 402 (and/or vice versa), and the outlet conduit 400 now has access to the inner chamber 50 of the beverage cartridge 32. Alternatively, the beverage cartridge 32 may be pressed onto the point 402 upon user placement of the beverage cartridge 32 into the brewer head receptacle 30. Many different embodiments are possible within the scope of the present disclosure, and it is also contemplated that an outlet conduit according to the present disclosure can access a medium, such as a medium within a beverage cartridge, with or without a point 402.

The lid 26 can be pushed downward toward the lower support member 24 such that the inlet nozzle 44 is placed proximate the beverage medium 78, and in some embodiments, at least below a level of the height 51 of the beverage cartridge 32. In one such system and method according to the disclosure, the lid 26 is pushed downward toward the lower support member 24 and/or is closed, e.g., such that the lid 26 is locked and/or otherwise sealed against the lower support member 24. In embodiments where the beverage medium 78 is contained in a soft pod, bag, filter, or other device where beverage cartridge 32 is not used, the inlet nozzle 44 may be placed proximate to the beverage medium 78 to direct the fluid from the flow port 74 toward the beverage medium 78. In embodiments where the beverage cartridge 32 comprises a cover 49, the inlet nozzle 44 may pierce the beverage cartridge 32 through the cover 49 and/or through another portion of the outer surface 48, which provides the flow port 74 with access to the inner chamber 50 of the beverage cartridge 32. Where the beverage cartridge 32 is open, e.g., does not comprise cover 49 or the beverage medium is otherwise accessible to the inlet nozzle 44 without breaking or puncturing beverage cartridge 32, the inlet nozzle 44 may be placed proximate to the beverage medium 78 in the beverage cartridge 32. The proximate placement of inlet nozzle 44 to the beverage medium 78 includes the inlet nozzle 44 being partially or fully immersed in the beverage medium 78 as well as being maintained at a level above and/or near the beverage medium 78, whether or not the beverage medium 78 is contained in a beverage cartridge 32. In an aspect of the present disclosure, the inlet nozzle 44 pierces the beverage cartridge 32 approximately on a center line 406 of the beverage cartridge 32, e.g., through the cover 49, although it is understood that, in other embodiments, an inlet nozzle 44 may puncture the beverage cartridge 32 in off-center locations or other locations of the outer surface 48 of the beverage cartridge 32. At a desired time, the inlet nozzle 44 may be rotated as shown by arrow 408 while coupled to the inner chamber 50. In such situations, the beverage cartridge may be substantially stationary with respect to the beverage brewer 10, as motion of both the inlet nozzle 44 and the beverage cartridge 32 may result in fluid from the beverage cartridge 32 being directed somewhere other than the outlet conduit 400. However, in other embodiments, it may be desirable to move both the inlet nozzle 44 and the beverage cartridge 32, e.g., simultaneously. Embodiments are also envisioned where only the beverage cartridge moves. For many applications, delivery of fluid from the beverage cartridge somewhere other than outlet conduit 400 is undesired.

FIG. 4D illustrates a beverage cartridge 32 when the brewer head 16 is in a closed position. The inlet nozzle 44 pierces the cover 49 of the beverage cartridge 32, as lid 26 is closed, i.e., moved in the direction of arrow 404. Inlet nozzle optionally rotates or otherwise moves as shown by arrow 408. As part of inlet nozzle 44, flow port 74 is also inserted into the beverage cartridge 32 such that fluid from heater tank 160, or other locations within brewing system 10, may be delivered to beverage cartridge 32. Further, flow port 74 and/or inlet nozzle 44 may be inserted into the beverage medium 78.

As shown in FIG. 4D, beverage medium 78 may be contained in only a portion of beverage cartridge 32, separated by a filter 450 which acts as a screen or sieve to filter out any portions of beverage medium 78 (e.g., coffee grounds, tea leaves, etc.) that may be undesired in the final beverage delivered to the receptacle 268 (e.g., mug, cup, etc.) for consumption.

### Crema Extraction

In an aspect of the disclosure, the receptacle 30, as part of the brewer head 16, may have a second portion 452 that is shaped to deliver the fluid from the beverage cartridge 32 through a conduit 454 before delivering the fluid to receptacle 268. In the embodiment shown, the conduit 454 can be pressurized and/or substantially sealed when the system 10 is operating. Within at least a portion of conduit 454, and possibly extending into second portion 452 of receptacle 30, may be an impeller 456, coupled to motor 458 via shaft 460. It is understood that devices other than impellers, including but not limited to other members designed to rotate about a shaft and/or shaft end, can be used without departing from the scope of the present disclosure. Shaft 460 may run through a sleeve 462 to connect the impeller 456 to motor 458, such that motor 458 may be located at other locations within system 10. As shown in FIG. 4D, motor 458 may also be located proximate or even within conduit 454 without departing from the scope of the present disclosure.

Shaft 462 may also extend through impeller 456 to a bearing race 464 or similar. Bearing race 464 may not be used in system 10 if the design of system 10 is such that impeller 456 may rotate substantially along the axis or otherwise within conduit 454 without damage to impeller 456 and/or conduit 454. However, bearing race 464 may be desirable if shaft 460 is a flexible shaft and/or if motor 458 is placed at a location more distant from conduit 454 than that shown in FIG. 4D. Motor 458 may be a physical motor, or may be another motor (such as motor 52 that is coupled to inlet nozzle 44) coupled to impeller 456 via shaft 460, gears, or other mechanical and/or electrical attachments to impeller 456.

System 10, as fluid exits cartridge 32 through outlet conduit 400, may energize motor 458 through wire 466. Energizing motor 458 may be performed as a timed sequence after inlet nozzle 44 begins spinning or otherwise moving by a sensor 468 coupled or read through wire 470 that senses fluid in the second portion 452 of receptacle 30, or by other methods without departing from the scope of the present disclosure. As motor 458 (or other device employed to turn impeller 456) is energized, fluid (i.e., the beverage fluid) flowing through conduit 454 is aerated and/or otherwise infused with gaseous molecules (e.g., oxygen, carbon dioxide, nitrogen, and/or other gasses), and/or takes entrained gaseous molecules out of the liquid solution, prior to delivery of the beverage fluid to receptacle 268. As such, a crema for espresso and/or an espresso-like beverage or coffee, froth for milk or latte, or other types of aeration of beverage fluid may be created by system 10.

Impeller 456 may be operated at different speeds, times of the preparation cycle, and/or durations depending on several factors. For example, and not by way of limitation, system 10 may be programmed to operate impeller 456 at a given speed (e.g., 8000 revolutions per minute) for a given amount of time (e.g., 10 seconds) at a given portion of the preparation time (e.g., the first and/or final ten seconds of a 45 second espresso and/or espresso-like beverage preparation). The system may also be programmed to operate at a different speed, time, and/or duration for a different beverage medium or different desired beverage (e.g., 6000 rpm for the final 15 seconds of a one minute tea latte preparation). The programmed speeds, times, and durations may also be user-programmed or overridden by user input to provide a beverage that is more desirable to a specific user. The system 10 may also be programmed, either automatically or by the user, to store the user inputs and/or overrides such that the user is not required to re-enter the overrides for each preparation cycle.

As such, in an aspect of the present disclosure, system 10 may include impeller 456 that selectively provides aeration of the beverage fluid. By selectively controlling the speed, duration, and time that the impeller is operated during the preparation cycle, various different textures, qualities, and/or beverage consistencies may be created in a consistent manner by system 10. Further, a separate fluid inlet 472, coupled via conduit 474, may provide additional fluid to second portion 452 of receptacle 30 to assist in cleaning impeller 456 and/or conduit 454, as well as second portion 452 if desired. Fluid inlet 472 may be coupled to the outlet of heater 160, pump 112, or otherwise. For example, and not by way of limitation, heater 160 may provide a burst of steam or hot water at or near the end of the preparation cycle to clean second portion 452, conduit 454, and/or impeller 456 as desired.

In an aspect of the present disclosure, fluid from inlet nozzle 44 introduces heated liquid (e.g., water) to a beverage medium 78 in cartridge 32. If the beverage medium 78 is coffee grounds, then the temperature of the fluid (water) from inlet nozzle 44 releases a solute (e.g., oils) from the coffee that is mixed with the water, along with carbon dioxide and/or other byproducts. It is understood that with other beverage mediums, other solutes and/or products may be formed. Under higher temperature and/or pressure, e.g., when making espresso and/or an espresso-like beverage, different concentrations of the solute, and/or different types of solutes are released from the coffee grounds, along with the possibility of additional carbon dioxide and/or other gasses and/or byproducts released from the combination of heated water, pressure, and coffee grounds.

Some or all of the carbon dioxide (illustrated as bubble 451 in cartridge 32) may dissolve or otherwise return to solution upon passing through outlet conduit 400 and into second portion 452 of receptacle 30. As the solution passes through conduit 454 and is aerated and/or otherwise stimulated by impeller 456, the carbon dioxide and/or other gasses are either introduced to the solution and/or are again separated from the solution, creating a crema and/or froth as a portion of the solution (i.e., beverage) that is delivered to receptacle 268. Depending on how and/or when the impeller 456 is selectively energized by system 10, different types of crema, i.e., a “top-off” crema made at or toward the end of a preparation cycle, a crema or froth that is created throughout the preparation cycle, and/or other types of froth or crema may be made without departing from the scope of the present disclosure.

Impeller 456 is shown in side view in FIG. 4E. Shaft 460 is shown central to impeller 456, with blades 476-480 of impeller shown. A larger or smaller number of blades 476-480 are possible within the scope of the present disclosure.

Blades 476-480 are shown as being of different dimensions and/or different widths, lengths, and or pitch with respect to the flow of fluid that impeller 456 may encounter, although it is understood that the blades 476-480 could be the same or similar to each other without departing from the scope of the present disclosure. For example, and not by way of limitation, the length of blade 480, shown as less than the length of blade 476, may provide additional aeration or removal of gasses and/or other solutes from the fluid 480. Any number of impeller 456 designs is possible in various aspects of the disclosure. Impeller 456 may also have curved or roughened surfaces on one or more of the blades 476-480, to allow for more precise control of the aeration and/or removal functions provided by impeller 456.

Further, while the FIG. 4E embodiment is shown as including blades, other impellers are possible. For instance, one example of an embodiment of an impeller according to the present disclosure can be disk-shaped. The outer diameter of such an impeller can also have various shapes, such as serrations and/or other irregularities, which can assist in crema and/or froth production. Such disk-shaped impellers can also, for example, include holes therethrough.

FIG. 4F illustrates another embodiment of an impeller in accordance with the present disclosure.

FIG. 4F illustrates an impeller 456 having one or more grooves 457 that radiate from a low-pressure zone of the impeller 456 to a high pressure zone of the impeller 456. Grooves 457 may take any shape, e.g., radial, curved, etc., and impeller 456 may have multiple grooves 457 as desired. Impeller 456 and/or grooves 457 may also have slots 459 that remove portions of the impeller 456.

As seen in FIG. 4F, grooves 457 may take different shapes, e.g., straight, curved, etc., and may be milled or otherwise removed from the thickness of the impeller 456 and/or may be added to the overall thickness of the impeller 456 and/or deviate from the plane of the impeller 456 and/or the plane of slot 457. Slots 459 may deviate in multiple directions from the plane of the impeller 456. Grooves 457 and/or slots 459 may be arranged to assist in producing crema from the beverage delivered to receptacle 268.

While in the embodiment shown the impeller 456 is horizontally oriented, it is understood that other arrangements are also possible. For example, and not by way of limitation, an impeller 456 according to another aspect of the present disclosure may be vertically oriented within conduit 454 (such that, e.g., FIG. 4E would be a top or bottom view), such that the impeller faced upward or downward. Further, in another aspect of the present disclosure, impeller 456 could be placed at an angle within conduit 454, at the bottom of second portion 452, and/or elsewhere between outlet conduit 400 and receptacle 268. Multiple impellers 456 within system 10, on the same shaft 460 and/or different shafts 460, are also within the scope of the present disclosure. Impeller(s) 456 may also operate at variable speeds in a given preparation cycle if desired.

FIG. 4G illustrates a pump in accordance with an aspect of the present disclosure.

Pump 482 may be used as an alternative to impeller 456, or in addition to impeller 456, and/or in addition to other devices or means for degasification of fluids in an aspect of the present disclosure. For example, and not by way of limitation, pump 482 may be placed in conduit 454 in series with, in parallel with, and/or instead of impeller 456, such that fluid flowing from outlet nozzle 400 selectively passes through pump 482. The fluid selectively passes through pump 482 based on the configuration of pump 482 in system 10, and whether or not impeller 456 is being implemented in system 10 in addition to pump 482. Many possible configurations are possible within the scope of the present disclosure. Further, pump 482 and/or impeller 456, and/or other means, may also be used to introduce gas into a fluid in an aspect of the present disclosure.

Pump 482 may be a vibration pump as shown in FIG. 4G, or may be another type of pump without departing from the scope of the present disclosure. Pump 482 operates when power from source 483, which may be an alternating current (AC) source such as 110 Volts, 60 Hertz AC power that is readily available in the United States, or may be another mains source of power available in other countries, and/or a DC source of power. If source 483 is an AC source, diode 484 creates a half-wave rectified waveform that is applied to coil 485 that is wrapped around pump 482. When current flows through coil 485, i.e., during the positive half of the AC waveform, piston 486 moves away from inlet 487 and toward outlet 488. This motion compresses forward spring 489 and relaxes return spring 490, as well as compressing ball 491 against piston 486 through pressure applied by ball spring 492.

Pressure chamber 493 is pressurized when current flows through coil 485. The pressure in pressure chamber 493 compresses valve 494 against valve spring 495, which opens a pathway to allow fluid to flow from outlet 488.

When the AC waveform is negative, forward spring 489 pushes piston 486 towards inlet 487, which compresses return spring 490. This releases pressure on ball 491, allowing fluid to flow through piston 486 in path 496. Fluid then moves from path 496 into pressure chamber 493 and is held in pressure chamber 493 by the valve spring 495 pressurizing valve 494 against a seal 497.

When the AC waveform is positive, the magnetic field created by current flowing through coil 485 moves piston 486 toward outlet 488, increasing pressure in pressure chamber 493. This forces ball 491 between piston 486 and ball spring 492, and applies pressure to valve 494. When enough pressure is applied to valve 494 to overcome the spring constant of valve spring 495, the contents in pressure chamber 493 open valve 494 and flow to outlet 488.

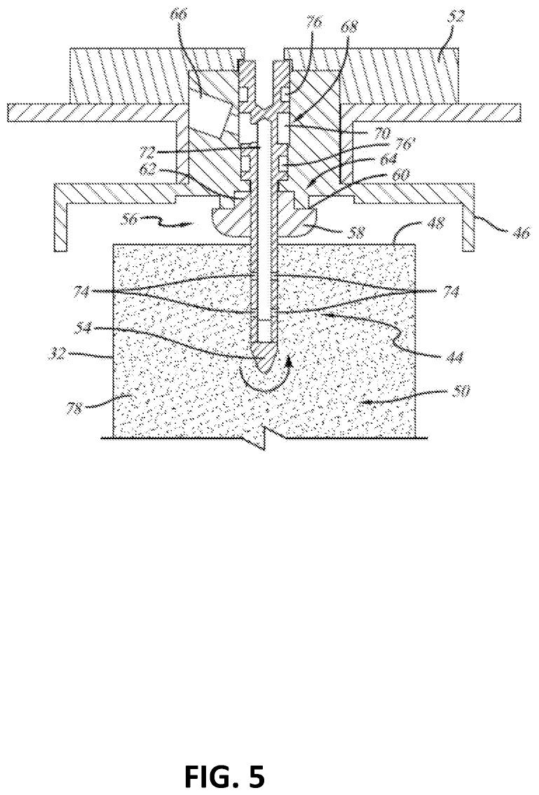

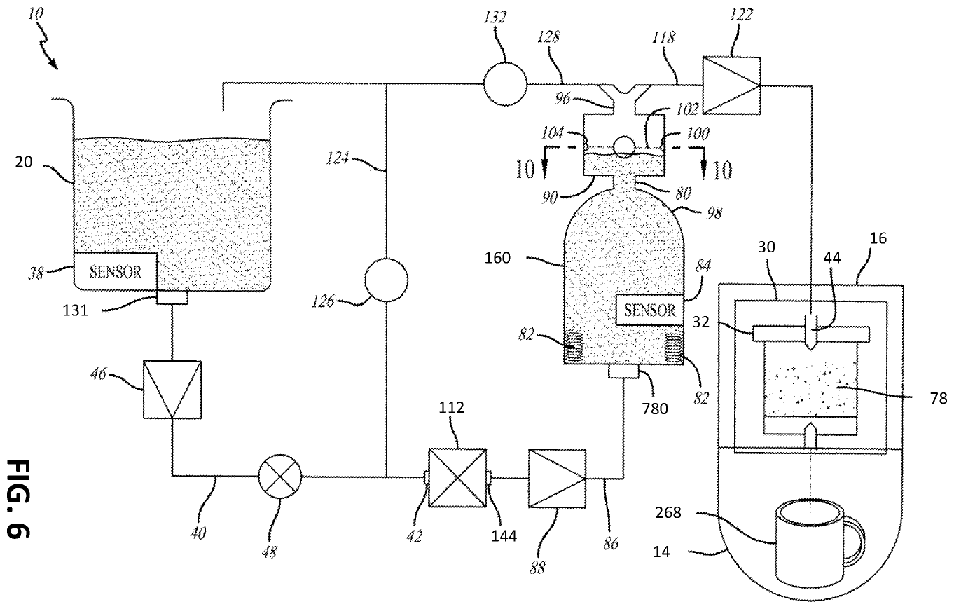

FIG. 5 is a cross-sectional view of the brewer head taken about the line 7-7 in FIG. 2 in an aspect of the present disclosure.

FIG. 5 illustrates at least some of the internal fluid, e.g., water, steam, etc., flow paths in the beverage brewer 10 that pass through the brewer head 16, the inlet nozzle 44, and a plurality of flow ports 74, and into the inner chamber 50 of a container-based beverage cartridge 32. As described with respect to FIG. 4C, When the lid 26 is pivoted to the closed position shown in FIG. 1, the inlet nozzle 44 is correspondingly moved into a position to puncture or otherwise pass through an outer surface 48 of the beverage cartridge 32 and extend down into an inner beverage medium-filled chamber 50 of the beverage cartridge 32.

When the brewer head 16 is in the closed position, the inlet nozzle 44 may be rotated by a motor 52 or other means coupled to the inlet nozzle 44 for at least a portion of the time while fluid is being delivered to the inner volume of the sealed container or for at least a portion of the time that the beverage brewer 10 is in the closed position. The same or different motor or means may also selectively vertically, horizontally, and/or rotationally (or otherwise) move or position the inlet nozzle 44 with respect to the beverage cartridge 32 and/or the beverage medium 78.

The inlet nozzle 44 in accordance with an aspect of the present disclosure may comprise a blunt or rounded nose 54 that force pierces the surface 48 to permit entry of the inlet nozzle 44 into the interior of the beverage cartridge 32. The nose of the inlet nozzle 44 may be sharpened, e.g., with jagged edges, having a point on the inlet nozzle 44, etc., to make the piercing of the outer surface 48 easier, but such a sharp or jagged edge may be less desirable since such an embodiment carries an inherently higher risk of user injury when the inlet nozzle 44 is exposed to the user as shown in FIG. 2.

The brewer head 16 may further include a gasket 56 having a concentric aperture with an inner diameter sized to snugly slide-fit around the exterior surface diameter of the inlet nozzle 44. The gasket 56 may be made from any sealing material, e.g., rubber, silicone, other food-safe materials, etc. In an aspect of the present disclosure, FIG. 5 shows the gasket 56 with a generally larger mushroom-shaped head 58 forming a ledge or step 60 that has a relatively smaller diameter neck 62 including an outer diameter sized for snug slide-fit reception into a corresponding aperture 64 in the brewer head 16 permitting extension of the inlet nozzle 44 into the beverage cartridge 32. In this respect, the gasket 56 pressure seals the inlet nozzle 44 relative to the interior of the brewer head 16 and related hot water conduit system. Other shaped gaskets are possible within the scope of the present disclosure.

A fluid conduit 66 (also referred to as a hot water conduit 66 herein) terminates at an upper end 68 of the inlet nozzle 44 and is generally aligned with an inlet channel 70 bored into the exterior diameter of the inlet nozzle 44. The inlet channel is coupled to, e.g., in fluid communication with, a central shaft 72 that channels fluid water from the upper end 68 toward the nose 54 and out through one or more flow ports 74. O-rings 76, 76′ may be positioned on each side of the inlet channel 70 to assist in minimizing leakage from pressurized fluid leaving the fluid conduit 66 for flow into the inlet channel 70.

The inlet channel 70 may be a reduced diameter bore that remains coupled with the fluid conduit 66 during the preparation cycle, and may remain coupled to the fluid conduit 66 while the inlet nozzle 44 spins or rotates within the beverage cartridge 32. As such, any fluid delivered to the beverage cartridge 32 through the inlet nozzle 44 while the inlet nozzle 44 is spinning or rotating may cause the beverage medium 78 to move as described herein. Accordingly, in this arrangement, a motor 52 couples to the upper end 68 and rotates or spins the inlet nozzle 44 during a brew cycle to rotate or spin the one or more flow ports 74 within the beverage cartridge 32 to more thoroughly mix the fluid delivered through inlet nozzle 44 with the beverage medium 78. A secondary fluid, comprising a mixture of the fluid delivered through the inlet nozzle 44 and a portion of the beverage medium 78, is thus created during the preparation cycle. The secondary fluid may be, for example, coffee, tea, etc., where the secondary fluid does not include, or includes only limited, solids from the beverage medium 78 (e.g., coffee grounds, tea leaves, etc.). In other words, some of the beverage medium 78 may remain in the beverage cartridge 32 after mixture with the fluid delivered through the inlet nozzle 44, whether or not the inlet nozzle 44 is rotated or otherwise moved while coupled to the inner chamber of the beverage cartridge 32. This secondary fluid may be referred to as a “fluidized mixture” herein.

The embodiment of the present disclosure shown in FIG. 5 illustrates four flow ports 74, but the inlet nozzle 44 may have as few as one flow port 74 or more than four flow ports 74 without departing from the scope of the present disclosure. The ports 74 may be structured or otherwise designed to inject fluid (e.g., hot water) into the beverage cartridge 32 in a variety of different ways, including an upward stream or spray and/or a downward stream or spray. Rotational movement of the inlet nozzle 44 and the injection stream or spray of hot water from the nozzle 44 may create a fluidized mixture of hot water and coffee within the interior of the beverage cartridge 32. As such, an aspect of the beverage brewer of the present disclosure described herein helps minimize channeling and/or overexposure of beverage medium (e.g., coffee grounds) during the preparation cycle. At least with respect to coffee, this may substantially reduce unwanted flavors and/or tastes, such as the bitter taste often associated with single-serve coffee brewers. Further, rotation of the inlet nozzle 44 within the beverage medium 78 in an aspect of the present disclosure may also produce a noticeable layer of coffee crema after the brewed coffee dispenses from the brewer head 16 into the receptacle (e.g., mug, cup, etc.) proximate the platen 14.

FIG. 6 is a schematic view of one embodiment of a beverage system according to the present disclosure.

An aspect of the present disclosure is shown in the drawings for the purposes of illustration, such as a beverage brewing system 10, can generally include a pump 112 that can be configured to pump unheated water from an ambient temperature water reservoir 20 to a heater tank 160, which can heat the water to a desired temperature (referred to herein as a “brewing temperature,” although other temperature types—e.g., “mixing temperature,” “soup temperature,” etc.—are possible, and this term should not be construed as limiting) for eventual delivery to a brew head 16 (referred to herein as a “brew head,” although many different types of heads are possible and this term should not be construed as limiting). The brew head 16 can include a receptacle 30 (e.g., a “brew chamber”) that can house a cartridge 32 (e.g., a “brew cartridge”) containing a single-serve or a multi-serve amount of a beverage medium 78, such as coffee grounds, tea, hot chocolate, lemonade, etc., for producing a beverage dispensed from the brew head 16. The beverage can be dispensed into an underlying container, such as a mug 268 or other similar container (e.g., a carafe) which can be placed on a platen 14, as part of a brew cycle.

More specifically, the reservoir 20 stores ambient temperature water used to brew a cup or multiple cups of beverage (e.g., coffee) in accordance with the embodiments and processes disclosed herein. Embodiments utilizing water at temperatures other than ambient are also possible, such as but not limited to pre-heated water that is hotter than ambient. The reservoir 20 may be top accessible for pour-in reception of water and may include a pivotable or fully removable lid or other closure mechanism that provides a watertight seal for the water in the reservoir 20. The water may exit the reservoir 20 during the brew process via an outlet 131 at the bottom thereof. Although, the water may exit the reservoir 20 from locations other than the bottom, such as the sides or the top such as via a reservoir pickup 34 extending down into the reservoir 20, or other locations as desired or feasible. In one embodiment, the reservoir 20 includes a water level sensor 38 for measuring the volume of water present therein. An optional reservoir closure switch 36, such as a Hall Effect sensor or the like, may detect whether the reservoir 20 is sealed by the lid, and may correspond with the brewer circuitry to prevent initiation of the brew cycle in the event the lid is open as shown in FIG. 2. The reservoir 20 may be sized to hold a sufficient quantity of water to brew at least one cup of brewed beverage, e.g., a 6 ounce (“oz.”) cup of coffee. The reservoir 20 could be of any size or shape, and may be sized to hold enough water to brew more than 6 oz., such as 8, 10, 12, 14 oz. or more. Of course, the water reservoir 20 could be replaced by other water sources, such as a water main.

Advantageously, in some embodiments of the present disclosure the pump 112 can be used for the dual purpose of pressurizing and/or pumping water (e.g., from the reservoir 20 to the brew cartridge 32) and/or for pressurizing and/or pumping air (e.g., for efficiently purging remaining water or brewed beverage from the system 10, such as near, at, or after the end of the brew cycle). In this respect, the pump 112 can initially pump water from the reservoir 20 through a first conduit 40 to the heater tank 160 where the water can be pre-heated and/or heated to a predetermined brew temperature before delivery to the brew cartridge 32 to brew the beverage medium 78. At, near, or after the end of the brew cycle, the pump 112 pumps pressurized air through the system 10 to purge any remaining water or brewed beverage therein to reduce and/or eliminate dripping at the end of the brew cycle. As such, the pump 112 is able to operate in both wet and dry conditions, i.e., the pump 112 can switch between pumping water and air without undue wear and tear. Accordingly, the pump 112 may eliminate the need for a two-pump system, thereby reducing the overall complexity of the brewing system 10, and is advantageous over conventional systems that require one pump for water and a second pump for purging the remaining fluid with air.

Many variables exist within system 10 that may affect the overall performance of system 10. One variable is the water level in the reservoir 20. Another variable may be the heater 82 operation in the heater tank 160. Another variable may be the back pressure from the cartridge 32 that may partially close the check valve 122. Other variables may also exist. Each of these variables may be at least partially accounted for through processor 512 to produce a more consistent performance in system 10.

Within reservoir 20 the pressure at outlet 131 (or in systems 10 connected to a water main, the pressure of the water main) and against the flow direction of check valve 46 may vary. Although pump 112 can deliver a constant volume of liquid per rotation as described herein, the monitoring of the current draw by pump 112 may not be sufficient to determine the pressure differential across pump 112.

The voltage delivered to pump 112 may be clamped such that the current delivered to operate pump 112 determines the speed and timing of each rotation of pump 112. The number of windings on the stator of pump 112 may vary from pump to pump, and, as such, a calibration for each pump may be made to determine the current drawn by each pump prior to installation in system 10.

The current spikes occur at specific times during the rotation of the rotor of pump 112, i.e., when the electric field within the windings of the stator is interfered with by the magnets or other metallic portions of the rotor. These current spikes may correspond to the movement of the pistons in pump 112, or may be calibrated to determine any delay between the current spikes and the full displacement of one or more of the pistons in pump 112.

Between the current spikes, it may not be necessary to clamp the voltage delivered to pump 112, as the times in between the current spikes are not drawing enough power to overload or otherwise damage pump 112. As such, the voltage across pump 112 may be unclamped and measured. This voltage shows the rest pressure in conduit 40, which is related to the hydrostatic pressure created by the water level in reservoir 20.

In other words, the minimum pressure, or diastolic pressure at inlet 42 of pump 112, created by the water level in reservoir 20 or in any other manner, can be determined by measuring the voltage, current, or other characteristics of pump 112 when pump 112 is at or near the point equidistance from the maximum pump displacement (in one embodiment at the minimum pump displacement), similar to systolic pressure in the heart, at outlet 144 of pump 112. Processor 512 or other similar means may take the measurements into account to change the amount of fluid delivered to heater tank 160, and ultimately to cartridge 32, to produce a more consistent fluid flow within system 10.

In an aspect of the present disclosure, check valve 88 may control the minimum pressure entering heater tank 160, and check valve 122 controls the minimum pressure leaving heater tank 160 to be delivered to nozzle 44 and cartridge 32. However, the actual pressure may be much more than the minimum cracking pressure that check valve 122 will accept. Because this pressure is, other than a minimum value, uncontrolled, additional pressure and/or liquid may be delivered to cartridge 32, causing inconsistent results for system 10.

For example, and not by way of limitation, when a brew cycle starts, check valve 122 has obtained a minimum cracking pressure and fluid flows through nozzle 44 into cartridge 32. If, during the brew cycle, heating element(s) 82 are energized, the pressure in heater tank will rise, thus creating additional pressure through check valve 122. Since this additional pressure may not be controlled by check valve 122, or vented through vent 128, the additional pressure may be delivered through nozzle 44 to cartridge 32. For the next brew cycle, heating element 82 may not be energized (or may be energized less), and thus the additional pressure and/or fluid caused by expansion of water due to the additional heat from heating element(s) 82 will not (or will only to a lesser extent) be delivered to the next cartridge 32. Since the beverage mediums 24 received different pressures, the tastes, temperatures, or other characteristics to be gleaned from the beverage mediums 24 may be different.

To reduce the difference in pressure, the present disclosure may employ processor 512 or other means to monitor current delivered to heating element(s) 82, and adjust the time that fluid is delivered to nozzle 44 accordingly. The present disclosure may also employ processor 512 to monitor the difference in pressure delivered to check valve 122 in other ways, e.g., temperature measurement, pressure measurement at the input to check valve 122, etc., to vary the time fluid is delivered or other aspects of system 10 to obtain more consistent results.

Once pierced by nozzle 44, each cartridge 32 provides resistance to the flow of fluid through cartridge 32 to mug 268. This resistance varies based on, among other things, the beverage medium within cartridge 32. For example, and not by way of limitation, bouillon within cartridge 24 may provide less resistance to fluid flow than ground coffee, because bouillon dissolves in the heated fluid from nozzle 44 while coffee grounds do not.

The pressure drop across the beverage medium 78 can result in back pressure against the outlet of check valve 122. If this back pressure is high enough (e.g., equal to or greater than the difference in pressure between the inlet and outlet of the check valve 122), check valve 122 may close, or cartridge 32 (or filter paper that is internal to cartridge 32) may be “blown out” by the pressure created by the incoming pressure of the heated fluid through nozzle 44.

Because cartridge 32 can only withstand a certain amount of pressure, and to minimize the chance of failure of cartridges 22, processor 512 may monitor the position of check valve 122 (such as through a sensor), and/or there may be a coupling of check valve 122 and vent 132.

In many brewing processes, there are several variables that affect flavor extraction from brewing materials. For example, and not by way of limitation, a brewing machine may heat water for a certain amount of time, called the heating time, and pass water through a brewing material (e.g., coffee) for a certain amount of time called the brewing time. However, if the only variable that is controlled by the brewing machine is time for the heating time and brewing time, the brewing machine likely does not take into account the ambient or prior temperature of the water, the hardness or other minerals present in the water, the amount of water in the machine, and/or the pressure that the water is being delivered at, among other things. Further, during the brew cycle, a simple timer likely does not take into account the amount, grind, and/or density of beverage medium, and/or actual temperature of the water as the water passes through the brewing material.

As such, a device or system in accordance with the present disclosure may take several variables into account for brewing different materials in different ways. Further, a device or system in accordance with the present disclosure may take into account one or more variables that may change during and/or between brewing cycles.

A brewing cycle may comprise, for example, several different periods of time. The conditions of the water, brewing material, and/or brewing machine may be determined, approximated, measured, interpolated, extrapolated, or otherwise taken into account prior to a request for brewing by a consumer or user. For example, and not by way of limitation, the temperature of the water in a reservoir, heater tank, or other area may be measured to determine how long a heating element should be energized to heat the water to a desired temperature, etc. Such initial conditions of the water, brewing material, system parameters, and other conditions prior to delivery of the water to the brewing material may be referred to as the “pre-brewing period” of a brew cycle herein.

Another period within the brewing cycle may be referred to as the “brew period” of the brew cycle. The brew period is the time during the brew cycle that water is delivered to the brewing material. As with the pre-brewing period, conditions of the water, brewing materials, system parameters, and other conditions during delivery of the water to the brewing materials may be monitored, measured, or otherwise inferred or determined to more precisely control the conditions for brewing during the brew period. For example, and not by way of limitation, the water temperature may be measured and/or controlled after being heated to provide a consistent water temperature to the brewing material, etc.

Another period during the brew cycle may be referred to as the “purge period.” The purge period may be employed to remove water or other materials from the brewing device. For example, and not by way of limitation, the brewing machine may change the flow of water within the brewing device to stop delivery of the heated water to the brewing material and pump air through the tubing, pumps, and other pipes inside the brewing machine to reduce or eliminate dripping from the machine after the desired beverage has been brewed.

A brewing device in accordance with the present disclosure can determine, measure, infer, or otherwise determine one or more conditions of one or more of the brewing variables, e.g., water temperature, pressure, backpressure, amount or type of brewing material, time, time of water delivery, amount of water delivery, amount of water delivery at temperature, purge time, pre-existing conditions, and/or other characteristics that may control brewing performance for one or more brewing materials used in the brewing machine.

The first conduit 40 fluidly couples the reservoir 20 to the pump 112. In one embodiment the first conduit 40 may carry water from the reservoir 20, through a first check valve 46 and an optional flow meter 48 to the pump inlet 42. The first check valve 46 may be a one-way check valve that only permits forward flow from the reservoir 20 to the pump 112 when in a first position, and otherwise prevents fluid from flowing in the reverse direction (i.e., backwards) back toward the reservoir 20 when in a second position. Moreover, the first check valve 46 has a positive cracking pressure (i.e., a positive forward threshold pressure needed to open the valve). As such, the first check valve 46 is generally biased in a closed position unless the positive forward flow (e.g., induced by the pump 112) exceeds the cracking pressure. For example, the first check valve 46 may have a cracking pressure of 2 pounds per square inch (“psi”). Thus, the pressure pulling fluid through the first conduit 40 must exceed 2 psi to open the first check valve 46 for fluid to flow there through. In this respect, water from the reservoir 20 will not flow past the first check valve 46 unless the pump 112 pressurizes the first conduit 40 to at least 2 psi. The cracking pressure may vary depending on the specific pump and/or other components used.

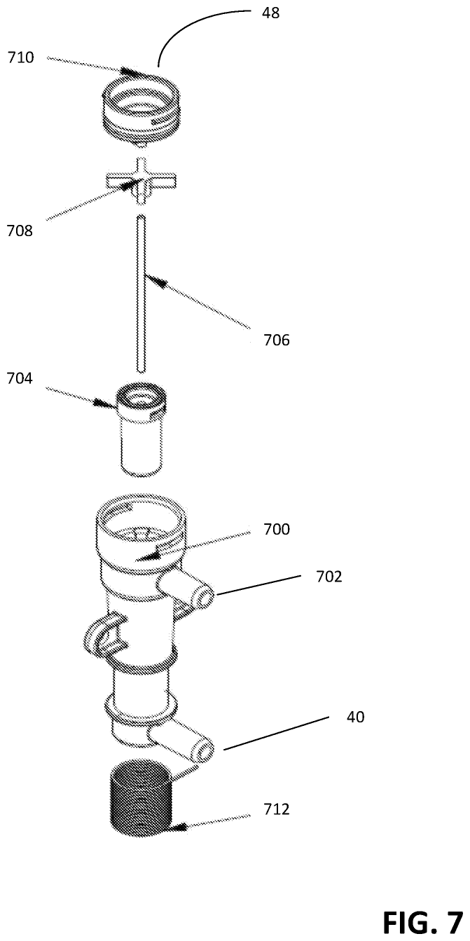

FIG. 7 is an exploded view of a flow meter for use with a beverage system according to an aspect of the present disclosure.

The beverage brewing system 10 may include the flow meter 48 disposed between the first check valve 46 and the pump 112 for measuring the volume of water pumped from the water reservoir 20 to the heater tank 160. In one aspect, the flow meter 48 may measure the quantity of water required to initially fill the heater tank 160. Additionally or alternatively, once the heater tank 160 is full, the flow meter 48 may measure the quantity of water delivered to the brew cartridge 32 in real-time during a brew cycle. This information is important, as it can allow the system 10 to set and track the amount of beverage that has been brewed and/or that needs to be brewed during the brew cycle. Thus, a user is able to select the desired quantity of beverage to brew (e.g., 6, 8, 10, 12 oz. or more) for any one brew cycle. In essence, the flow meter 48 provides measurements which can be used to ensure that the pump 112 displaces the correct amount of water (i.e., the desired serving size) from the reservoir 20 to the brew cartridge 32. Alternately, the flow meter 48 may be positioned on the outlet side of the pump 112.

As shown in FIG. 7, flow meter 48 may comprise a body 700. The body 700 may also comprise an inlet 40, and an outlet 702, where fluid flows into the body 700 from inlet 40 and flows out of the body 700 at outlet 702. A plunger 704 may be inserted into an interior cavity of body 700, with rod 706, crossbar 708, and cap 710 completing the construction of flow meter 48. Further, in an embodiment, wire 712, which may be insulated wire to reduce electrical shorts between turns of wire 712, is coupled as an external wrapping on body 700. Cap 710 and crossbar 708 ensure containment of fluid within body 700 and/or proper placement of plunger 704 and/or rod 706 within body 700. Although gravity may provide an initial or “no flow” position of plunger 704, a bias toward one position may be provided to ensure that plunger 704 is in a certain position along rod 706. Such a bias may be provided by, for example, a spring placed between plunger 704 and cap 710, if desired in system 10.

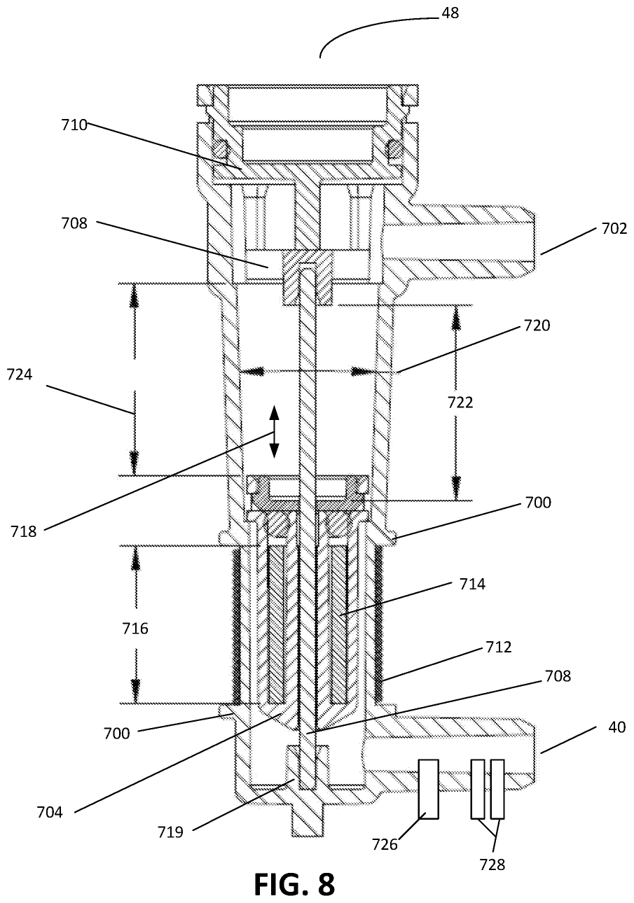

FIG. 8 is a cross-sectional view of a flow meter according to an aspect of the present disclosure.

Plunger 704 may comprise a core 714, which, when fluid is not flowing through body 700, is substantially aligned with wire 712. Core 714 may comprise silicon steel, iron, ferrite, metal, or other conductive and/or magnetic material in an aspect of the present disclosure. Core 714 may be isolated from the fluid flow by plunger 704 as plunger 704 encapsulates or otherwise isolates core 714 from moisture or other intrusions of the fluid flow. This isolation may be created by using a specific material for plunger 704, e.g., plastic, and ensuring that the core 714 is completely covered or isolated from the fluid flow by the material of plunger 704 when manufactured. Other methods of encapsulating core 714 may be to dip and/or coat core 714 in a liquid that dries substantially conformally coated on core 714. Core 714 may be isolated from the fluid flow and/or core 714 may be watertight to decrease effects of the core 714 on any taste or minerals present in the fluid flow introduced by core 714, as well as protecting core 714 from any deleterious effects caused by the fluid flow, e.g., erosion of the core 714. Since wire 712 is wrapped around an exterior of body 700, any current that is passing through wire 714 creates a magnetic field within the height 716 of the turns of wire 712 wrapped on body 700. When core 714 is substantially aligned with wire 712, the magnetic flux is concentrated and/or better contained within the windings of wire 712. This increased containment of the flux alters the inductance, or “L”, of the windings of wire 712.

Fluid flow from inlet 40 to outlet 702 provides increased pressure on plunger 704, and moves plunger in a direction 718 away from inlet 40 and toward outlet 702. Because rod 706 passes through plunger 704, plunger 704 moves along rod 706, which is coupled to a retainer 719 portion of body 700, to an “open” position. As fluid flow decreases, plunger moves in direction 718 toward inlet 40. As fluid flow increases, plunger 706 moves in direction 718 toward outlet 702. Further, the outer surface of plunger 704, and, if desired, an inner surface 720 of body 700 may be tapered, such that for a given fluid flow rate, the plunger 704 a predetermined amount with respect to the turns of wire 712. The amount of movement of plunger 704 with respect to wire 712 may or may not be linear with respect to the flow rate. The amount of taper of either plunger 704 and/or inner surface 720 may be selected to assist in the measurement of flow rate of fluid from inlet 40 to outlet 720. For example, and not by way of limitation, the taper may increase by a specific amount per unit length of height 716 and/or heights 722 and/or 724, such that the size and/or volume of the aperture between inlet 40 and outlet 703 can be determined at any position of plunger 704. By determining the size of the aperture based on the position of plunger 704, the amount of intersection of core 714 and wire 712 may have a unique characteristic, which may be a unique inductance. Measurement of the unique characteristic during fluid flow through body 700 under such conditions may be related to fluid flow between inlet 40 and outlet 702.

Because there are other materials within the windings of wire 712, e.g., the material used for body 700, the additional material of plunger 702, rod 706, and the fluid itself, there may be some variation in the characteristic, e.g., the electric or magnetic field, being determined using wire 712. To assist in calibrating or removing these variations from determining the characteristic, a measurement may be made while plunger 702 is “closed,” i.e., when there is minimal or no fluid flow between inlet 40 and outlet 702. This measurement may determine any magnetic, mineral, composition, electrical, or other characteristics of the fluid, which may vary based on the fluid input, and any changes in the material of plunger 702, body 700, rod 706, etc., that are within the measurement scope. These portions of the measurement may be removed from any final determination of position with respect to fluid flow as plunger 702 moves between closed and open positions.

Measurement of the characteristic during operation of system 10 may now provide a measurement of fluid flow from and/or to pump 112, which will assist in delivering a more precise amount of liquid to beverage medium 78 through inlet nozzle 44.

Optionally, flow meter 48 may include a temperature probe 726 and/or one or more conductivity probes 728. Although shown at the inlet 40, the temperature probe 726 and/or conductivity probes 728 may be placed at any location in flow meter 48 without departing from the scope of the present disclosure. Probes 726 and 728 may measure characteristics of the fluid flowing through flow meter 48, as well as when fluid is not flowing through flow meter 48, to better provide conductivity, temperature, or other characteristics, to assist system 10 in determining a more accurate and/or precise flow rate through flow meter 48. Further, the probes 726 and 728 may provide data points for other operations within system 10, e.g., a temperature probe 726 measuring temperature of water at inlet 48 may provide information that is used to operate heater 82, conductivity probes 728 may provide information about the fluid at inlet 40 that is used to control the preparation time for a particular beverage, etc. Further, viscosity of the fluid at inlet 40 may change with respect to temperature. As such, temperature probe 726 may assist in determining more accurate fluid flow measurements. Conductivity probes 728 may further assist in determining total dissolved solids in the fluid from inlet 40, which may provide a correction factor to measurements made using wire 712. Information provided by probes 726 and 728 may be used with flow meter 48, for other parts of system 10, and/or both.

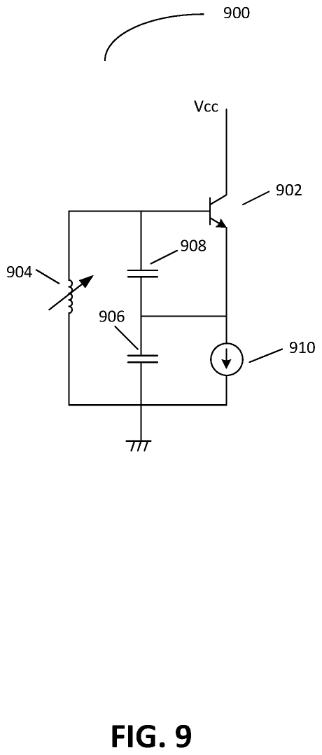

FIG. 9 illustrates an electrical circuit that may be associated with the flow meter in an aspect of the present disclosure.

FIG. 9 illustrates a Colpitts oscillator circuit 900. Other oscillator circuits may be used without departing from the scope of the present disclosure. Within circuit 900, a gain device 902, such as a bipolar junction transistor (shown), field effect transistor, etc., with a feedback loop of variable inductor (L) 904 and two capacitors (C) 906 and 908. A current source 910, which sets the voltage level between the capacitors 906 and 908, is also shown. The circuit may be powered from a voltage Vcc to ground, or other voltage differentials may be used.

The inductor 904 is shown as a variable inductor. As described with respect to FIG. 8, the plunger 704 moves in and out of the magnetic field created within windings of wire 712. The movement of plunger 704 with respect to the windings of wire 712 acts like a variable inductor 904. By coupling the windings of wire 712 to capacitors 906 and 908 and gain device 902 as shown in FIG. 9, a variable frequency oscillator (VFO) circuit 900 is created.

The frequency of the oscillations of circuit 900 is based on the inductance of inductor 904. Since the amount of inductance changes as a function of position of plunger 704, the frequency of oscillations of circuit 900 also changes as a function of position of plunger 704. Measurement of the frequency of oscillations from circuit 900 will yield the position of plunger 704, which may be related to flow rate as described with respect to the measurement of such frequencies before, during, and/or after operation of pump 112.

As shown in FIG. 9, the voltage across inductor 904 is in parallel with the voltage across the series connection of capacitors 906 and 908. As such, the voltage is equal across inductor 904 and series capacitors 906 and 908. The resonant frequency of this loop is based on the values of the inductor 904 and the capacitors 906 and 908. This “inductive” voltage divider comprising inductor 904 and the series capacitors 906 and 908 form a parallel resonant “tank” that oscillates. The voltage across capacitor 908, in the common-collector configuration of circuit 900, provides feedback to create the oscillations of circuit 900. Changes in the inductance of inductor 902 tune the circuit to a different resonance, and thus change the oscillation frequency. Other circuit configurations, such as common-base or common-collector (when used with bipolar junction transistors), common source, drain, or gate (when used with field-effect transistors), or other Colpitts designs, or other oscillator circuits, may be used without departing from the scope of the present disclosure.

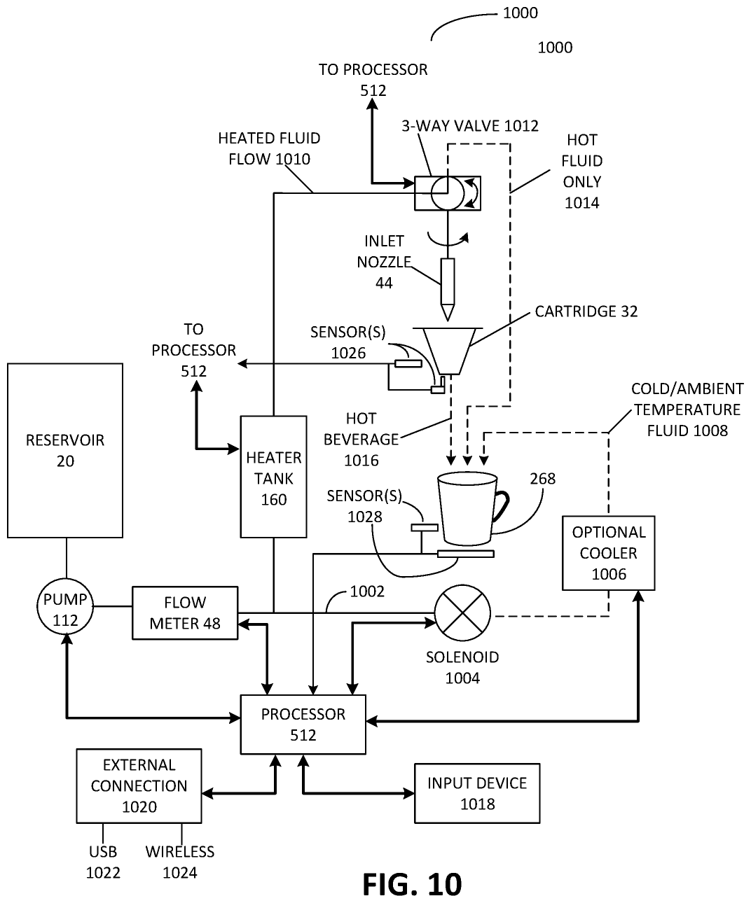

FIG. 10 illustrates a block diagram in accordance with an aspect of the present disclosure.

System 1000, which may be included in system 10, illustrates reservoir 20 delivering fluid to pump 112, through flow meter 48, and to heater tank 160. Flow meter 1002 may also deliver fluid on path 1002 to solenoid 1004, which selectively delivers fluid to optional cooler 1006, which can deliver cold and/or ambient temperature fluid 1008 (e.g., water, and/or whatever fluid is in reservoir 20 or introduced through other conduits to system 1000) to receptacle (mug) 268.

When delivered to heater tank 160, the heated fluid flow 1010 may be delivered to a valve 1012, which can deliver the heated fluid in flow 1008 to inlet nozzle 44 or, if desired, to a heated fluid (e.g., water) only line 1014. The inlet nozzle 44 delivers heated fluid in flow 1008 to cartridge 32, and a hot beverage 1016 (which may optionally be aerated or carbonated by impeller 456 as shown in FIG. 4D) is delivered to receptacle 268.

As such, system 1000 may deliver one or more of the following fluids to receptacle 268: cold fluid (e.g., water) or ambient temperature fluid from reservoir 20 to receptacle 30 as fluid 1008; hot fluid (e.g. water) alone via flow 1014, and/or a hot beverage 1016 through a cartridge 32. Because system 1000 can deliver at least one, and possibly any combination of these fluids, in an aspect of the present disclosure, system 1000 can mix these fluids to create additional beverages at receptacle 268 that could not be created by a system that lacked this multiflow fluid delivery system 1000.

For example, and not by way of limitation, a specialty coffee drink, known as an “Americano,” is a mixture of espresso and/or an espresso-like beverage and water. An “iced Americano” is a mixture of espresso and/or an espresso-like beverage and cold (or ambient) temperature water, whereas an “Americano” is a mixture of espresso and/or an espresso-like beverage and hot water. System 1000 may, in an aspect of the present disclosure, accept inputs from input device 1018 to create an Americano or Americano-like drink, and create an espresso or espresso-like portion of the Americano through inlet nozzle 44 (with or without the impeller 456 as described with respect to FIG. 4D), and add water to the espresso and/or espresso-like beverage 1016 in receptacle 268. An Americano may be created by adding hot water through flow 1014, whereas an iced Americano may be created by adding cold (or ambient) temperature through flow 1008. The mixture of fluids 1008, 1014, and 1016 may vary based on the final taste, temperature, and/or beverage desired, as well as allowing for inputs through input device 1018 and/or external connection 1020 to alter or deliver the beverage comprising fluids 1008, 1014, and/or 1016.

The delivery of fluids 1008, 1014, and/or 1016 to receptacle 268 may occur in sequence (i.e., one after the other), in parallel (i.e., at the same time), or staggered (e.g., one fluid 1008 begins, and at some later time, fluid 1014 delivery begins). Any combination of serial, parallel, and/or staggered delivery of fluids 1008, 1014, and/or 1016 in any order is possible within the scope of the present disclosure.

Processor 512 is coupled to pump 1002, flow meter 48, heater tank 160, valve 1012, and/or optional cooler 1006, to control the various functions of these and/or other devices within system 1000. Processor 512 may provide this control via programming stored in processor 512 or in external memory, or may receive instructions from an input device 1018 coupled to processor 512. Input device 1018 may be a button, knob, selector switch, or any combination of devices coupled to system 1000, e.g., as a user control, switch, or other device accessible to the user, including a display and/or other readout to guide the user as to the inputs to processor 512, that allows for control of the various devices within system 1000 via processor 512 and/or directly from input device 1018.

Further, processor 512 may have an external connection 1020 that may have a Universal Serial Bus (USB) port 1022 and/or a wireless port 1024. As such, external devices, such as cellular telephones, wireless networks, wi-fi enabled devices, or USB-enabled devices may be coupled to system 10 and, if desired, to processor 512. For example, and not by way of limitation, cellular phones may be coupled to USB port 1022 for charging of the cellular phone through system 1000, as well as allowing for communication (either one-way and/or two-way communication) between system 1000 and the cellular phone.

Further, processor 512 may be reduced in size and/or complexity because an external device coupled to processor 512 via external connection 1020 may comprise a processor internal to the separate device. For example, and not by way of limitation, a cellular telephone has a processor that can couple to the external connection 1020 and “run” system 1000 and/or system 10 using the processor internal to whatever device is coupled to external connection 1020. As such, an application on an external device, such as a software program (an application, or “app”) resident or otherwise stored on a cellular telephone, may control system 1000 and/or system 10 from a remote location, either through communication with processor 512, through the processing power of the external device, through commands from the external device to processor 512, and/or any combination of control and/or processing power shared by the external device and system 1000.

For example, and not by way of limitation, an aspect of the present disclosure allows for an app on a cellular telephone or similar device to control system 1000 remotely. If a person has an alarm function and/or app that is set on their cellular telephone, the alarm, when it is triggered, may send a signal to system 1000 through external connection 1020, to start system 1000, either immediately or through a delay of a predetermined or user-defined amount of time or through the alarm's snooze function, to begin a preparation cycle in system 1000.

Other control of system 1000, through a separate app that may be resident on the cellular phone and/or resident on system 1000 may be designed specifically to remotely operate system 1000 and/or may be a generic application that has been coupled to system 1000 (via Bluetooth®, Zigbee, and/or other wired and/or wireless protocols). The app or other control functions may communicate commands to system 1000 to perform various functions, e.g., begin a preparation cycle, report status of system 1000, send sensor readings from system 1000 to determine if, e.g., reservoir 20 contains enough fluid to prepare a beverage, etc. In an aspect of the present disclosure, two-way communication between the external device and system 1000 allows for any control that a user may have when able to physically touch system 1000 (and/or system 10) via user controls resident on system 1000, can be performed remotely through external connection 1020.

To insure that system 1000 is ready to prepare a beverage to be delivered to receptacle 268 remotely, for safety and/or other reasons, the system 1000 may insure that system 1000 will not cause damage or create an unsafe condition for users and/or property. As such, system 1000 may comprise, in an aspect of the present disclosure, one or more sensors 1026 to detect the presence of a cartridge 32 in system 1000. Further, in another aspect of the present disclosure, system 1000 may comprise one or more sensors 1028 to detect the presence of a receptacle 268.

Sensors 1026 may detect that an unused cartridge 32 has been placed in and/or is present in system 1000. This may occur, for example, by processor 512 detecting the opening and/or closing of lid 26, a mechanical sensor 1026 that detects the removal of a cartridge 32 after a preparation cycle and the depression of the mechanical “button” sensor and closure of lid 26 after the preparation cycle is completed, an infrared or other light beam transmitter/receiver/sensor 1026 that senses removal and replacement of a cartridge, or by other methods or sensors. Any sensing of a cartridge 32 presence in system 1000 may be employed without departing from the scope of the present disclosure. If a cartridge 32 is not detected in system 1000, or cartridge 32 is not an unused or “new” cartridge, or is not capable of preparing a beverage in accordance with other commands sent to system 1000, system 1000 may report an “error” or “unable to make beverage” message, or other message reporting the status of system 1000, to the remote external device through external connection 1020.

Further, sensors 1028 may be an infrared and/or other light beam transmitter/receiver/sensor that detects the presence of receptacle 268 on platen 14. The sensors 1028 may be a weighing scale to determine if platen 14 is holding any weight above a certain amount, indicating the presence of a receptacle 268. Any sensing of the presence of a receptacle 268 may be employed without departing from the scope of the present disclosure. If a receptacle 268 is not detected in system 1000, or receptacle 268 is determined as not being of sufficient size to contain the beverage desired (as determined by system 1000), or receptacle 268 is determined as not in accordance with other commands sent to system 1000, system 1000 may report an “error” or “unable to make beverage” message, or other message reporting the status determined by system 1000, to the remote external device through external connection 1020.

Other messages may also be sent to the remote external device through external connection 1020 (either through USB 1022 and/or wireless connection 1024). For example, and not by way of limitation, a “beverage ready” message or “reservoir low” message may be sent from system 1000 to remote external device via external connection 1020. Any system 1000 messages may be sent without departing from the scope of the present disclosure.

If sensors 1026 and 1028 indicate the presence of a cartridge 32 and a receptacle 268, the system 1000 may accept instructions from the remote device via wireless connection 1024 (and/or USB connection 1022) and begin a preparation cycle that may be delivered by the app or programmed into processor 512. For example, the cartridge 32 may be encoded or otherwise indicate to sensors 1026 and/or system 1000 to perform a specific preparation cycle, the app may deliver specific instructions to system 1000 via external connection 1020 to prepare a specific beverage and thus a specific preparation cycle, or other methods or means may be used without departing from the scope of the present disclosure to allow for remote starting and/or preparation of beverages within system 1000.

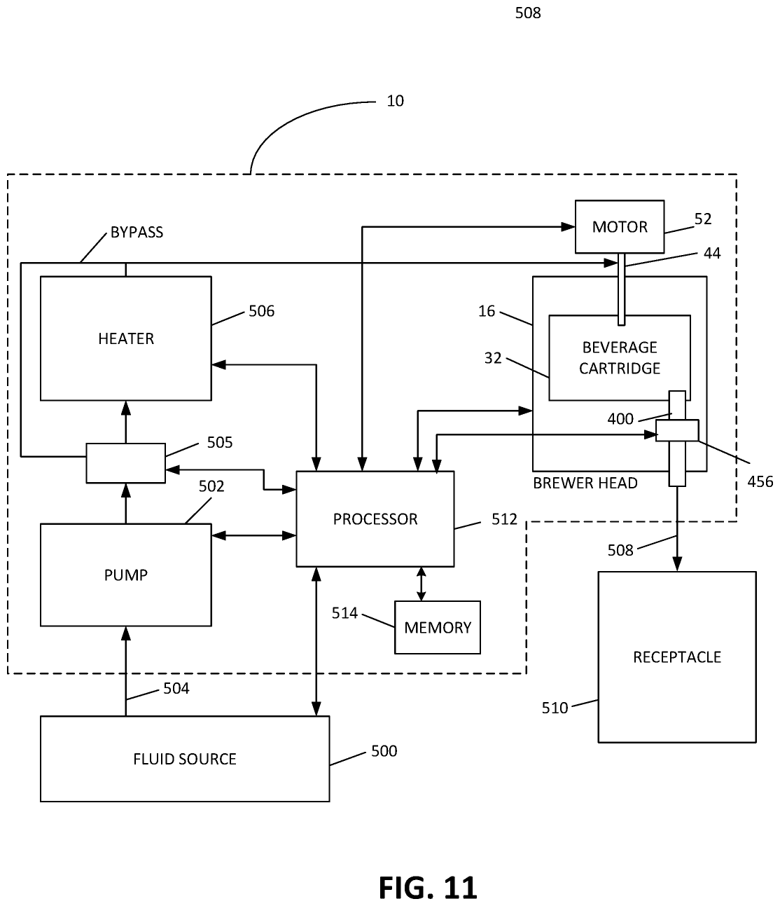

FIG. 11 illustrates a block diagram of a beverage brewer in accordance with an aspect of the present disclosure.

Beverage brewer 10, as shown in dashed lines in FIG. 10, may be coupled to a fluid source 500. The fluid source 500 may be a reservoir that is included within and/or attached to a beverage brewer 10, but such a fluid source may also be the water supply for a home or building, a filtered water supply, a carbon dioxide (CO2) line, or other fluid source as desired. Further, more than one fluid source 500 may be coupled to the beverage brewer 10.

A pump 502 is coupled to the fluid source 500. The pump 502, which may be pump 112, may provide pressure to the fluid 504 within the beverage brewer 10, such that the pump 500 delivers the fluid 504, e.g., water, milk, CO₂, etc., at a desired, known, and/or predetermined pressure to the remainder of the beverage brewer 10.

The pump 502 is coupled to a flow meter 505 which may be flow meter 48. The flow meter 505 is coupled to heater 506, which may be heater tank 160, and delivers fluid 504 to heater 506 for those fluids 504 that may need to be heated prior to delivery to the beverage cartridge 32. Flow meter 505 measures the flow rate of the fluids 504 passing through pump 404, and heater 506 heats (and/or optionally cools) the fluid 504 as desired. In another aspect of the present disclosure, heater 506 is provided with a bypass flow from flow meter 505 in order to allow ambient temperature fluid to pass without heating or cooling, although other methods of providing ambient temperature fluid (such as not heating the heater 506) are possible without departing from the scope of the present disclosure. Although not shown, valves may be placed between flow meter 505, heater 506, and/or pump 502, as well as along the bypass of heater 506, as desired to selectively control the flow of fluid 504 through system 10.

Heater 506, when employed by the beverage brewer 10, delivers the heated or otherwise processed fluid 504 to the inlet nozzle 44. When the brewer head 16 is in the proper position (i.e., the closed position as shown in FIG. 1), at least a portion of the inlet nozzle 44 is coupled to the inner chamber 50 of the beverage cartridge 44. Fluid 504 that is delivered to the inlet nozzle 44 may then be delivered to the inner chamber of the beverage cartridge 32.

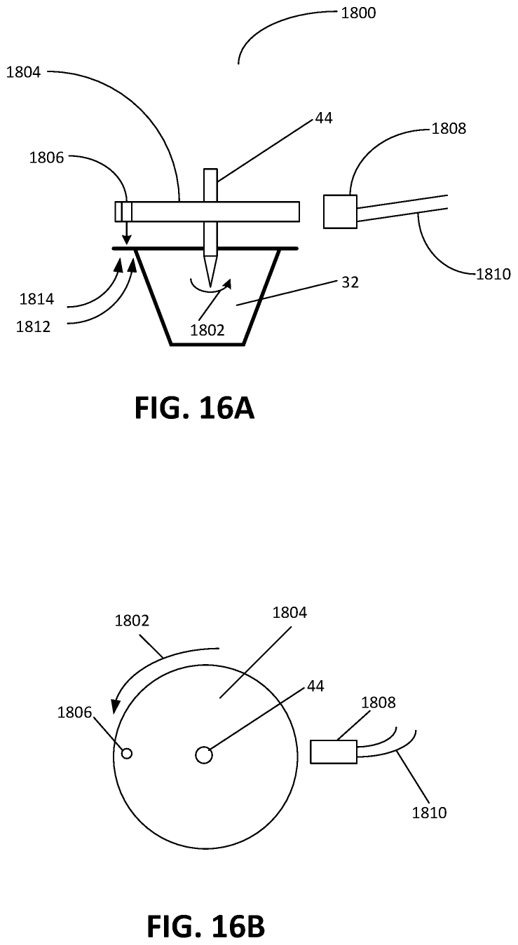

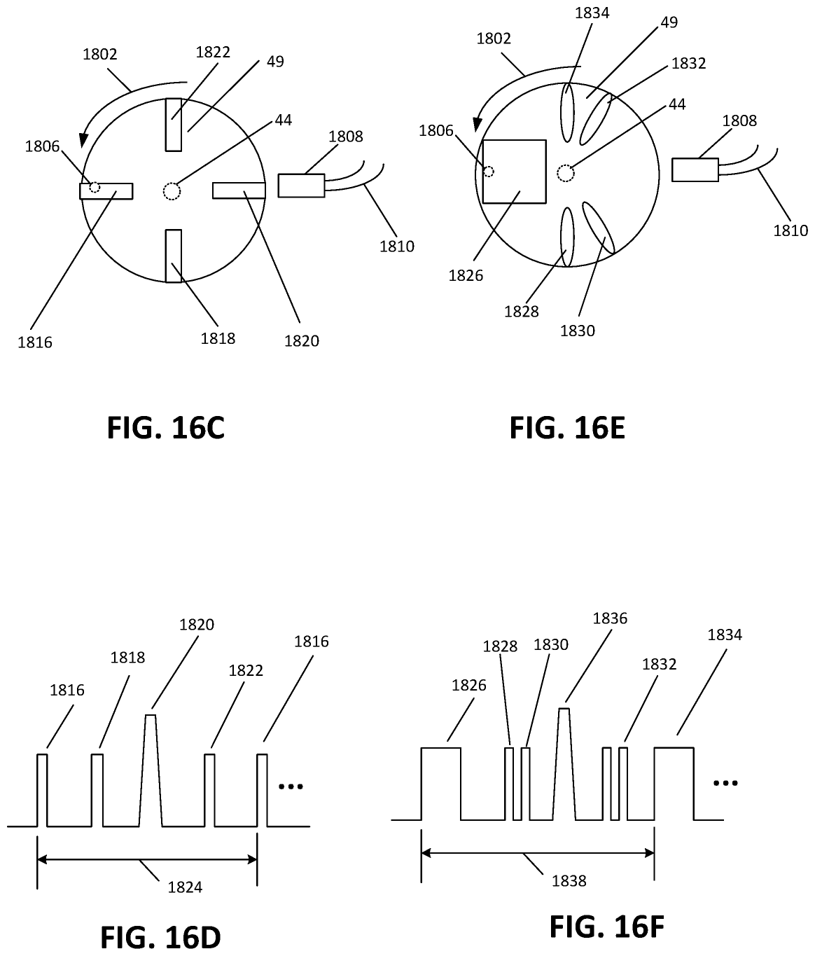

During at least a portion of the time that the brewer head 16 is in the closed position, motor 52 and/or other means within beverage brewer 10, may spin, rotate, nutate, vibrate, oscillate, or otherwise move inlet nozzle 44. Fluid 504 delivered through the moving inlet nozzle 44 may then move the beverage medium 78 (as shown in FIGS. 5 and 16) to assist in the fluidizing and/or mixture of fluid 504 with beverage medium 78.

The outlet conduit 400 is also coupled to the inner chamber 50 of the beverage cartridge 32 when the brewer head is in the closed position. As such and/or after the fluidization of fluid 504 and beverage medium 78 occurs, a secondary fluid 508 may be delivered from the inner chamber 50 of the beverage cartridge 32 to an impeller 456 and then to a receptacle 510, e.g., a coffee mug, glass, cup, mug 268, or other container that may be external to the beverage medium 10. The beverage brewer 10 may also comprise receptacle 510, e.g., a carafe, etc., however, in many applications the receptacle eventually is used externally to the beverage brewer 10.

The pump 502, motor 52, flow meter 505, heater 506, brewer head 16, impeller 456, and, optionally, the fluid source 500, are coupled to a processor 512. The processor 512 is further coupled, either internally or externally, to a memory 514. The processor 512 provides computer-based control of the pump 502, motor 52, impeller 456, and heater 506, and receive inputs from flow meter 505 and/or other sensors. Further, processor 512 may control other components within beverage brewer 10.

For example, and not by way of limitation, the processor 512 may receive a signal or other input from a sensor coupled to the fluid source 500, to indicate to the beverage brewer 10 that there is not enough fluid 504 available to brew a beverage. The processor 512 may then prevent the beverage brewer 10 from initiating a preparation cycle for a beverage cartridge 32.

Further, the processor 512 may sense a particular type of beverage cartridge 32 present in the brewer head 16. Once the type of beverage cartridge 32 is known, the processor 512 may provide different inputs to the pump 502, motor 52, heater 506, impeller 456, or other components in the beverage brewer 10 to change one or more variables in the mixture of fluid 504 and the beverage medium in the particular beverage cartridge 32. The processor 512 may increase or decrease the speed of rotation of motor 52, may insert the inlet nozzle 44 further into the beverage container 32, provide pulsed or different types of current to the pump 502 and/or heater 506, or may change some path for the fluid 504 prior to introduction into the inner chamber 50 of the beverage cartridge 32. Additionally, the processor 512 may select a particular kind of inlet nozzle 44 motion or combination of motions based on the type of beverage cartridge 32 that is sensed or a specific user input. The processor 512 may also provide inputs to selectively rotate the impeller 456 to create crema and/or other aeration of the secondary fluid 508 based on the type of beverage medium 78, user inputs, or other variables. These and/or other inputs to the processor 512 may cause the processor 512 to access memory 514 to provide such instructions to various components of the beverage brewer 10.

The system 10 may include one or more of the microcontrollers 512, and that the microcontroller(s) 512 can be used to control various features of the system 10 beyond simply turning the pump “on” or “off”. For example, the microcontroller and/or processor 512 may also control, receive feedback from, or otherwise communicate with the heater tank temperature sensor 84 (e.g., to monitor heater tank water temperature), the water level sensor 38 in the reservoir 20 (e.g., determine if there is any water to brew), the flow meter 48 (e.g., monitoring the quantity of water pumped to the heater tank during a brew cycle), the heating element 82 (e.g., regulate water temperature in the heater tank 160), heater tank water level sensor 90 (e.g., determine fill state of the heater tank 160), the emitter 100 (e.g., to turn “on” or “off” the light beam 102), the photoreceptor 104 (e.g., to determine occlusion of the light beam 102), the rotating inlet nozzle 44 (e.g., activation and rotation during a brew cycle), the first solenoid valve 126 (e.g., open or close), and/or the second solenoid valve 132 (e.g., open or close).

The memory 514 may be implemented in firmware and/or software implementation. The firmware and/or software implementation methodologies may be implemented with modules (e.g., procedures, functions, and so on) that perform the functions described herein. A machine-readable medium tangibly embodying instructions may be used in implementing the methodologies described herein; for example, a barcode and/or UPC code can be included on a cartridge and read by, for example, an optical sensor in the beverage head. For example, software codes may be stored in a memory (e.g., memory 514) and executed by a processor unit (e.g., processor 512). Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

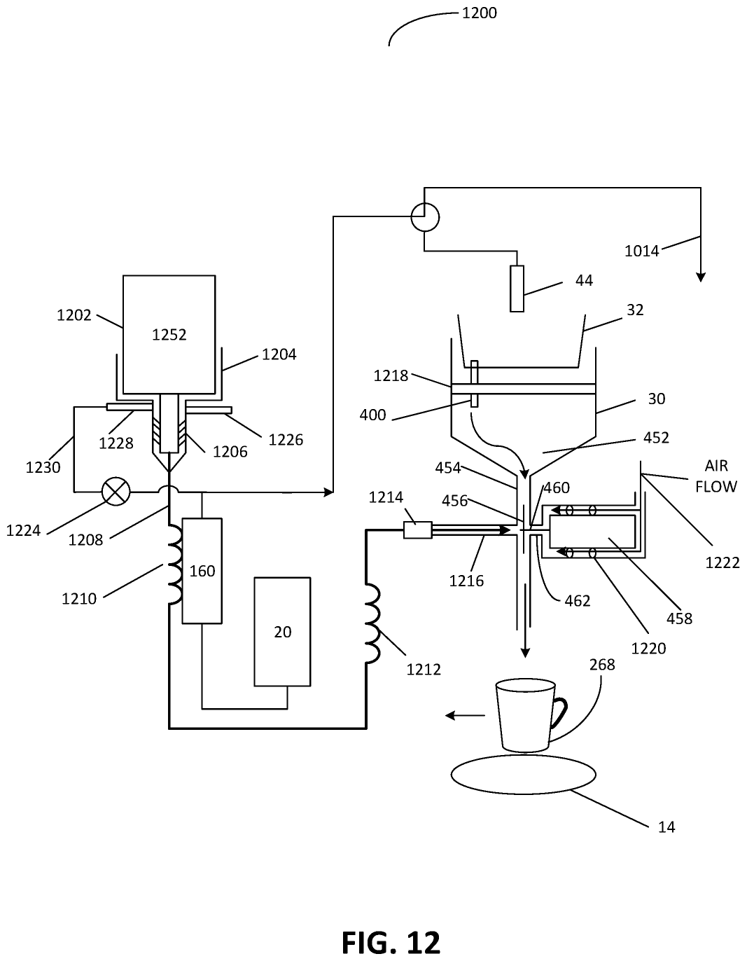

FIG. 12 is a diagram in accordance with an aspect of the present disclosure.

System 1200, which may be included in system 1000 and/or system 10, illustrates a second reservoir 1202 which may be removable from a holder 1204. Holder 1204 may comprise at least one seal 1206, which may couple second reservoir 1202 with holder 1204. Seal 1206 may be a rubber or silicone based seal, and may be a chevron or “flapper” style seal to assist in holding second reservoir 1202 into holder 1204. Further, seal 1206 may also reduce or prevent air flow from passing seal 1206 when second reservoir 1202 is inserted or otherwise coupled to holder 1204. Although shown with an extension or nozzle on second reservoir 1202, other configurations of second reservoir 1202, e.g., conical, spherical, or other shapes, with or without nozzles or extensions, are possible within the scope of the present disclosure.

Fluid 1250 from second reservoir 1202 passes through conduit 1208 to a heated conduit 1210. Heated conduit 1208 may be coupled and/or thermally coupled to heater tank 160, either externally as shown in FIG. 12, internal to heater tank 160, or both. Heated conduit 1208 assists in heating fluid from second reservoir 1202, and, in an aspect of the present disclosure, may completely heat fluid from second reservoir 1202, which may be at refrigerated temperatures when delivered to second reservoir 1202, to a desired temperature. A second heater 1212 may also be included in system 1200 if desired to increase the thermal input to fluid flowing from second reservoir 1202.

Orifice 1214 may assist in controlling the rate of fluid flow from second reservoir 1202 to conduit 1216. Either a fixed, pre-selected orifice 1214 size, or a controllable orifice 1216 size, which may be controlled by processor 512, are possible in the scope of the present disclosure. Conduit 1216 may be coupled to conduit 454. In an aspect of the present disclosure, conduit 1216 is coupled to conduit 454 substantially along the axis of shaft 460 and substantially opposite conduit 462. In such an aspect, when motor 458 is rotating impeller 456, a region of low pressure is created substantially at the axis of shaft 460. The fluid from second portion 452 of receptacle 30 is at a higher pressure as fluid from reservoir 20, because fluid is pressurized through system 1200 by pump 112. As such, there is a higher pressure in second portion 452 (which may be sealed from other portions of receptacle 30 by seal 1218) that forces fluid toward impeller 456, and may be pierced by outlet conduit 400 as shown in FIG. 12. Seal 1218 may also separate outlet conduit 400 from second portion 452 within receptacle 30 if desired.

The lower pressure region created substantially at the axis of shaft 460 within conduit 454 helps pull the fluid 1252 from second reservoir 1202 to conduit 454. Further, placement of the second reservoir 1202 at a higher point in system 1200 than conduit 1216 may also allow gravity to assist with the flow of fluid 1252 from second reservoir 1202 to conduit 1216.

When impeller 456 is rotated by motor 458, cavitation of the fluid from outlet conduit 400 and/or fluid through conduit 1218 may occur, creating froth, crema, foam, or other aerated and/or gaseous mixtures of fluids from reservoir 20 and/or second reservoir 1202. Orifice 1214 may be sized and/or controlled by processor 512 to also assist in the flow of fluid from second reservoir 1202. As such, time of preparation, the heat of the fluids being delivered, and the point in time of mixture of the fluids, as well as the quantity of each fluid delivered to the final beverage delivered to receptacle 268 can be controlled, either through processor 512, the user, or any combination of both inputs.

To resist, minimize, and/or prevent fluid flow from conduit 454 entering conduit 462 around shaft 460 and/or contacting motor 458, and/or to dampen vibration and/or reduce sound emanating from motor 458, dampeners 1220 may be placed around motor 458. Further, to reduce fluid flow around shaft 460 and/or motor 458, a positive pressure 1222, e.g., air flow that passes through dampeners 1220 and toward conduit 454, may be used to resist fluid flow into shaft 462. As such, secondary fluids, such as milk, cream, or other liquids, may be added to beverages created from beverage cartridge 32, and/or added to other fluid flows as described herein.

To purge the fluid path from holder 1204 to conduit 1218, solenoid 1224 and sensor 1226 may be provided. When solenoid 1226 is opened, pump 112 may pump water 1230 through the holder 1204. A different type of purge water 1230 control may be created by coupling an inlet 1228 to holder 1204, water flow (which may be heated water) is pressurized through system 1200 where secondary fluid from reservoir 1202 would flow. Other ways to control the flow of purge water may be, for example and not by way of limitation, by placing a three-way valve on the outlet of the heater tank 160, where one valve output is to the purge line and the other outlet may be used for heated water to beverage cartridge 32 or hot water only line 1014.

To ensure that a purge does not occur when reservoir 1202 is in place, sensor 1226 may be used in conjunction with processor 512 to provide purging of system 1200 only at proper times. For example, a purge cycle may be run prior to making a beverage through system 1200. The system may, through sensor readings, or other inputs, know that a cup or receptacle 268 is on the platen 14. The system may indicate to a user, either a user that is standing near the system 1200 or a remote user that is informed by an application, that the system 200 cannot be used for that particular drink.

Rather than deliver purge water to a receptacle 268, in an aspect of the present disclosure allow for purging the secondary fluid line from secondary reservoir 1202 to conduit 1018, but delivering the quantity of purge water to the platen 14 (drip tray). This purge water may leave system 1200 underneath the platen to avoid human contact with heated liquids. Further, the purge water that flows from reservoir 20 through system 1200 may be delivered to platen 14, rather than to receptacle 268, through a clear, see-through or other material used for platen 14 (which may also include a drip plate), including other sensors as described herein, to reduce the possibility of delivering purge fluid to a receptacle 268. Other lockout features are possible within the scope of the present disclosure.

In an aspect of the present disclosure, a second fluid 1252, which may be milk, cream, and/or other fluids, can be delivered to receptacle 268 as shown in FIG. 12. Second fluid 1252 may also be heated, by heater coil 1210 (optionally coupled to heater tank 160, either internally, externally, or both) or by heater coil 1212, or by both heater coils 1210 and 1212.

The flow rate of fluid 1252 can be controlled by the size of orifice 1214, and the size of orifice 1214 may be controlled by processor 512 if desired. The fluid 1252 is then delivered by conduit 1216 to conduit 454 substantially at the axis of shaft 460, or, in another aspect of the present disclosure, to a different portion of conduit 454. In the embodiment shown in FIG. 12, the conduit 1216 is positioned at an area/volume of low pressure in conduit 454, such that fluid 1252 will be pulled through the flow path from reservoir 1202 to conduit 454. Such fluid 1252 may also be assisted by gravitational pull between second reservoir 1202 to conduit 454.

The second fluid 1252 may be mixed and/or combined with fluid from the beverage cartridge 32 through outlet conduit 400, or other fluids described herein, to make and/or produce beverages using a plurality of fluids, such as fluid from reservoir 20 and fluid from reservoir 1202. Multiple reservoirs 1202 and/or holders 1204 are possible within the scope of the present disclosure.

The mixed beverage, which may have fluid 1252 delivered before, during, or after the delivery of fluid from cartridge 32 via outlet conduit 400, may be aerated and/or otherwise affected by rotation of shaft 600 and impeller 456. Many combinations of steps, functions, and/or delivery durations and/or times are possible within the scope of the present disclosure.

Purging of the system 1200 couples reservoir 20 to conduit 1208 through inlet 1228. Inlet 1228 may be placed upstream from seal 1206, or downstream from seal 1206, as desired. By opening solenoid valve 1224, or through the use of a three-way valve as otherwise described herein, fluid (water) flow from reservoir 20 (or other fluid source) may be diverted to inlet 1228 and pressurized through system 1200 by pump 112.

The purge cycle may utilize one or more sensors 1226 to indicate the presence or absence of reservoir 1202. System 1200 may have a user remove reservoir 1202 to allow a purge cycle to begin. Further, system 1200 may also determine that receptacle 268 is not on platen 14 to allow for delivery of purge fluid to a drip tray (underneath and/or part of platen 14).

Once conditions for purging system 1200 are determined by system 1200, possibly through the use of processor 512, solenoid 1224 (or other flow control device) is opened and pump 112 pumps heated and/or unheated fluid from reservoir 20 to holder 1204, and through the fluid flow path from conduit 1208 to conduit 1216. Motor 458 may be energized to assist in cleaning impeller 456, and positive air flow 1222, which may be a fluid flow or other cooling and/or protective measure, may also be engaged to protect motor 458.

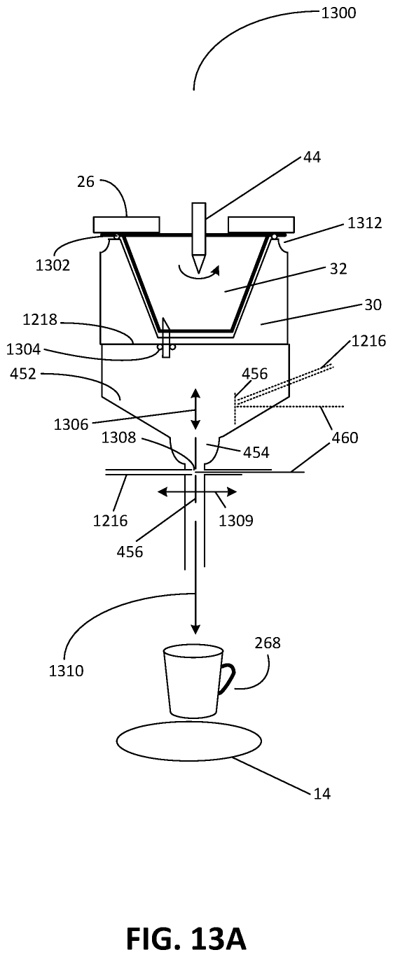

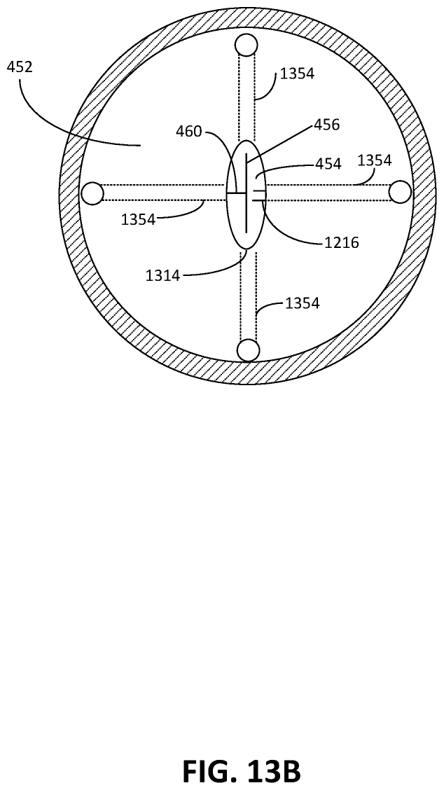

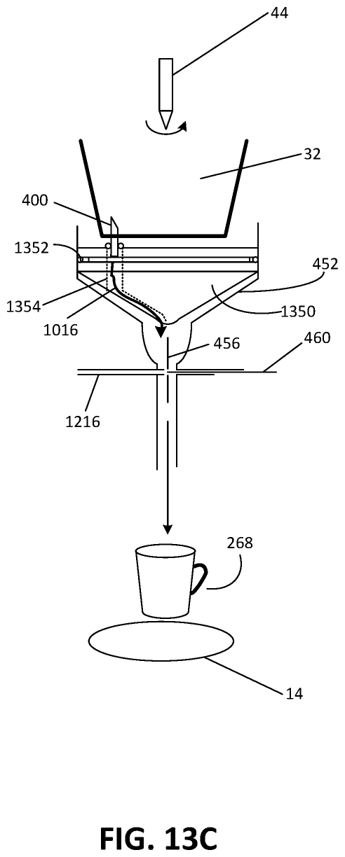

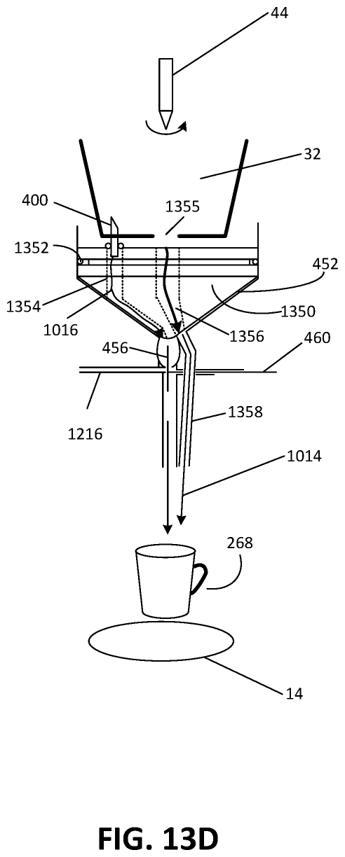

FIGS. 13A-13D illustrate an embodiment of the brewing head in accordance with an aspect of the present invention.

Brewing head 1300, which may be part of system 10, may be employed to assist in the generation of crema or other types of gaseous-liquid fluids for delivery to receptacle 268. Lid 26 may compress a ridge, lip, or other protrusion of beverage cartridge 32 against a seal 1302 such that a substantial pressure seal between beverage cartridge 32 and receptacle 30 exists. Another seal 1304 may provide a substantial pressure seal between receptacle 30 and second chamber 452, such that fluid pressure provided through inlet nozzle 44 is substantially released through outlet conduit 400 into second chamber 452, and substantially not to other locations.

As shown in FIG. 13A, arrow 1306 indicates that the impeller 456 may be moved closer to the seal 1218 between receptacle 30 and the second chamber 452, or farther away from the seal 1218. Further, arrow 1308 indicates that impeller 456 may be moved laterally such that impeller 456 is closer to or farther away from conduit 1216. The placement of impeller 456 may be placed substantially in conduit 454, substantially outside of conduit 454 (as shown in dashed lines in FIG. 13), or in any position as desired within the scope of the present disclosure. Some exemplary distances between impeller 456 and conduit 1216 can be between 5/1000 of an inch and 50/1000 of an inch, with some specific embodiment distances being between 8/1000 and 20/1000 of an inch, or about 10/1000 or about 12/1000 of an inch. Many different distances are possible.

Conduit 1216 may also be supplied at an angle to either side of the impeller 456. As shown in dashed lines in FIG. 13, conduit 1216 may be supplied at an angle to the “back” side of impeller 456 (i.e., the side of impeller 456 coupled to shaft 460). Further, impeller 456 may have holes or surface irregularities 1309 that allow fluid from conduit 1216 to be pulled from conduit 1216 by the low pressure zone created near the rotational axis of impeller 456.

After delivery of fluid through inlet nozzle 44, and optional delivery of second fluid through conduit 1216, as well as optional variable use of impeller 456, a fluid 1310, which may be a mixture of fluid from beverage cartridge 32 and fluid from conduit 1216, may be delivered to receptacle 268.

For ease of insertion and/or removal of beverage cartridge 32, indents 1312 may be provided to provide access to the lip (also referred to as a flange or ridge) of the beverage cartridge 32.

FIG. 13B illustrates a top view of second chamber 452. A bowl 1314, which may be elongated as shown, or of any shape, may allow for the impeller 456 and/or conduit 1216 to be partially in the second chamber 452, although the impeller 456 and/or conduit 1216 may also be completely within the bowl 1314 and/or conduit 454. Depending on the fluid dynamics desired, placement of other items, such as flow channeling structures (culverts) or other directional flow devices or surfaces, may also be included in certain aspects of the present disclosure.

FIG. 13C illustrates a flow channeling device 1350 placed in second chamber 452 in accordance with an aspect of the present disclosure.

Flow channeling device 1350 is coupled to outlet conduit 400 and is substantially sealed against second chamber 452 with seal 1352. Flow channeling device 1350 may be otherwise sealed or more closely coupled with second chamber using sonic welding, glues or epoxies, or may be fabricated as part of second chamber 452 as desired; many embodiments are possible.

Flow channeling device 1350 comprises at least one channel 1352 that directs the flow of beverage 1016 from outlet conduit 400 to impeller 456. Flow channeling device 1350 reduces the effects of external forces, e.g., temperature, atmospheric gasses, etc., from affecting the beverage 1016 between the time beverage 1016 is formed and the time of delivery of beverage 1016 to impeller 456.

Because beverage 1016 is a fluid, which comprises liquid, gas bubbles, and gas molecules entrained in solution, the temperature of beverage 1016 as delivered to impeller 456 affects the ability of impeller 456 in cavitation and/or formation of the gas entrained in solution. Further, because beverage 1016 may comprise oils, once the gas entrained in solution is formed into a gas bubble, the oils provide greater surface tension and maintain the gas bubbles formed by impeller 456 for a longer time.

System 10, as well as system 1300, may control the temperature and/or pressure of formation for beverage 1016. Since flow channeling device 1350, through channel 1352, reduces the effects of temperature, pressure, and/or other external forces on beverage 1016 between the time of formation and the time of gas bubble cavitation (formation) of the fluid beverage 1016, system 10 and/or system 1300 has fewer variables to control in controlling the speed of motor 458. Further, by containing and/or directing beverage 1016 in a more direct fashion to impeller 456, a more consistent beverage 1016 may be delivered to receptacle 268.

Although shown as substantially perpendicular to conduit 454 (and thus substantially perpendicular to the plane of impeller 456), channel 1354 may deliver beverage 1016 at any angle to impeller 456 without departing from the scope of the present disclosure. Further, channel 1354 may be of any shape or size, and be located anywhere within flow channeling device, without departing from the scope of the present disclosure.

FIG. 13D illustrates a flow channeling device 1350 including a second channel 1356 for channeling hot fluid 1014 to receptacle 268. As described with respect to FIG. 10, fluid from heater tank 160 may be delivered directly to receptacle 268, however, because some cartridges 32 may be “multi-use” or “user-filled” cartridges, there may be occasions where fluid is employed through inlet nozzle 44 rather than diverted away from brew head 16. As such, some cartridges 32, as well as receptacle 30, may have other openings and/or channels 1355 for fluid to pass through.

Flow channeling device 1350, through second channel 1356 (and/or other channels), may couple to the openings in receptacle 30 such that when fluid delivered to cartridge 32 does not pass through outlet nozzle 400, such fluid may pass through opening 1355 and second channel 1356, and through a second conduit 1358 that bypasses impeller 456, for delivery to receptacle 268. Such an embodiment may be employed for certain beverages, e.g., tea, or for certain beverage mediums, such as instant soup, that may be present in dried form in receptacle 268. Further, such an embodiment may also be employed for reusable cartridges 32 where outlet nozzle 400 is not used.

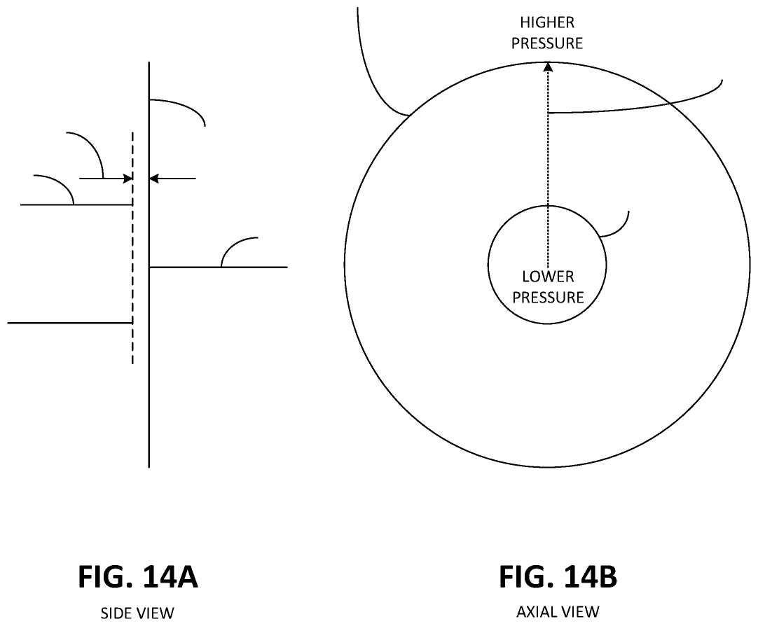

FIGS. 14A-14B illustrate views of the impeller in an aspect of the present disclosure.

FIG. 14A illustrates a side view of the impeller 456 and shaft 460 with respect to conduit 1216. The length of distance 1400 may determine how much suction impeller 456 may provide to fluid exiting conduit 1216. Further, any hydrostatic head pressure from second reservoir 1202 may provide additional pressure on fluid in conduit 1216.

FIG. 14B illustrates an axial view of conduit 1216 and impeller 456. As the distance 1402 increases from the rotational axis of impeller 456 to the circumference of impeller 456, the pressure created by rotation of impeller 456 increases.

As such, conduit 1216 may be placed at or near the rotational axis of impeller 456, and at a distance 1400 that allows for a differential in pressure between second reservoir 1202 and conduit 454 to “pull” or provide suction to fluid from second reservoir 1202 and conduit 454. In an aspect of the present disclosure, such placement of conduit 1216 with respect to impeller 456 may provide a self-priming feature for fluid in second reservoir 1202 as such a fluid passes from second reservoir 1202 to conduit 1216.

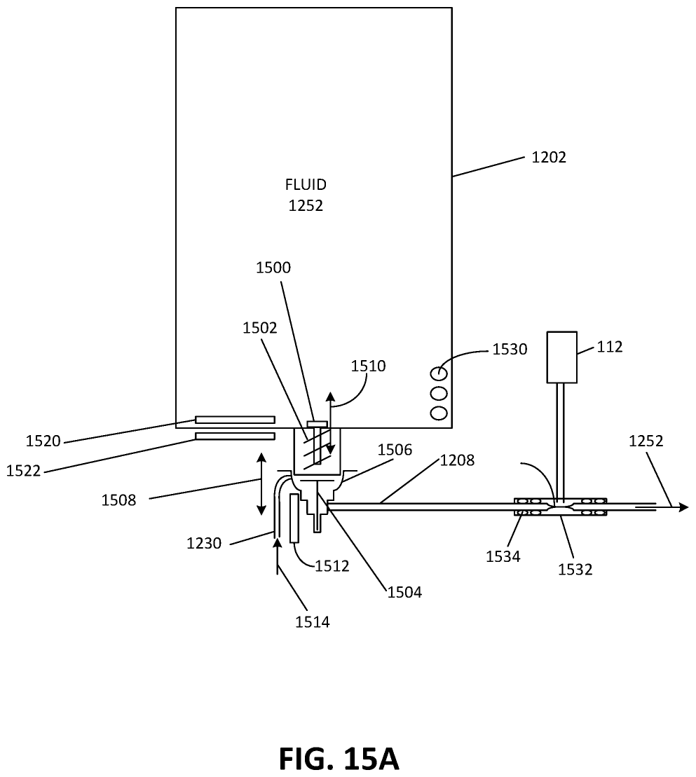

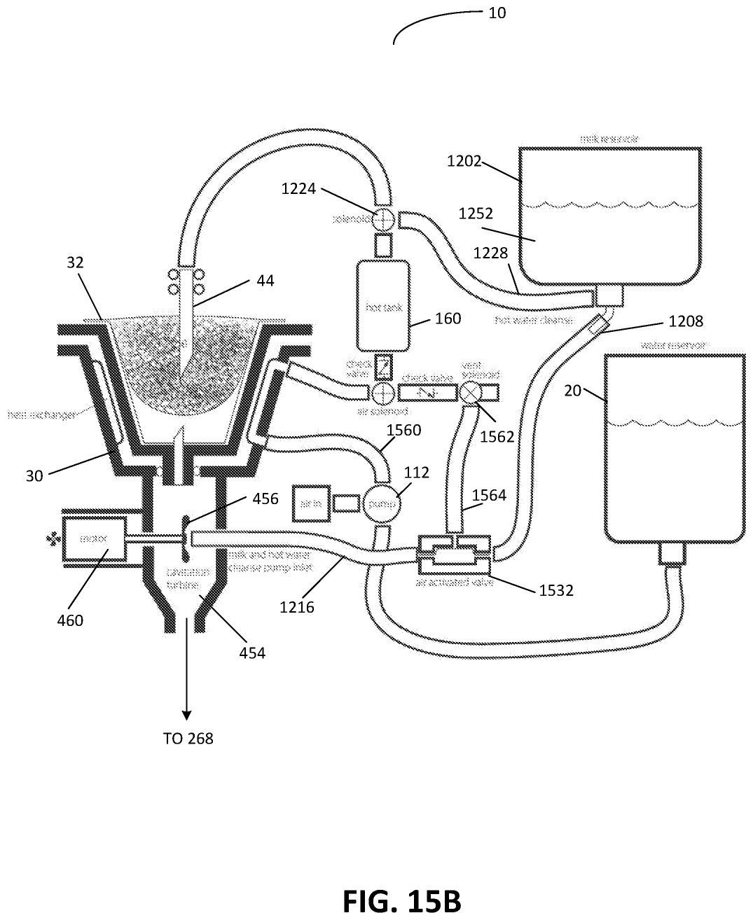

FIGS. 15A-15B illustrate an embodiment of the second reservoir in an aspect of the present disclosure.

As shown in FIG. 15A, second reservoir 1202 may comprise a valve 1500, which may include a spring 1502 that maintains valve 1500 in a position that allows second reservoir 1202 to be removed from system 10 and hold fluid. Such a position may be called a “closed” position for valve 1500.

As second reservoir 1202 is positioned in system 10, valve 1500 is contacted by piston 1504, which may be located in housing 1506. As second reservoir 1202 is moved in direction 1508, piston 1504 moves valve 1500 to an open position in direction 1510 that allows fluid flow from second reservoir 1202 to conduit 1208. Valve 1500 and/or piston 1504 may have specific shapes to provide certain movement of valve 1500, and valve 1500/piston 1504 may have openings or aerators to provide aeration of fluid flowing into conduit 1208. Fluid 1252 then flows from conduit 1208 as described with respect to FIG. 12.

As second reservoir 1202 is moved in the opposite direction (away from housing 1506), valve 1500 is returned to the closed position shown by arrow 1510, preventing fluid from flowing out of second reservoir 1202 through valve 1500. In other words, as second reservoir is introduced into system 10 in a “downward” (as shown in the perspective of FIG. 15) direction 1508, valve 1510 is moved “upward” to an open position in direction 1510. When second reservoir is removed from system 10 in an upward direction 1508 (as shown in the perspective of FIG. 15), the valve 1500 is moved “downward” to a closed position in direction 1510.

Conduit 1230 allows for fluid 1514 to be used to clean housing 1506. By shaping the housing 1506, and, if desired, the shape and/or aeration of piston 1504, fluid 1514 may remain substantially within housing 1506. For example, and not by way of limitation, the shape of housing 1506 may be that of a vortex funnel, or a parabolic bowl, such that the fluid 1514 flow around and/or within housing 1506 will cause fluid 1514 to be substantially delivered to conduit 1208, rather than out of the housing 1506.

Piston 1504 may also be able to rotate, such that piston 1504 may act as an impeller, aerator, or other beating or whipping device for fluid 1252. Piston 1504 may be coupled to an induction motor 1512 to rotate piston 1504 at appropriate times, e.g., during delivery of fluid 1252. Similarly, induction plates (coils) 1520 and 1522 may be included to heat fluid 1252 as desired. The induction plate 1522 may be coupled to an alternating current (AC) source within system 10, and inductively coupled to plate 1520. When sensor(s) indicate the presence of second reservoir 1202, and at the appropriate times as determined by a user and/or processor 512, inductive plate 1522 may be coupled to AC power which will induce a current in inductive plate 1520, which may heat the secondary fluid 1252. Further, the AC power may be coupled to induction motor 1512 to rotate piston 1504, either in conjunction with, in series with, or in parallel with the inductive heating of secondary fluid 1252. Such an induction motor 1512 may comprise, for example, a magnetic core as part of piston 1504 (wherein the core is isolated or conformally coated to avoid contact with secondary fluid 1252), and windings in motor 1512 to spin, rotate, or otherwise move piston 1504. Further, piston 1504 may have a designed shape or raised portions to assist in the generation of aerated or gaseous mixtures within secondary fluid 1252.

Alternatively, or in conjunction with the above aspect of the disclosure, heating coils 1530 may be used to heat secondary fluid 1252. The heating coils 1530 may be coils coupled to the heating tank 160, either using recirculating fluid from reservoir 20, or may be electrical coils that are coupled to AC power for heating secondary fluid 1252. Other devices and methods for heating secondary fluid 1252 are possible.

Valve 1532 may be used to close conduit 1208 using air pressure from pump 112, or from another air pump within system 10. Conduit 1208 may be sealed within valve 1532 using seals 1534. A section 1536 of conduit 1208 may have thinner walls than other portions of conduit 1208, and this section 1536 of conduit 1208 may be exposed to air pressure from pump 112 to squeeze section 1536 closed, i.e., to substantially limit the flow of fluid 1252 through conduit 1208. Pump 112 may be coupled to valve 1532 through any series of solenoid valves, etc., and valve 1532 may be operated (i.e., opened or closed) at any time as desired without departing from the scope of the present disclosure.

FIG. 15B illustrates a schematic diagram of air flow in an aspect of the present disclosure.

As shown in FIG. 15B, reservoir 20 is coupled to pump 112, and to solenoid 88 to deliver fluid (water) to heater 160. Heated fluid is then delivered to inlet nozzle 44, which delivers the fluid to cartridge 32 in receptacle 30. The fluid from receptacle 20 is also delivered to pump 112 and through conduit 1560 to receptacle 30 to cool cartridge 32 when heated fluid is delivered through inlet nozzle 44 and/or at other times. As fluid passes through cartridge 32 to second chamber 454, impeller 456 may be turned by motor 460 to further process fluid to be delivered to receptacle 268.

Second fluid 1252 is delivered from second reservoir 1202 through conduit 1208 and to valve 1532. When valve 1532 is open, second fluid (milk, cream, or other liquid) is delivered to a low pressure zone in second chamber 454 created by impeller 456 to be mixed with the fluid from cartridge 32, either during production of the fluid from cartridge 32, and/or before and/or after production of the fluid from cartridge 32.

To clean the second fluid line, valve 1224 is changed to deliver hot fluid from heater 160 to conduit 1228. Pump 112 then delivers fluid from heater 160 through conduit 1228, and through conduit 1208, valve 1532, and conduit 1216 to impeller 456, and out conduit 454. The cleaning fluid can be delivered to platen 14, or to another reservoir (not shown) as desired.

To close valve 1532, valve 1562 is opened and air is pumped into conduit air purge system 10, vent solenoid 126 is opened and pump 112 pumps air either into conduit 1564 and/or out of conduit 1564 to squeeze conduit 1208 closed within valve 1532. To maintain pressure on valve 1532, valve 1562 may be closed during pump 112 operation, which will maintain the pressure in conduit 1564 and thus maintain pressure on conduit 1208 inside valve 1532.

FIGS. 16A-16F illustrate a cartridge reader in accordance with an aspect of the present disclosure.

As shown in FIG. 16A, system 1800, which may be included in system 10, shows inlet nozzle 44 rotating in a direction 1802. As inlet nozzle 44 rotates, disk 1804, which is coupled to inlet nozzle 44, also rotates in direction 1802. Disk 1804 may be a conductive material, such as steel, tin, aluminum, or any other metal or conductive material. Disk 1804 comprises a plug 1806 of a different material than disk 1804. Plug 1806 may comprise a magnetic material, such as ferrite, in an aspect of the present disclosure.

A sensor 1808, such as a Hall Effect sensor, with leads 1810, may be coupled to processor 512. As disk 1804 rotates, plug 1806 passes over an annular ring defined by the distance between diameter 1812 and diameter 1814 of the cover 49 of the beverage cartridge 32. FIG. 16B illustrates a top view of the disk 1802. Such diameters 1812 and 1814 may be near the flange, lip, or edge of beverage cartridge 32 as shown, but may also be in any location without departing from the scope of the present disclosure.

In FIG. 16C, a top view of cover 49 of a beverage cartridge 32 is shown, with plug 1806 shown in dashed lines to indicate a position over cover 49. Cover 49 may be screen printed or otherwise coated with a magnetic substance, e.g., ferrite-infused ink, ferrite particles, or other magnetic materials either in cover 49 or coupled to cover 49, to create a change in magnetic field as disk 1804 rotates. As shown in FIG. 16C, areas 1816-1822 are areas of magnetic material that are coated or otherwise coupled to cover 49.

As inlet nozzle 44 rotates in direction 1802, plug 1806 also rotates and encounters areas 1816-1822. FIG. 16D illustrates the pulses read by sensor 1808 through wires 1810. The period 1824 of repetition for the pattern of the output of sensor 1808 is also shown. The pulse for area 1820 may be larger because the sensor 1808 not only detects the change in field for the plug 1806, sensor 1808 will also detect a change in field because of plug 1806 being proximate to the sensor 1808. As such, a larger spike in output of the sensor 1808 is shown. The larger spike generated when plug 1806 passes proximate the sensor 1808 also provides system 10 with the ability to determine a full rotation of the plug 1806, and thus the pattern or period 1824 of a particular cover 49.

A different pattern for a different cover 49, which may indicate a different type of beverage medium, is shown in FIG. 16E, and the corresponding sensor 1808 output is shown in FIG. 16F. Because the pattern of spikes for areas 1826-1834 shown in FIG. 16F is different than that of FIG. 16D, processor 512 can differentiate between a beverage cartridge 32 having a cover 49 with the pattern shown in FIG. 16C from a beverage cartridge having a cover 49 with the pattern shown in FIG. 16E. Further, through the use of different shapes, distances between shapes, and different numbers of shapes for areas 1816-1822 and/or 1826-1834, any number of different patterns can be created. As such, any number of different beverage cartridges 32 may be differentiated by the system 1800 of the present disclosure. Pulse 1836 is shown as a pulse that is generated from the plug 1806 passing in front of sensor 1808. Period 1838 of the waveform is also shown in FIG. 16E.

Through the use of “dot-dash” or different patterns for areas 1816-1822 and/or 1826-1834 of ferrite and/or magnetic materials on cover 49, a determination of which type of cartridge 32 is present in system 10 may be performed. Processor 512 may, for example, merely count the pulses between the large pulses (e.g. pulse 1836) and determine from the number of pulses counted what type of cartridge 32 is present in the brewing head 16. The processor 512 may then determine a particular preparation cycle for that particular cartridge 32.

Although shown as a plug 1806, other forms of material, such as an annular ring, several plugs 1806 at different distances from the rotational axis of inlet nozzle 44, etc., may be employed without departing from the scope of the present disclosure. The use of different plug(s) 1806 may also employ different sensors, e.g., an optical plug 1806 with brushes may be coupled to an optical sensor 1808, etc., such that the patterns of material on cover 49 may be read and/or processed to differentiate between different cartridges 32.

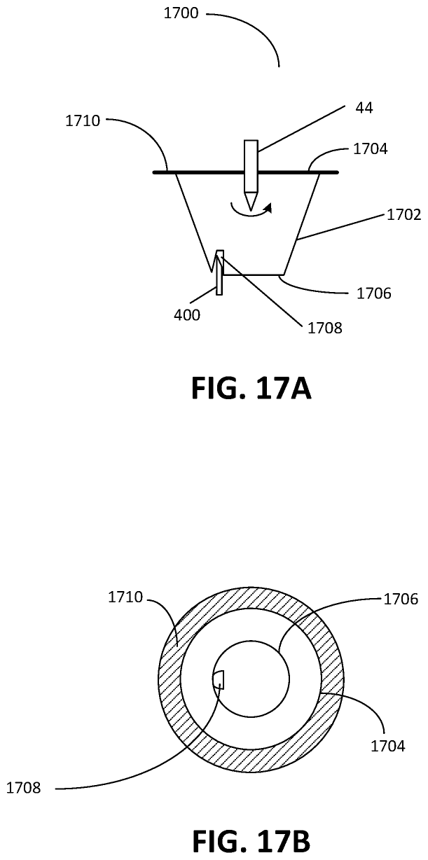

FIGS. 17A-17B illustrate a reusable cartridge in accordance with an aspect of the present disclosure.

FIG. 17A illustrates a side view of a cartridge 1700 that may be filled by a user with their own choice of beverage medium. However, in some aspects of the present disclosure, the reusable cartridge may be pierced by the outlet conduit 400 if the cartridge 1700 is not properly designed. As such, cartridge 1700, may comprise a body 1702, a first (or top) surface 1704 (which may be just a plane and open for filling with a beverage medium), a second (or bottom) surface 1706, a recess 1708, and a flange 1710. The overall dimensions of cartridge 1700 may be similar to that of cartridge 32.

FIG. 17B is a top view of cartridge 1700, which illustrates that recess 1708 may be placed such that cartridge 1700 may fit in certain orientations within brewing head 16, while cartridge 1700 may appear to a user to not fit in brewing head 16 in other configurations. Recess 1708 may accept outlet conduit 400 only in certain orientations. As such, the position of recess 1708 with respect to second surface 1706 may provide a specific orientation for cartridge 1700. An annular ring recess 1708 may also be provided to allow cartridge 1700 to fit in any orientation with respect to outlet conduit 400.

In an aspect of the present disclosure, flange 1710 may also be encoded with information, e.g., magnetic areas similar to those discussed with respect to FIGS. 16A-16F, to allow system 10 to determine that cartridge 1700 is being utilized in brewing head 16, e.g., through processor 512 and sensor 1808. System 10 may also allow for user programming for cartridge 1700 use in system 10, e.g., brew time, crema generation, temperature, etc., by allowing user inputs to system 10 and/or processor 512. As an example, and not by way of limitation, a special pattern of magnetic material(s) for cartridge 1700 on flange 1710 may be employed such that system 10 can recognize cartridge 1700 as being different than other cartridges 32 used in system 10.

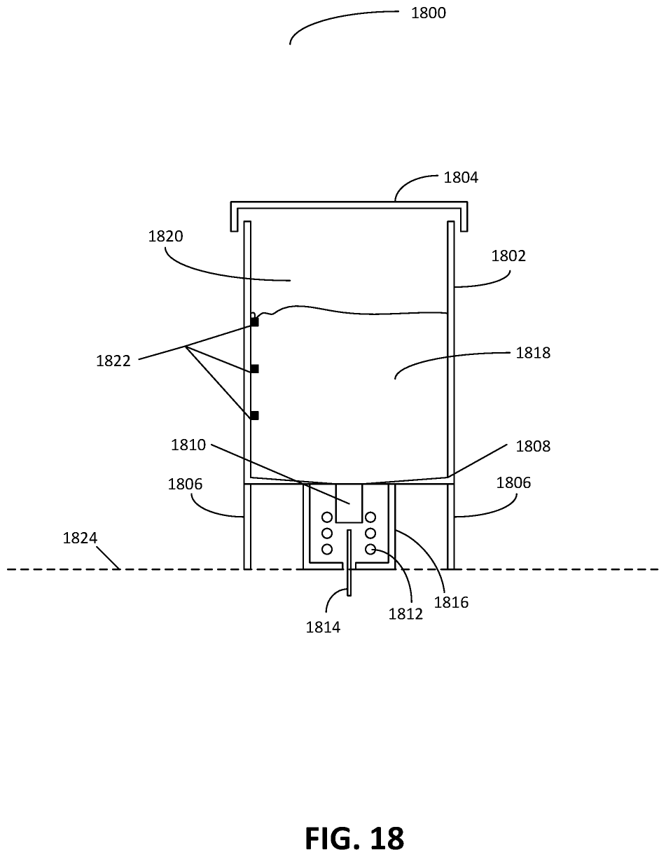

FIG. 18 illustrates a fluid container in an aspect of the present disclosure.

Container 1800 is shown in a cross-sectional view, and comprises a body 1802 and a lid 1804. Container 1800 may optionally comprise one or more legs 1806, which may be an extension of body 1802 below a level 1808 of body 1802. Coupled to body 1802 is a valve 1810, which may be activated by spring 1812 and pin 1814. A housing 1816 may be provided to contain spring 1812 and pin 1814 and maintain a desired coupling between pin 1812 and valve 1810.

Body 1802 may hold a quantity of liquid 1818, and may also have sufficient volume to hold a gas 1820. Liquid 1818 may be milk, cream, other dairy or non-dairy products, or may be another liquid to be used in system 10. Gas 1820 may be air, or may be nitrogen, carbon dioxide, or other gas to be used in system 10, or gas 1820 may be air that is vented into body 1802 as liquid 1818 flows out of body 1802 through valve 1810.

To fill container 1800, lid 1804 is removed and a desired quantity of liquid 1818 is placed in body 1802. Markers 1822 may be placed on body 1802 to show some often-used quantities of liquid 1818, e.g., 2 fluid ounces, 4 fluid ounces, 6 fluid ounces, etc. Lid 1804 is placed back onto body 1802. Liquid 1818 may be heated in system 10, or may be heated separately by placing container 1800 into a microwave, or liquid 1818 may have been heated prior to adding liquid 1818 into body 1802.

Legs 1806 may be provided to allow container 1800 to stand on one side 1824 of container 1800. Legs 1806 may be used for, as an example, to place container 1800 into a microwave after liquid 1818 has been added to container 1800, such that container 1800 is stable and not easily tipped over during movement of container 1800, either in a microwave or while container 1800 is placed on another surface. Container 1800 may also be placed on lid 1804 as a stable surface when container 1800 is moved or in a microwave.

Valve 1810 provides a flow port for liquid 1818, as well as optionally providing a vent port for container 1800. For example, when liquid 1818 is added to container 1800, and lid 1802 is placed on body 1802, container 1800 may be placed on lid 1804 and liquid 1818 will not leak out of container 1800. However, if container 1800 is placed in a microwave to heat liquid 1818, the expansion and possible boiling of liquid 1818 will create vapors that will need to escape from container 1800. Valve 1810 provides a vent port to allow vapors to escape from container 1800 during such operations.

Valve 1810 also allows for drainage of liquid 1818 from container 1800. After liquid 1818 is prepared (if such preparation is necessary), placing container 1800 into brewer head 16 pushes pin 1814, releasing valve 1810 and allowing liquid 1818 to flow into brewer head 16. This may be done when the brewer head 16 is in an open position, such that container 1800 is not enclosed in brewer head 16 when liquid 1818 is flowing from container 1800 through system 10.

Spring 1812 and pin 1814 may be made of plastic or other non-metallic material, since container 1800 may be placed in a microwave or other heating device that may deleteriously affect the heating of liquid 1818 or adversely affect the heating device. Pin 1814 may be coupled to container 1800, or may be coupled to system 10, as desired.

If necessary, lid 1804 may also provide a vent port for container 1800. Lid 1804 may be slightly removed, loosened, or may be slightly opened when container 1800 is placed in brewer head 16. Further, other venting possibilities, e.g., where pin 1814 opens another valve in container 1800 when container 1800 is placed in brewer head 16, are also possible without departing from the scope of the present disclosure.

Container 1800 may be placed in brewer head 16 when receptacle 30 is present in brewer head 16, or receptacle 30 may be removed from brewer head 16 such that container 1800 may be placed in brewer head 16. The design and contours of housing 1816 may be arranged such that container 1800 is compatible with brewer head 16 in any configuration of brewer head 16, receptacle 30, or other devices. Further, pin 1814 may be optional, as receptacle 30 may employ outlet nozzle 400 to move valve 1810. Many configurations are possible for container 1800 without departing from the scope of the present disclosure.

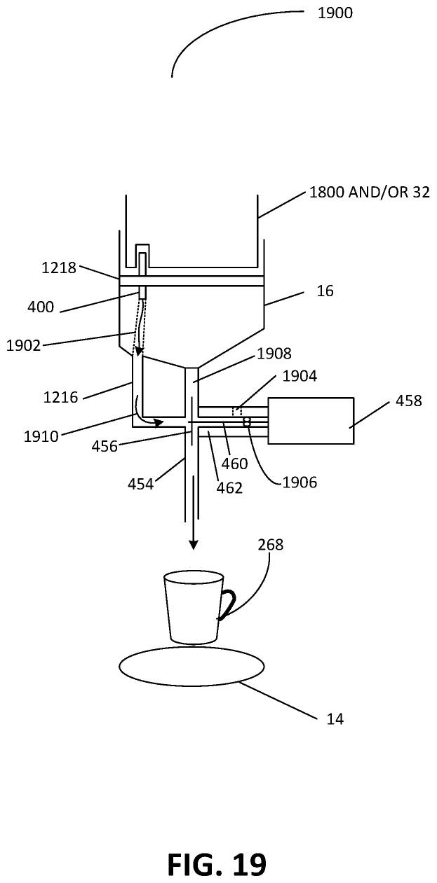

FIG. 19 illustrates a portion of the system in accordance with an aspect of the present disclosure.

Portion 1900 of system 10 may be designed to accept either receptacle 30 and/or container 1800 in brewer head 16. Flow path 1902 may be used to direct liquid in container 1800 to impeller 456 via conduit 1216 as well as directing liquid from inlet nozzle 44 (selectively through cartridge 32 as desired) through conduit 1216. Sensors or other mechanical, electrical, electro-mechanical, or optical devices may be employed to determine when to turn on motor 458, and at what speed, duration, etc., depending on the detected presence of receptacle 30, specific beverage cartridge 32, and/or container 1800.

Vent 1904 may be provided to reduce the pressure differential between sleeve 462 and conduit 1216. Seal 1906 may also be provided to reduce the liquid flow to motor 458. Volume 1908 may also be a closed volume in conduit 454. Volume 1908, and the size of vent 1904, and/or the diameter of conduit 454, may be designed as part of system 10 to increase, decrease, or control the amount of available air that can be integrated and/or otherwise combined with any liquid 1910 flowing in conduit 1216. For example, and not by way of limitation, vent 1904 may be a 1/16^{th} of an inch diameter hole, and volume 1908 may be a 3 cubic centimeter (cc) volume (i.e., the volume of conduit 454 opposite the exit port of conduit 454). The length of conduit 454 may be one inch. This particular combination of available air (at room pressure, which may be approximately atmospheric pressure, or 1 ATM) and available added air (through vent 1904) may provide proper aeration of milk, creation of crema for coffee, and/or other desired aeration, crema creation, and/or frothing of liquids 1910 traversing conduit 1216 and flowing past impeller 456. Other diameter vent 1904 holes, multiple vent holes, other volumes 1908, and/or other diameters and/or lengths of conduit 454 are possible without departing from the scope of the present disclosure. The speed, duration, and other parameters of operation of motor 458 may be selectively controlled by processor 512, and may be based, at least in part, on the presence and/or absence of receptacle 30 and/or container 1800.

Because system 1900 may accept both container 1800 and/or receptacle 30, any user of system 10 may prepare a milk-based drink with the milk portion of the drink first, or may prepare the same milk-based drink with the coffee portion of the drink first. If the milk portion of the drink is made first, the coffee portion, when passing through conduit 1216 and having the crema created as described herein with impeller 456, the coffee portion will “mark” the milk (i.e., the milk froth) that had previously been dispensed into receptacle 268.

Although shown on one side of sleeve 462, vent 1904 may be placed anywhere in sleeve 462 without departing from the scope of the present disclosure. Further, vent 1904 may be placed in other locations within system 10, e.g., in conduit 1216, and may have different dimensions, without departing from the scope of the present disclosure.

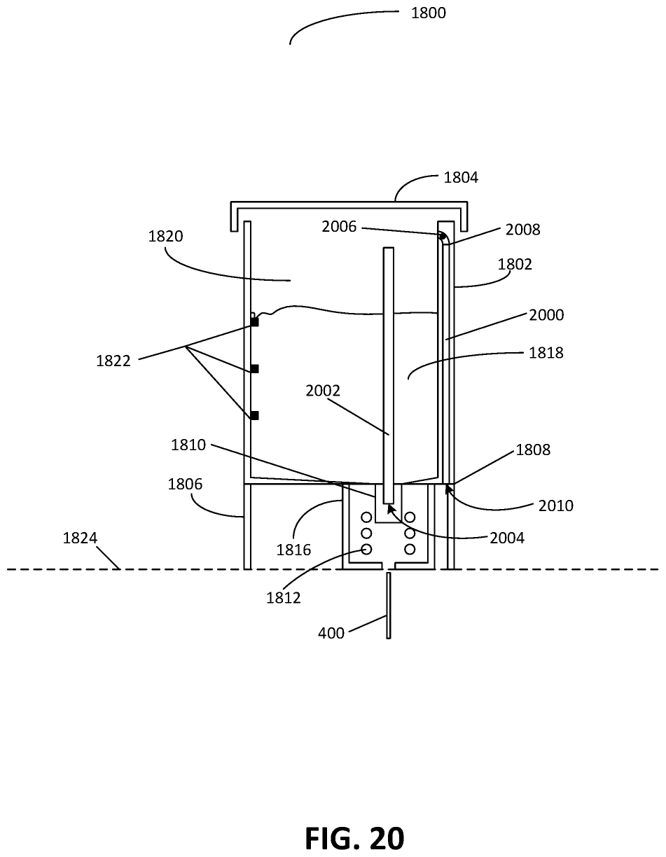

FIG. 20 illustrates a liquid container in accordance with another aspect of the present disclosure.

Container 1800 is shown, comprising a tube 2000 in body 1802. Alternatively, or in addition, container 1800 may also comprise tube 2002. If tube 2002 is present, when container 1800 is placed in brewer head 16, outlet nozzle 400, when engaging valve 1810, allows air 2004 into tube 2002, which will help evacuate fluid 1818 from container 1800, as now volume 1820 is coupled to atmosphere, and the hydrostatic head of fluid 1818 will evacuate container 1800.

If tube 2000 is present, a stopper 2006 and ridge 2008 may also be present. As container 1800 is placed with the lid 1804 down (closer to the ground than valve 1810), stopper 2006 will move within tube 2000 to the portion of tube 2000 that is along an inner wall of container 1800. If the container 1800 is then filled with liquid 1818, stopper 2006 may be moved up to ridge 2008, but is prevented from travelling further in tube 2000 because ridge 2008 limits the range of motion of stopper 2006.

When container 1800 is turned over, stopper 2006 will “fall” downward toward ridge 2008. However, liquid 1818 is now in the “bottom” of container 1800 (i.e., closer to valve 1810). Thus liquid 1818 cannot travel through tube 2000 because liquid is not proximate stopper 2008 or the portion of tube 2000 that engages the inner portion of container 1800. The other end of tube 2000 may be coupled to atmosphere, or to pump 112, such that gas 2010 enters tube 2000 as shown and aids the evacuation of liquid 1818 from container 1800. If tube 2000 is coupled to pump 112, pump 112 may be controlled by processor 512 to provide a desired pressure at which to evacuate container 1800.

Other methods for assisting the evacuation of container 1800, e.g., hydrostatic pressure, pump 112, gravity-assistance, or other methods, are possible given the teachings of the present disclosure. Such methods, alone or in any combination, may be employed in system 10 without departing from the scope of the present disclosure. For example, and not by way of limitation, pump 112 may be coupled to lid 1804 or body 1802 after container 1800 is coupled to brewer head 16. Pump 112 may be coupled through valves, or may be coupled directly to lid 1804, body 1802, or some other portion of container 1800 as desired for container 1800, without departing from the scope of the present disclosure. Further, container 1800, in any aspect described herein, may be combined with the system 10 as shown in FIG. 15B, such that more than two liquids may be supplied to system 10 if desired.

### Gravity-Fed Second Fluid System

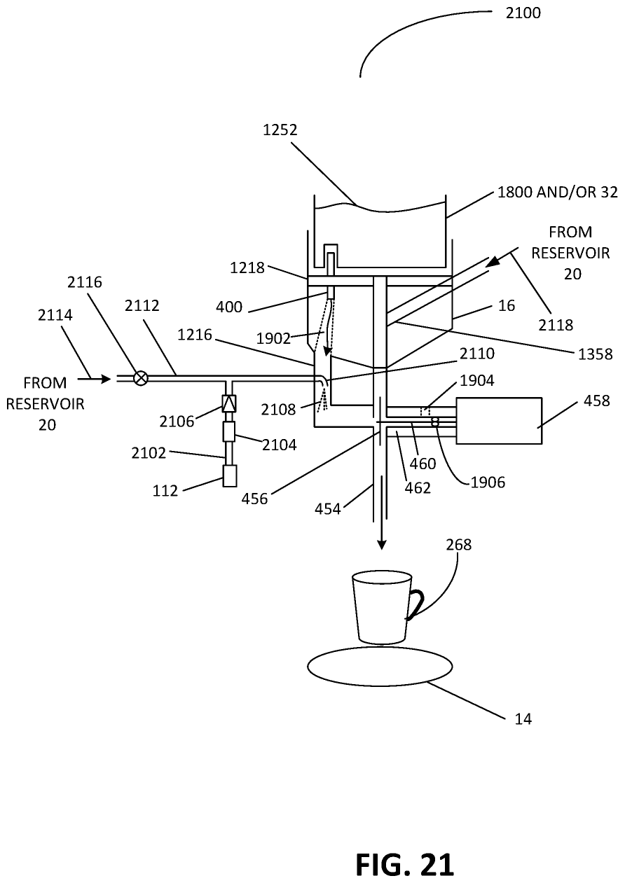

FIG. 21 illustrates a portion of the system in accordance with an aspect of the present disclosure.

System 2100, which may be a part of system 10 or other system in accordance with an aspect of the present disclosure, allows for a gravity-fed second fluid 1252 delivery through receptacle 30. When container 1800 is placed into receptacle 30, second fluid 1252 may be added to container 1800. The second fluid 1252 is delivered to receptacle 268 via conduits 1216 and 454.

System 2100 may employ pump 112 to pump liquid from reservoir 20 through conduit 2102 and optional heater 2104. Heater 2104 may be part of or coupled to heater 160 if desired. In one embodiment, heater 2104 produces steam and/or vapor, which is then pressurized in conduit 2102, along with the pressure provided by pump 112, to open check valve 2106 and force vapor 2108 through nozzle 2110 which is located in and/or adjacent to conduit 1216. Nozzle 2110, and, if desired, conduit 2112, may be made of a thermally conductive material such as stainless steel, other metals, etc., that are able to withstand food contact without deleterious effects to taste, health, and other factors. The vapor 2108 heats conduit 2112 and nozzle 2110, which may provide additional heating surface to heat second fluid 1252. Further, as the hydrostatic pressure of second fluid 1252 is reduced, vapor 2108 may travel upward into container 1800, and provide heating to second fluid 1252 within container 1800. Depending on the heat transfer design between nozzle 2110 and conduit 2112, second fluid 1252 may be provided at the storage temperature of second fluid 1252 and be raised to a desired drinking temperature by system 2100. For example, and not by way of limitation, second fluid 1252 may be milk that was refrigerated at 40 degrees Fahrenheit just prior to adding the milk to container 1800. System 2100, through conduit 2112 and/or nozzle 2110, may raise the temperature of the milk to 190 degrees Fahrenheit.

As vapor 2108 exits nozzle 2110, a venturi effect may be created in conduit 1216, which assists the flow of second fluid 1252 through conduit 1216 and toward impeller 456 (if present). Impeller 456 also provides flow assistance and heating of second fluid 1252, as the second fluid 1252 is directed toward the low pressure portion of impeller 456.

Further, vapor 2108 may be provided for a portion of time after second fluid 1252 has drained from container 1800. System 2100, and thus system 10, may determine the evacuation of second fluid 1252 in any way, including timing the fluid drain, monitoring the motor 458 current draw, or other methods without departing from the scope of the present disclosure. Continuing vapor 1800 flow after second fluid 1252 has been evacuated from container 1800 (and thus conduit 1216 and conduit 454) may provide several advantages to system 2100, such as maintaining a temperature of second fluid 1252 in receptacle 268, more complete delivery of second fluid 1252 to receptacle 268, removing some or all of the residual portions of second fluid 1252 from conduits 1216 and 454, preparing system 2100 for subsequent use, and/or other advantages. Vapor 2108 may also be provided for a portion of time after second fluid 1252 has passed nozzle 2110, which can also provide some of these beneficial effects.

In an aspect of the present disclosure, pump 112 may also provide heated fluid 2114 from reservoir 20 through a valve 2116 to conduit 2112. Fluid 2114 may be provided in addition to, or instead of, vapor 2108. Fluid 2114 may be used, for example, to dilute second fluid 1252, heat second fluid 1252, ensure complete delivery of second fluid 1252 to receptacle 268, remove some or all of the residual portions of second fluid 1252 from conduits 1216 and 454, as well as other advantages and features. For example, if second fluid 1252 is a concentrated fluid such as a syrup, system 2100 may employ fluid 2114 to heat second fluid 1252 and dilute second fluid 1252 such that a desired taste may be presented in receptacle 268. In one embodiment, heater 2104 may heat fluid 2114 to boiling and/or to a temperature higher than fluid heated by another heater such as heater 160. Thus, the combination of fluid 1252 and fluid 2114 can have a temperature closer to or equal to fluid from heater 160, such that the temperature of the final beverage delivered to receptacle 268 is not lowered or is lowered less by the addition of fluid. To ensure complete delivery of second fluid 1252, fluid 2114 and/or vapor 2108 may be employed in system 2100 to provide proper dilution, cleaning of conduits 1216 and 454, and/or preparing system 2100 for subsequent use.

In an aspect of the present disclosure, system 2100 may, alternatively or in conjunction with the aforementioned aspects, deliver fluid 2118 through secondary outlet 1358. As with fluid 2114, fluid 2118 may be provided in addition to, or instead of, vapor 2108 and/or fluid 2114. Fluid 2118 may be used, for example, to dilute second fluid 1252, heat second fluid 1252, ensure complete delivery of second fluid 1252 to receptacle 268, removing some or all of the residual portions of second fluid 1252 from conduits 1216 and 454, as well as other advantages and features. For example, if a user of system 10 wants a caramel flavored Americano (espresso and hot water), second fluid 1252 may be a concentrated flavored syrup. The user may enter a specific amount of drink, e.g., 12 ounces, and place the flavored syrup in container 1800. System 2100 may employ vapor 2108 to heat second fluid 1252 and dilute second fluid 1252 with fluid 2118 such that a desired taste may be presented in receptacle 268. To ensure complete delivery of second fluid 1252, fluid 2118, fluid 2114, and/or vapor 2108 may be employed in system 2100 to provide proper dilution, cleaning of conduits 1216 and 454, and/or preparing system 2100 for subsequent use.

After second fluid 1252 is delivered, whether delivered with vapor 2108, fluid 2114, and/or fluid 2118, a beverage cartridge 32 may be introduced into receptacle 30. The system 2100 may have been programmed by the user, or pre-programmed, to deliver a specific amount of fluid from reservoir 20 to prepare a beverage from the beverage cartridge, or the user may input additional commands and/or data to the system 2100 to prepare the beverage to be delivered to receptacle 268. The beverage delivered from beverage cartridge 32 may be combined with the second fluid/vapor 2108/fluid 2114/fluid 2118 beverage to create any number of beverages delivered to receptacle 268. For example, and not by way of limitation, the process of alternating between beverage cartridge 32 and container 1800 (and/or second fluid 1252) may be repeated as many times as desired to create a layered or “stratified” beverage, (e.g., a “black and tan” strata of stout and ale, a coffee layer with a foam topping, etc.). Providing a beverage that will not spoil (e.g., black coffee) after a beverage that may spoil (e.g., dairy-based products such as milk) can be beneficial in that the non-spoiling beverage can clean the system of remnants of the spoiling beverage.

In another embodiment of the present invention, fluid from a cartridge (e.g., coffee) may be provided simultaneously with second fluid 1252. For example, fluid 2118 can be provided from reservoir 20 and through a cartridge, and combine with second fluid 1252 at a later point, such as at impeller 456. Thus, the finalized beverage can exit conduit 454, without substantial mixing occurring in receptacle 268 (which may occur in methods where one fluid, e.g., heated milk, is provided to receptacle 268 prior to another fluid, e.g., coffee).

In an aspect of the present disclosure, system 2100 allows for gravity-fed delivery of a second liquid 1252, which may be pressure-assisted by vapor 2108, fluid 2114, and/or 2118, as well as pressure assisted by impeller 456. System 2100 also provides for cleaning of conduits employed to deliver second liquid 1252, for complete delivery of second liquid 1252, preparation of system 2100 for subsequent use, and to help avoid possible after-taste and/or other deleterious effects of residual presence of second liquid 1252 in system 2100. System 2100 also allows for use of a container 1800 to deliver second fluid 1252 that employs the same receptacle 30 as beverage cartridge 32, thereby decreasing complexity of system 2100 when employed to produce more complex beverages.

It is understood that while the above may have described gravity-fed systems, systems utilizing pumps or other mechanisms in place of gravity can be employed.

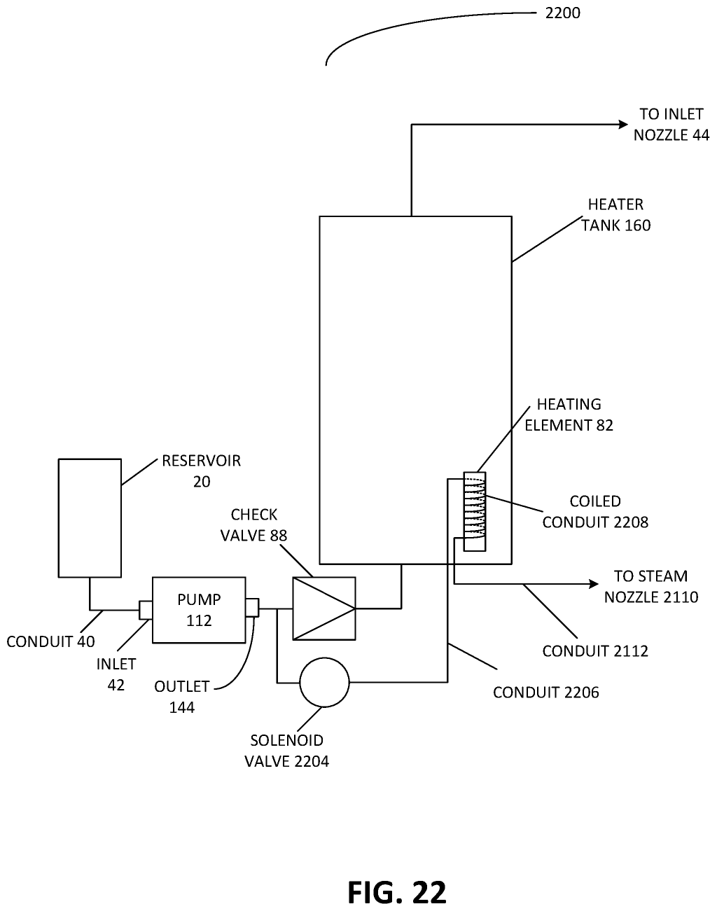

FIG. 22 illustrates a steam generator in accordance with an aspect of the present disclosure.

Generator 2200 may be embodied in system 10 by coupling a conduit 2202 to outlet 144 of pump 112, which is then able to carry fluid from reservoir 20. Conduit 2202 may then be coupled to solenoid valve 2204, which may be placed elsewhere in the fluid flow between pump 112 and steam nozzle 2110 if desired. As shown in FIG. 22, solenoid valve 2204 may then be coupled to conduit 2206, which is coupled to coiled conduit 2208. Coiled conduit 2208 may then be coupled to conduit 2112, which is coupled to steam nozzle 2110.

Conduits 2202, 2206, 2208, and 2112 may be a single piece of conduit, or multiple pieces of conduit, depending on the configuration employed, without departing from the scope of the present disclosure. Conduits 2202, 2206, 2208, and 2112 may also be made from different materials as desired without departing from the scope of the present disclosure.

Coiled conduit 2208 is proximate heating element 82, which provides heat to heater tank 160. Coiled conduit 2208 may be a stainless steel conduit, and may be welded or otherwise coupled to heating element 82, such that coiled conduit 2208 not only provides thermal energy to any fluid inside coiled conduit 2208, coiled conduit 2208 may provide thermal energy to fluid in heater tank 160. Coiled conduit 2208 may also be of a small diameter, such that heating element 82 provides a large amount of thermal energy to any fluid in coiled conduit 2208.

When solenoid valve 2204 is open, and heating element 82 is energized, fluid (e.g., water) will flow through conduit 2202, solenoid valve 2204, and conduit 2206 to coiled conduit 2208. Since coiled conduit 2208 is thermally coupled, and, in some aspects of the present disclosure, in thermal contact with heater element 82, fluid in coiled conduit 2208 will receive thermal energy from heater element 82. Because coiled conduit 2208 may be of small diameter, the amount of thermal mass of the fluid in coiled conduit 2208 may be small, and likely smaller than the thermal mass of the fluid in heater tank 160. Heating element 82 often provides a large thermal energy transfer, e.g., on the order of 1500 watts, and as such is often at an elevated temperature, e.g., 1100 degrees Fahrenheit. The application of such energy to a small thermal mass of fluid in coiled conduit 2208 raises the temperature of the fluid in coiled conduit 2208 beyond the boiling point of the fluid. As such, the fluid in coiled conduit 2208 changes phase from liquid to vapor.

As the temperature of the fluid in coiled conduit 2208 rises, so does the pressure in coiled conduit 2208. The solenoid valve 2116, which is coupled between conduit 2112 and steam nozzle 2110, may be opened to allow the pressurized vapor to be delivered to conduit 454 through steam nozzle 2110. Alternatively, solenoid valve 2204 may be omitted, and solenoid valve 2116 may control the delivery of vapor to conduit 454 through steam nozzle 2110.

In an aspect of the present disclosure, the coiled conduit 2208 may be coupled to a separate heating element 82 other than that in the heater tank 160. In such cases, when the heating element 82 for coiled conduit 2208 is energized, and the heating element(s) 82 for the heater tank 160 are energized at the same time, the current draw for system 10 may exceed the current capabilities of the power source for system 10. For example, and not by way of limitation, the heating elements 82 for heater tank 160 may consume 1500 watts of power, and the heating element 82 for coiled conduit 2208 may consume 500 watts of power. At 110 volts AC, system 10, just for the heating elements, may draw over 18 amperes of current. This may be larger than the circuit breaker or fuse that is in series with the wall plug where system 10 is plugged in. Such a condition may trip the circuit breaker or blow the fuse.

In such an aspect, system 10, either through processor 512 or through other means, may control the current drawn by system 10. In one aspect of the present disclosure, system 10, either through processor 512 or through other means, may not allow the heating element 82 for coiled conduit 2208 to be energized when heating element 82 for heater tank 160 is energized. In another aspect, system 10, either through processor 512 or through other means, may provide proportional input power to one or more of the heating elements 82 to reduce the overall current draw of system 10. For example, and not by way of limitation, system 10 may allow full power to heating element 82 for coiled conduit 2208, but reduce the power supplied to heating element 82 in heater tank 160. Such reduced power may be based on what portion of a brew cycle system 10 is in, temperature of the fluid in heater tank 160, or other conditions as desired without departing from the scope of the present disclosure.

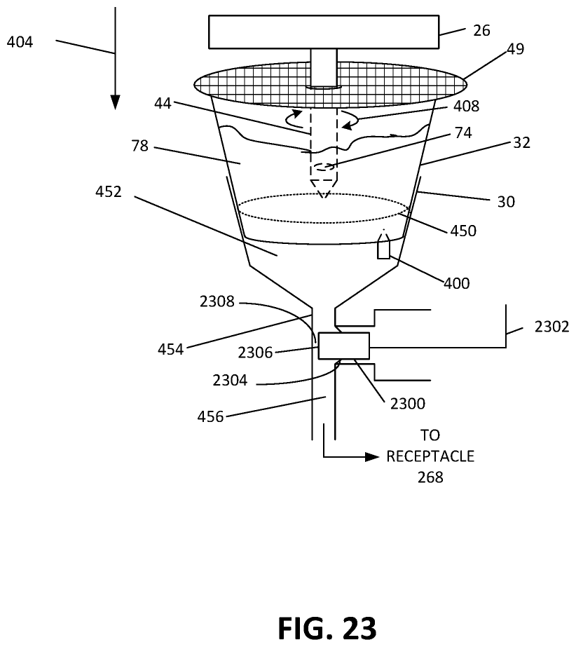

FIG. 23 illustrates a transducer in accordance with an aspect of the present disclosure.

FIG. 23, similar to FIG. 4D, illustrates a beverage cartridge 32 when the brewer head 16 is in a closed position. The inlet nozzle 44 pierces the cover 49 of the beverage cartridge 32, as lid 26 is closed, i.e., moved in the direction of arrow 404. Inlet nozzle optionally rotates or otherwise moves as shown by arrow 408. As part of inlet nozzle 44, flow port 74 is also inserted into the beverage cartridge 32 such that fluid from heater tank 160, or other locations within brewing system 10, may be delivered to beverage cartridge 32. Further, flow port 74 and/or inlet nozzle 44 may be inserted into the beverage medium 78.

As shown in FIG. 4D, beverage medium 78 may be contained in only a portion of beverage cartridge 32, separated by a filter 450 which acts as a screen or sieve to filter out any portions of beverage medium 78 (e.g., coffee grounds, tea leaves, etc.) that may be undesired in the final beverage delivered to the receptacle 268 (e.g., mug, cup, etc.) for consumption.

### Crema Extraction

In an aspect of the disclosure, the receptacle 30, as part of the brewer head 16, may have a second portion 452 that is shaped to deliver the fluid from the beverage cartridge 32 through a conduit 454 before delivering the fluid to receptacle 268. In the embodiment shown, the conduit 454 can be pressurized and/or substantially sealed when the system 10 is operating. Within at least a portion of conduit 454, and possibly extending into second portion 452 of receptacle 30, may be a transducer 2300, energized through wires 2302 that may be controlled by processor 512 (not shown). As described with respect to FIG. 4D and/or FIG. 4G, transducer 2300 may be employed within system 10 in addition to and/or instead of impeller 456 and/or pump 482. Although transducer 2300, impeller 456, and pump 482 are described in further detail herein, it is understood that devices other than impellers, pumps, and/or transducers may be employed within the scope of the present disclosure to degasify fluid from and/or introduce gas into fluid from beverage cartridge 32 and/or container 1800.

As shown in FIG. 4D, transducer 2300 may also be located proximate or even within conduit 454 without departing from the scope of the present disclosure. Seal(s) 2304 help reduce leakage of fluid in conduit 454 around transducer 2300, as well as providing transducer 2300 with the ability to move within conduit 454.

The head 2306 of transducer 2300 imparts mechanical energy at sub-sonic, sonic, and/or ultrasonic frequencies, and is placed at a desired distance from the wall of conduit 454 to create channel 2308. As fluid from outlet nozzle 400 passes through channel 2308, the head 2306 impacts the fluid to apply pressure to fluid within channel 2308, thereby degasifying and/or introducing gas into the fluid. Depending on the frequency and/or frequencies generated by transducer 2300, and/or the duration of transducer 2300 operation, as well as the different types of fluids that may be passed through channel 2308 during transducer 2300 operation, different types and/or qualities of crema may be created, and/or different types of degasification and/or gas introduction may be performed.

System 10, as fluid exits cartridge 32 through outlet conduit 400, may energize transducer 2300 through wire 2302. Energizing transducer 2300 may be performed as a timed sequence after inlet nozzle 44 begins spinning or otherwise moving, by a sensor that senses fluid in the second portion 452 of receptacle 30, or by other methods without departing from the scope of the present disclosure. As transducer 2300 (or other device employed to degasify and/or introduce gases into the fluid) is energized, fluid (i.e., the beverage fluid) flowing through conduit 2308 is aerated and/or otherwise infused with gaseous molecules (e.g., oxygen, carbon dioxide, nitrogen, and/or other gasses), and/or gaseous molecules are removed from the liquid solution, prior to delivery of the beverage fluid to receptacle 268. As such, a crema for espresso and/or an espresso-like beverage or coffee, froth for milk or latte, or other types of aeration of beverage fluid may be created by system 10.

### Temperature Control of Resultant Beverage

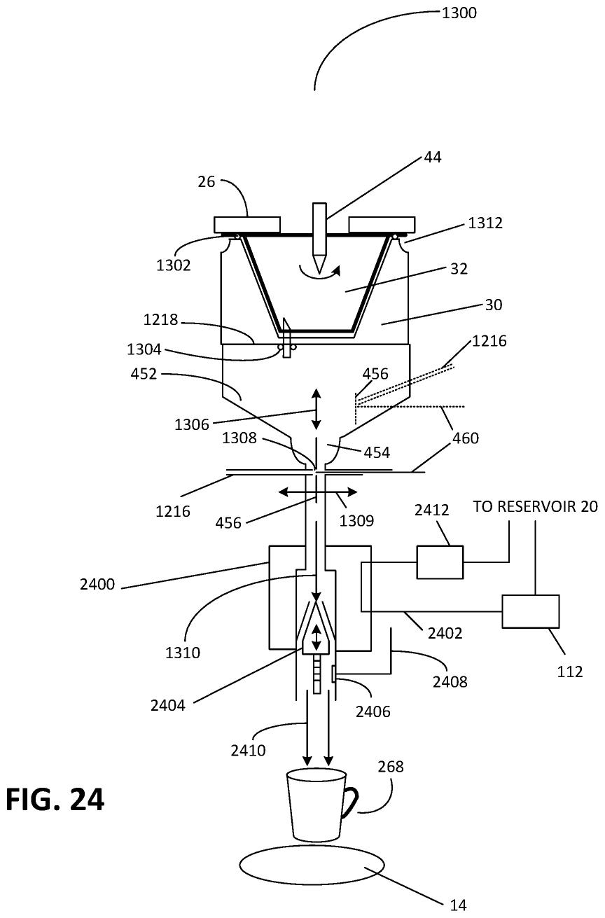

FIG. 24 illustrates a heat exchanger in accordance with an aspect of the present disclosure.

As described with respect to FIG. 15B, beverage cartridge 32 may be cooled by receptacle 30. As such, fluid from reservoir 20 may be used to deliver a cooling thermal mass to keep beverage cartridge 32 at a reduced temperature. Fluid from heater tank 160 may thus be delivered to beverage cartridge at a higher temperature, e.g., at almost 100 degrees centigrade, to brew a beverage 1310 at a higher temperature. Such beverages may include espresso, cappuccino, and/or other beverages 1310, which are made at higher temperatures to extract greater amounts of dissolved solids, oils, and/or other materials from beverage material 78.

Because beverage cartridge 32 is made from plastic, temperature control of beverage cartridge may be important to reduce and/or eliminate leaching of materials from beverage cartridge 32. Compounds such as bisphenol-A (BPA), butylated hydroxyanisole (BHA), and other chemicals may be extracted from the beverage cartridge 32 at elevated temperatures that are employed within system 10. Other compounds may be leached from plastics such as polypropylene (PP), since binders and other filler materials are often intentionally included in PP and/or other plastics to reduce the breakdown of the plastic material. The binders and other materials may create BPA-like and/or BHA-like compounds that could be extracted from beverage cartridge 32 at elevated temperatures. Since these compounds are not desirable in beverage 1310, control of the temperature of beverage cartridge 32 may be important

Further, control of beverage cartridge 32 may increase the safety of system 10, as a beverage cartridge 32 that has been exposed to steam and/or fluids at approximately 100 degrees centigrade may be too hot to be handled after beverage 1310 is produced by system 10. Elevated temperatures of beverage cartridges 32 may pose a safety risk to users that are changing beverage cartridges immediately and/or a short time after brewing a beverage 1310 in system 10.

In an aspect of the present disclosure, when beverage 1310 is brewed at such a high temperature, beverage 1310 may be too hot for immediate human consumption and/or contact with skin. Safety concerns may interfere with higher temperature brewing, reducing the convenience and/or desirability of system 10.

As such, the present disclosure allows for a heat exchanger 2400 which operates similarly to the heat exchanger 30 described with respect to FIG. 15B. Heat exchanger 2400 accepts beverage 1310, and aids in the control of the temperature of beverage 1310 by exchanging the heat of beverage 1310 with heat exchanger 1310. Heat exchanger 2400 may be coupled to reservoir 20 via conduit 2402, to provide a larger thermal mass to heat exchanger 2400. Heat exchanger may be made from thermal material, such as aluminum and/or other metals or alloys, or may be made from plastics such as Ultem® or other high-temperature polymers as desired. Heat exchanger 2400 may also be made as part of heat exchanger 30 if desired.

To further control the temperature of beverage 1310, a valve 2404 may be included as part of heat exchanger 2400, or may be a separate part within system 10 as desired. Valve 2404 may be a needle valve as shown, or may be another type of valve, metering device, and/or control device, such that the valve 2404 controls the time that beverage 1310 is in contact with heat exchanger 2400. A thermistor 2406 with a lead 2408 may be used in conjunction with processor 512 to control how far valve 2404 is open or closed. As valve 2400 is opened, the flow of beverage 1310 is allowed to flow faster across heat exchanger 2400, which may increase the temperature of final beverage 2410. Feedback from thermistor 2406, as controlled by processor 512, can then control the opening and/or closing of valve 2404 to increase and/or reduce the temperature of final beverage 2410. The control of the temperature of final beverage 2410 may be programmed into system 10, and controlled solely by system 10 if desired. In an aspect of the present disclosure, such control may be overridden by the user to allow for users to increase and/or decrease the temperature of final beverage 2410.

Heat exchanger 2400 may be used for espresso final beverage 2410, and/or brewed coffee, which allows for users and/or system 10 to further control the temperature of final beverage 2410. If desired, heat exchanger 2400 may be used to increase the temperature of final beverage 2410, such that the temperature of final beverage 2410 is greater than the temperature of beverage 1310.

Pump 112 may also be employed with heat exchanger 2400, and/or with heat exchanger 30, to circulate fluid from reservoir 20 through heat exchanger 2400 and/or heat exchanger 30. Valve 2412 may also be employed to control the flow of fluid through heat exchanger 2400. Valve 2412 may be a solenoid valve, or may be a needle valve or other type of flow control device, which may also be controlled by processor 512, which may be in further control of the temperature of beverage 2410.

### Jaw Control

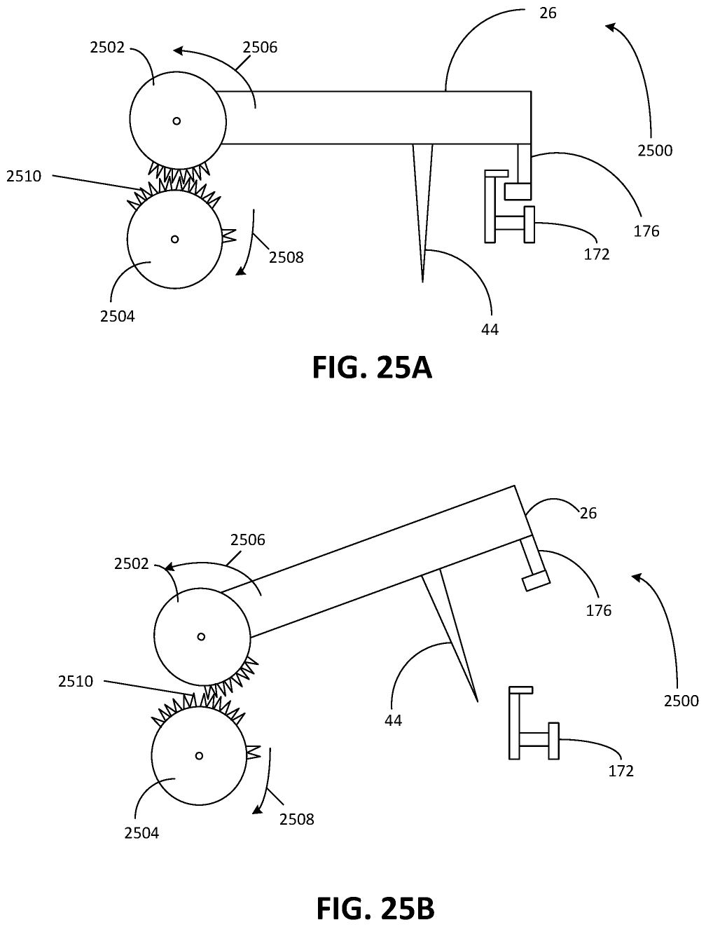

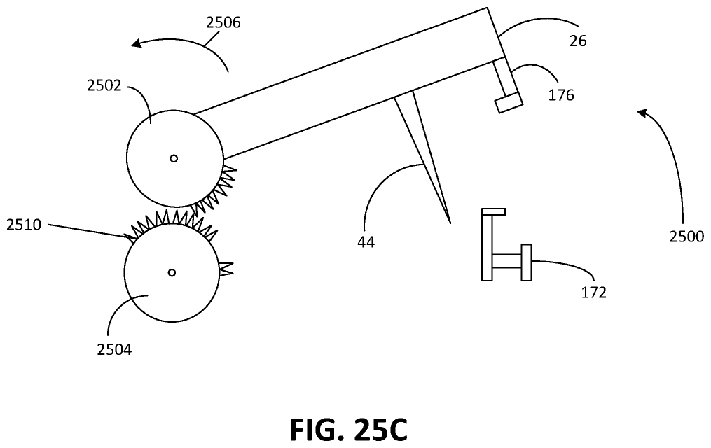

FIGS. 25A-25C illustrate a jaw control in accordance with an aspect of the present disclosure.

In FIG. 25A, lid 26 is shown in a closed position. Jaw lock 176 is closed, and button 172 is in a first position. When button 172 is pressed, jaw lock 176 opens, and lid 26 begins to move in direction 2500.

As lid 26 begins to move, damper 2502 and damper 2504 begin to rotate. Damper 2502 begins to rotate in direction 2506, and damper 2504 begins to rotate in direction 2508. Teeth 2510 on dampers 2502 and 2504 mesh to allow both dampers 2502 and 2504 to slow the speed of lid 26 motion during at least a portion of travel in direction 2500. FIG. 25B illustrates both dampers 2502 and 2504 impeding and/or controlling the speed of lid 26 motion.

FIG. 25C illustrates a point along the travel in direction 2500 where teeth 2510 on dampers 2502 and 2504 no longer engage. When a particular point along the travel in direction 2500 is reached, only damper 2502 controls the speed of lid 26 motion in direction 2500. Damper 2502 may still be rotating in direction 2506, but because teeth 2510 are no longer engaged, damper 2504 is no longer rotating. As such, different speeds of travel for lid 26 in direction 2500 may be controlled by dampers 2502 and 2504. It is envisioned that the point where dampers 2502 and 2504 disengage may be selected such that inlet needle 44 is at a desired point of travel, e.g., the flow port of inlet needle 44 is still engaged in beverage cartridge 32, or may be at some other point along direction 2500. Further, additional dampers 2502 may be employed to provide additional speed control along direction 2500 as desired without departing from the scope of the present disclosure.

### Cartridge Reader

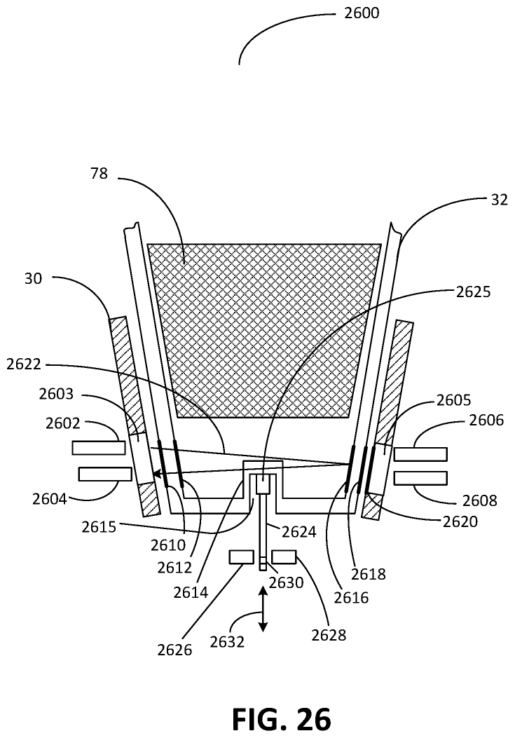

FIG. 26 illustrates a cartridge reader in accordance with an aspect of the present disclosure.

Embodiment 2600 includes a transmitter 2602 and a receiver 2604. Window 2603, which may be partially and/or completely transmissive to the frequencies being transmitted by transmitter 2602, may be included in receptacle 30 proximate transmitter 2602 and/or receiver 2604. Optionally, or in addition, embodiment may also include receiver 2606 and transmitter 2608, and another window 2605, which may be similar and/or different than window 2603, may be included proximate receiver 2606 and transmitter 2608. Transmitters 2602/2608 may be infrared emitters, or may emit other wavelengths of light and/or other radio frequencies as desired. Receivers 2604/2606 may be infrared detectors, or may detect other wavelengths of light and/or other radio frequencies as desired.

Surfaces 2610-2620 may be illuminated by an emission 2622 from transmitter 2602. Other surfaces, and/or the same surfaces 2610-2620, may be illuminated by an emission from transmitter 2608. Surfaces 2610-2620 may be arranged to reflect, refract, or allow transmission through surfaces 2610-2620 of emissions from transmitters 2602/2608. For example, and not by way of limitation, a logo or other identifying mark may be placed on one or more surfaces 2610-2620 to provide a known or discernible image on one or more surfaces 2610-2620 such that a particular beverage cartridge 32 may be differentiated from other beverage cartridges 32. Further, in an aspect of the present disclosure, the material used for beverage cartridge 32 may be doped with specific materials that provide a unique reflection, refraction, and/or transmissivity of the amplitude and/or wavelengths emitted by transmitter 2602 and received by the receiver 2604, such that a unique signature is created based on each individual type of beverage cartridge 32. Such changes in materials may reduce or eliminate the use of changes in topological features, mechanical features, and/or other features on surfaces 2610-2620. Such changes may be additions to surfaces 2610-2620, e.g., an addition to the outside diameter and/or inner diameter of beverage cartridge 32, and/or some changes may be depressions into surfaces 2610-2620, e.g., remove material from the outer diameter and/or inner diameter of beverage cartridge 32.

There are at least two potential concerns with cartridge 32 identification. One such challenge is to manufacture a cartridge 32 that has a unique “signature” that can be determined by system 10. Such cartridge signatures may, in some cases, contain changes in topology, coloration, and/or other variations on the surfaces 2610-2620, or in the material used to manufacture cartridge 32 and/or filter fabric used in cartridge 32, such that the materials and/or topologies create a different reflection, refraction, and/or transmission of the spectra emitted by transmitter (emitter) 2602 that is received by a receiver 2604/2606. This challenge may be referred to as an “origin” or “counterfeiting” challenge, as the origin, brand, or specific manufacturer or source of a given cartridge 32 can then be uniquely determinable and less able to be copied or counterfeited by one or more other manufacturers.

Another challenge with cartridge 32 identification is in the accounting for cartridge 32 usage. If system 10 is used to determine purchases by a given consumer, manufacturers would not want to count a previously used cartridge as an additional purchase and provide a customer with repeated counting of a single cartridge 32 as a plurality of cartridges 32 for such accounting systems. For example, and not by way of limitation, a consumer may accidentally and/or purposefully try to brew multiple beverages from a single cartridge 32, in order to obtain rewards, purchasing credits, and/or other benefits associated with cartridge 32 purchases. Such a challenge may be referred to as a “spoof” challenge, where the consumer is trying to trick system 10 into counting a single cartridge 32 more than once, i.e., after first use of such a cartridge 32.

The transmitter 2602 may transmit one or more frequencies in emission 2622 that are selectively scattered, transmitted, and/or reflected by one or more surfaces 2610-2620 based at least on the topological, angular, and/or mechanical surface irregularities of surfaces 2610-2620. Further, one or more of the surfaces 2610-2620 may occlude or block emission 2622 from reaching one or more of the surfaces 2610-2620. For example, and not by way of limitation, surface 2614 may be arranged, either by angle, surface topology, or surface composition, to completely reflect emission 2622, such that receiver 2606 does not receive any emissions 2622 from transmitter 2602.

Another aspect of the present disclosure allows for receptacle 2615 to receive a plunger 2624 on beverage cartridge 32. Although receptacle 2615 is shown on the bottom surface of beverage cartridge 32, receptacle 2615 may be on any surface of beverage cartridge 32 without departing from the scope of the present disclosure. Plunger head 2625 may also be a transmitter, receiver, or other surface that reflects, refracts, or absorbs transmissions from one or more transmitters 2602 and/or 2608. In such an aspect of the present disclosure, a transmitter 2626 and receiver 2628 may be employed to determine the position of plunger 2624. Plunger 2624 may include an indicator 2630, such that as plunger 2624 moves up and down in direction 2632, e.g., when the plunger 2624 is displaced or not displaced by beverage cartridge 32, system 10 may be alerted to the presence of a specific beverage cartridge 32 in receptacle 30. If plunger 2624 is moved along direction 2632, to a position where indicator 2630 does not allow for transmission from transmitter 2626 to reach, or to fully reach receiver 2628, system 10 may be alerted that a different type of beverage cartridge 32 is present in receptacle 30. Further, transmissions and or receptions from plunger head 2625 may also be used in determining a particular type of cartridge 32 that is present in receptacle 30. The determination of type of beverage cartridge 32 present in receptacle 30 may be performed when lid 26 is in a closed position.

The depth of receptacle 2615 may be determined to align indicator 2630 between transmitter 2626 and receiver 2628. Further, a transmitter/receiver pair, or a transmitter, or a receiver, may be located at plunger head 2625, such that a reflection of sound, light, and/or other desired information may be read or determined from any surfaces that define receptacle 2615, or other locations on the bottom and/or sides of beverage cartridge 32, provides a unique reflection, refraction, and/or scattering profile from each type of beverage cartridge 32.

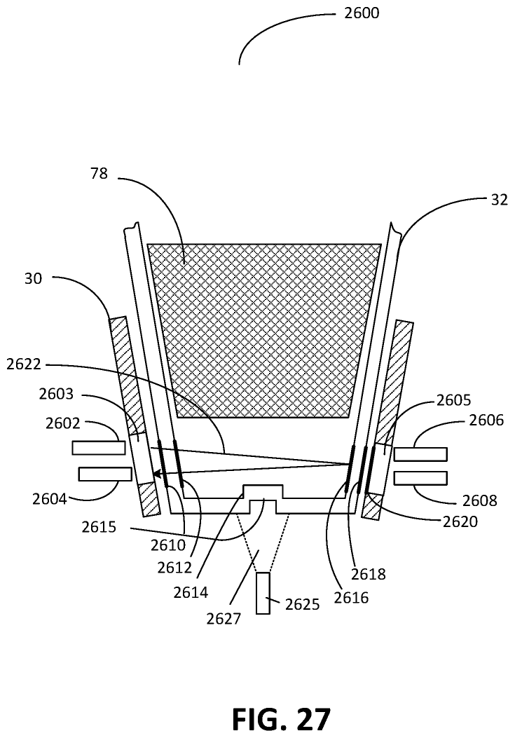

FIG. 27 illustrates a cartridge reader in accordance with an aspect of the present disclosure.

Although shown as within receptacle 2615 in FIG. 26, FIG. 27 illustrates another aspect of the present disclosure where plunger head 2625 transmits and/or receives information 2627 from the bottom of beverage cartridge 32. The area on the bottom of beverage cartridge 32 may include receptacle 2615, but is not required to include receptacle 2615.

In such an aspect, as well as in the aspects of the present disclosure described with respect to FIG. 26, a picture or image may be captured by sensors located in plunger head 2625. For example, and not by way of limitation, a camera sensor and light source may be located in plunger head 2625, or elsewhere within system 10, such that system 10 may capture an image of the bottom of beverage cartridge 32, and/or a portion of the bottom of beverage cartridge 32, and/or at least a portion of any outer surface of beverage cartridge 32.

For beverage cartridges 32 that are to be counted, registered, or otherwise noted as meeting certain characteristics for inclusion in or exclusion from the statistics being monitored by system 10, the image or other captured information from the beverage cartridge 32 may be compared to information stored in memory within system 10. Such comparison can be aided by, for example, system 10 having the processor capability to digitally and/or electronically rotate the image and/or other information from the beverage cartridge 32, digitally and/or electronically re-size the image and/or other information from beverage cartridge 32, etc., such that a more complete comparison may be made between the stored information within system 10 and the information captured from the beverage cartridge 32 that is being employed by system 10.

To assist in avoiding “spoofing” system 10 when such a comparison of the stored image with the image of the beverage cartridge 32 presently in system 10 is made, system 10 may comprise additional verifications that may not be readily apparent to the user. For example, and not by way of limitation, the beverage cartridges 32 may have dyes, dopants, and/or other unique markings that may only be present on and/or in those beverage cartridges, the materials used to make those beverage cartridges 32, etc., in addition to specific images and/or markings that may be present on other beverage cartridges 32 that may not be designed to register and/or be recognized within system 10. Other anti-counterfeiting measures may be employed, such as detection of unique inks, unique shapes, other unique patterns, and/or combinations of such unique markings, and/or detection of varying surface topographies (e.g., detecting topographical measurements of indents, raised markings, patterns, etc.) such that specific beverage cartridges 32 may be identified as well as identified as being genuine as identified by the detection system within system 10 and/or from a specific manufacturing source and/or supplier.

For example, and not by way of limitation, the depth of receptacle 2615 may be a specific depth, whether on a bottom of the beverage cartridge 32 and/or a channel around the circumference of beverage cartridge 32, that is measured by one or more sensors within system 10. The reflectivity, refractive index, and/or transmissivity of one or more surfaces, e.g., the bottom, of beverage cartridge 32 may be specified to be unique to a particular type of beverage cartridge 32. Other additional anti-counterfeiting measures, such as images, logos, etc., as well as employing various wavelengths of light and/or multiple images of the beverage cartridge 32, may also be employed. Further, by designing a particular receptacle 2615, as well as other parts of the bottom and/or sides of beverage cartridge 32, to be viewed as a whole when comparing with the stored version of the image, removing a “genuine” bottom and/or sidewalls and/or portions of a beverage cartridge 32 and placing it in receptacle 30 would prevent another beverage cartridge 32 from being placed on top of the removed “genuine” bottom, sidewalls, and/or portion of beverage cartridge 32 and used within system 10. Other methods and/or combinations of anti-counterfeiting and/or anti-spoofing techniques may also be possible within the scope of the present disclosure.

System 10 may also be calibrated to determine the type of beverage cartridge 32 based on the signature of the emission 2622 from transmitter 2602 that is received at receiver 2604, based on the reflections/refractions/transmissivity of surfaces 2610-2620. In addition, or alternatively, transmitter 2602 may emit a first emission 2622 that is received by receiver 2606, and transmitter 2608 may emit a second emission 2622 that is received by receiver 2604, also based on the reflections/refractions/transmissivity of surfaces 2610-2620. In addition, or alternatively, the status of plunger 2624 may aid in determination of the type of beverage cartridge 32 that is used in system 10.

The presence or absence of fluid in beverage cartridge 32 may also affect the emission 2622. For example, after brewing begins, emission 2622 may be scattered and/or reflected more by the brewed beverage than when emission 2622 is traveling through air underneath filter 450 that contains beverage medium 78. Further, the materials used to create beverage cartridge 32 may be varied, by type, color, thickness, and/or other characteristic, to provide a desired signature for transmission, reflection, and/or refraction of emission 2622, such that unique signatures can be created for each type of beverage cartridge 32.

The type and number of beverage cartridges 32 used in system 10 may be stored by system 10 for later use by system 10 and/or the user. For example, and not by way of limitation, a user that employs a specific type of beverage cartridge 32, e.g., French roast, may want to know how many of that type of beverage cartridge 32 has been used by system 10. System 10, because of embodiment 2600, may have the capability to report such usage, as system 10 can determine how many of each type of cartridge 32 has been used. Various other functions of system 10 may also be employed to determine whether a particular beverage cartridge has been used, e.g., whether lid 26 has been opened and closed, whether the image of the current image of beverage cartridge 32 has been rotated with respect to the prior image (which may prevent the same beverage cartridge 32 from being counted twice), the temperature of beverage cartridge 32 prior to brewing, etc. Further, system 10 can store and/or report such usage to the user when a certain number of cartridges 32 of a specific type have been used by system 10. Such reporting may provide additional benefits to the user, e.g., knowing when to purchase more cartridges 32, frequent buyer rewards for certain cartridges 32, system 10 usage details, and/or other information that may be of assistance to the user, consumers, and/or manufacturers of system 10 and/or beverage cartridges 32.

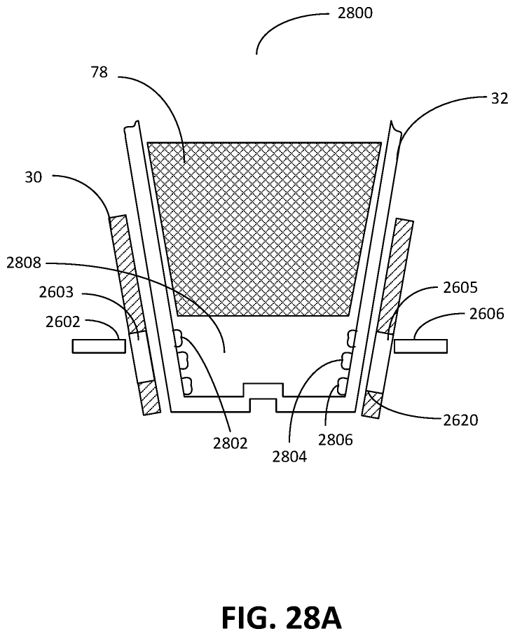

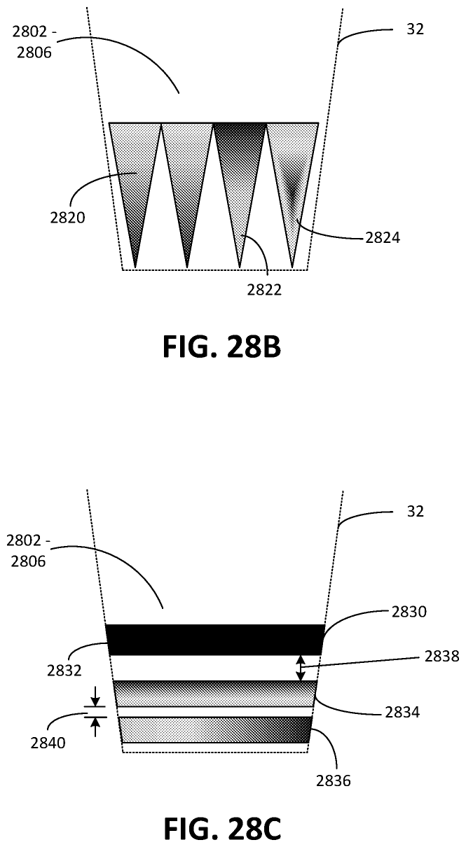

FIGS. 28A-28C illustrate beverage cartridges that may be read by the cartridge reader in an aspect of the present disclosure.

Cartridge 2800 comprises one or more features 2802-2806 on surface 2612. Although shown on the inside of the cartridge 2900, features 2802-2806 may be on one or more surfaces 2610-2618 as desired. Emitter 2602 emits a signal, which may be infrared, visible, or other waves in the electromagnetic spectrum, or any other signal that may be received by detector 2606. As cartridge 2800 is inserted into receptacle 30, the bottom of cartridge 2800 and features 2802-2806 pass between the emitter 2602 and detector 2606 and interrupt and/or otherwise change the transmission from the emitter 2602, either partially or completely, as seen by detector 2606. There may be a smaller or greater amount of features 2802-2806 included with cartridge 2800 without departing from the scope of the present disclosure.

For example, and not by way of limitation, features 2802-2806 may be a gradient surface that gradually reduce, increase, and/or change the transmissivity of cartridge 2800 as cartridge 2800 is inserted into receptacle 30. Further, once the beverage being made by cartridge 2800 passes into volume 2808, the transmissivity of cartridge 2800 may change with respect to cartridge 2800 prior to the beverage entering volume 2808 between emitter 2602 and detector 2608. The amount of transmissivity of the beverage created when liquid is passed through beverage material 78 may also change during the brewing cycle, which also may affect the amount of transmission received at detector 2606. Features 2802-2806 may be different materials, a gradient of materials, shapes of various materials such as triangles, arrays of dots, ridges, and/or any surface and/or material treatment that may change the transmission spectra and/or amplitude that reaches detector 2606. FIGS. 28B-28D illustrate some possibilities that may be incorporated as features 2802-2806 without departing from the scope of the present disclosure.

For example, and not by way of limitation, FIG. 28B illustrates features 2802-2806 as comprising one or more triangles 2810 that are on a surface of beverage cartridge 32. Features 2802-2806 may comprise a gradient 2820, which is less transmissive toward the bottom of cartridge 32 than at the top. Features 2802-2806 may also comprise a gradient 2822, which is more transmissive at the bottom of cartridge 32 than at the top. Features 2802-2806 may also comprise a gradient 2824, which is more transmissive in the middle of features 2802-2806 than at the edge of features 2806. Any combination of gradient transmission is possible without departing from the scope of the present disclosure. Such features 2802-2806 may be on one or more surfaces 2610-2618, and a unique pattern of features 2802-2806, which may provide a unique signal output from detector 2606, may assist in determining the origin and/or uniqueness of a given cartridge 2800.

For example, and not by way of limitation, FIG. 28C illustrates features 2802-2806 as comprising one or more horizontal bands 2830 that are on a surface of beverage cartridge 32. Such features 2802-2806 may be on one or more surfaces 2610-2618. Horizontal bands 2830 may be a single level of transmissivity as shown in band 2832, or may be a gradient band of transmissivity as shown in bands 2834 and 2836. Further, distances 2836 and/or 2838 may be varied between bands 2830 to allow for additional variations in container 2800.

Features 2802-2806 may also be a cross-hatching, pattern imprint, or other solid varying pattern and/or gradient pattern that vary between the bottom of container 2800 through the portion of container 2800 that passes between emitter 2602 and detector 2606. Further, in an aspect of the present disclosure, emitter 2602 may have more than one wavelength and/or signal that the features 2802-2806 have different affects upon. As such, a unique transmissivity for a given cartridge 2800 as received by detector 2606 may be created for one or more emissions from emitter 2602.

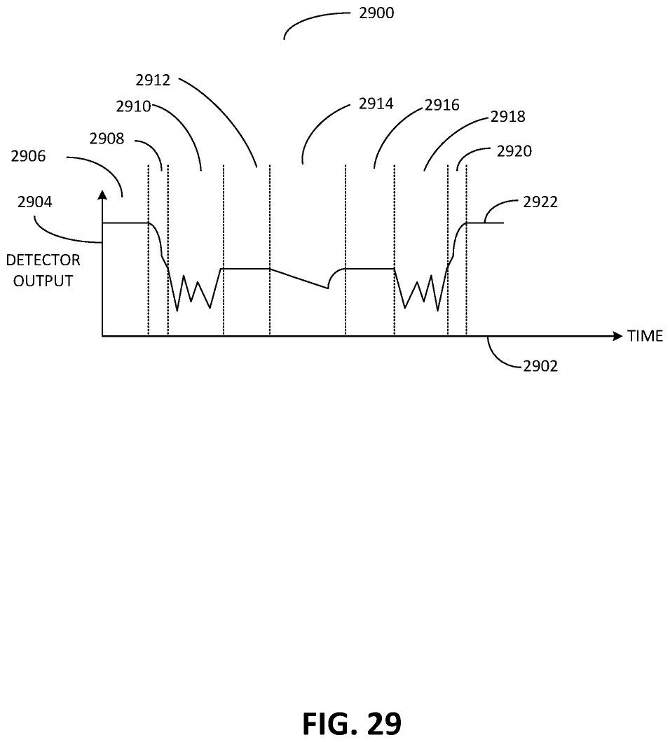

FIG. 29 illustrates an output of a cartridge reader in accordance with an aspect of the present disclosure.

Graph 2900 illustrates time on axis 2902 and detector output on axis 2904. Time period 2906 indicates a period of time when there is no cartridge 32 inserted in receptacle 30. When there is no cartridge 32 in receptacle 30, emitter 2602 transmissions are traveling through air, and reach detector 2606 unimpeded. As such, detector output 2904 is at a high, possibly maximum level.

Time period 2908 indicates a period of time when cartridge 2800 is being inserted into receptacle 30, and the bottom of cartridge 2800 disrupts the transmissions from emitter 2602. Because there is a different material between emitter 2602 and detector 2606, the detector output will be reduced. When the bottom of cartridge 2800 disrupts the beam, or the output of detector 2606 drops below a certain level, this may trigger system 10 to begin responding to changes in detector 2606 output.

Time period 2910 indicates a period of time when features 2802-2806 pass between emitter 2602 and detector 2606. As features 2802-2806 pass between the emitter 2602-2606, the detector output 2904 will vary based on the types of features 2802-2806 present in cartridge 2800. As such, detector output 2904 may provide a unique signature based on the type of cartridge 2800 that is inserted into receptacle 30.

Time period 2912 indicates a period of time after cartridge 2800 has been fully inserted into receptacle 30 but before the brewing of a beverage has started. Because the material between emitter 2602 and detector 2606 is not changing, detector output 2904 may be at a substantially constant level. The constant level during time period 2912 may be lower than that level during time period 2906, because the transmissivity of cartridge 2800 may be less than the transmissivity of air.

Time period 2914 indicates the period of time during brewing a beverage from cartridge 2800. Because the beverage is now in volume 2810, and thus also between emitter 2602 and detector 2606, the transmissivity of the entirety of the material between emitter 2602 and detector 2606 changes. The signature for a given beverage, e.g., coffee, may provide less transmission at the beginning of a brew than at the end of the brew, because additional extraction occurs at the beginning of the brew while less extraction occurs later in the brew.

After a cartridge 2800 has been used, in an aspect of the present disclosure, there are not as many oils and/or extractables to extract from the beverage material 78 in a used cartridge 2800. As such, system 10 may be aware that the detector output 2904 should rise (or drop) to a certain level for an unused cartridge 2800, but was not changed to and/or started from the proper level because a previously used cartridge 2800 has been left in the system 10 or the user is trying to “spoof” system 10 into counting two cartridges when only one cartridge 2800 has been purchased. However, because the transmissions through a previously used cartridge 2700 is different than the transmissions through an unused (“new” or previously uncounted) cartridge 2700, system 10 can account for mistakes and/or attempts at double counting a single cartridge in any recording, accounting, and/or memory storage of cartridges 2700 that have been used. That the brew cycle has been initiated for a given cartridge, and the proper features 2702-2706 have been recognized by system 10, can be aided by the transmissions through the beverage in the cartridge 2700 to avoid double counting and/or spoofing of system 10.

For example, and not by way of limitation, emitter 2602 emits radiation through the sidewalls of a cartridge and through the beverage that is brewed from the beverage material 78 below the filter and above the bottom of the cartridge. The detector 2606 is on the approximate opposite side of the cartridge from the emitter 2602, and as such, only sees transmissions from emitter 2602 that travel through the sidewalls of the cartridge and through the beverage brewed from the beverage material 78 in the cartridge. For the first brew cycle of a given beverage material 78, the beverage material has the largest amount of extractables, and these will darken the resultant beverage more at the beginning of a brew cycle than later on in the brew cycle. If the same cartridge with the same beverage material 78 is used in a second or subsequent brew cycle, the beverage material 78 does not darken the resultant beverage as much as the first brew cycle through that cartridge. As such, the detector 2606 will see a different amount of light (e.g., greater amount lesser) than the first brew cycle, and this difference may assist with avoiding “spoofing” of system 10. System 10 may store the detector 2606 readings in a memory to compare readings for a given cartridge and/or for a certain amount of time that system 10 is operational, such that rapid repeated brewing attempts may be compared and/or a given cartridge may be compared to a stored value associated with that type of cartridge.

After brewing, time period 2916 illustrates the time after brewing but before cartridge 2800 has been removed. At this time, if time periods 2910-2914 have recorded proper detector outputs 2904 for a cartridge 2800, the cartridge 2800 may be entered into the memory of system 10 as part of any accounting, counting, or credit system. If one or more of the time periods 2910-2914 shown an improper reading for detector output 2904, e.g., time period 2914 did not reduce the detector output sufficiently, then system 10 knows not to count this cartridge 2800 as part of any credit, benefit, customer reward, and/or accounting figures.

Time period 2918 is the period where cartridge 2800 is removed from receptacle 30, and time period 2920 is the time period where the bottom of cartridge 2800 passes between emitter 2602 and detector 2606. Time period 2922 is when the cartridge 2800 has been removed from receptacle 30, and emitter 2602 is transmitting through air to detector 2606. This return to a nominal/maximum value for detector output 2904 may be a signal to system 10 to reset the counting mechanism to prepare for determination of whether the next cartridge 2800 will be added to the credit/accounting/counting figures.

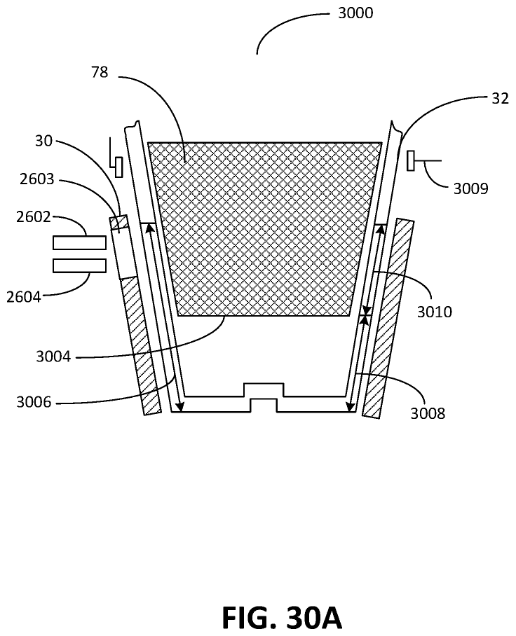

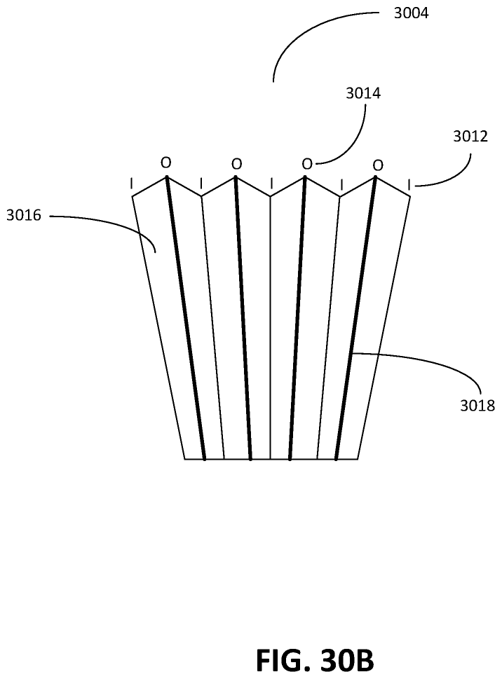

FIGS. 30A-30B illustrate beverage cartridges that may be read by the cartridge reader in an aspect of the present disclosure.

As shown in FIG. 30A, emitter 2602 and detector 2604 are located in system 10 such that reflections/refractions from cartridge 3000 of the transmissions from emitter 2602 are detected by detector 2604. Further, the location of emitter 2602 and detector 2604 are such that any changes in topography, color, reflection and/or refraction from cartridge 32 along length 3002 may be detected by detector 2604.

Features that affect the detector 2604 may be present on one or more surfaces 2610-2618, as well as on other surfaces as desired. Emitter 2602 emits a signal, which may be infrared, visible, or other waves in the electromagnetic spectrum, or any other signal that may be received by detector 2604. As cartridge 3000 is inserted into receptacle 30, the bottom of cartridge 3000 and the features pass in front of the emitter 2602 and reflections and/or refractions from surfaces passing in front of the emitter 2602 are directed toward detector 2604, either partially or completely.

Further, emitter 2602 and detector 2604 are now located such that reflections and/or refractions from beverage material 78 and/or filter 3004 may be detected by detector 2604. As such, features of beverage material 78 and/or filter 3004 may be incorporated into cartridge 3000, and such features and/or changes in such features may be determined by system 10, to address the counterfeiting and/or spoofing challenges described above with respect to FIGS. 26-29.

The reflections and/or refractions from cartridge 32 along distance 3008 may be similar to, or somewhat inverted from, those described with respect to FIGS. 28-29. Because transmission through cartridge 3000 may be affected as described above, the reflections and/or refractions may also be affected in a similar manner, however, the output from detector 2602 may be slightly different in amplitude and/or direction from that described for detector 2606. However, the principles of how the features 2802-2806 within length 3008 would affect the detector output as described above with respect to detector 2606 would also affect detector 2602.

Further, additional features may be added in length 3010, and additional operations of system 10 may be determined if emitter 2602 and detector 2604 are located to detect reflections and/or refractions rather than transmissions from emitter 2602. Combinations of detecting a transmission through cartridge 3000 (and/or cartridge 32/2800) along with reflections and/or refractions from cartridge 3000 (and/or cartridge 32/2800) may be used without departing from the scope of the present disclosure.

Another sensor 3009, which may be a capacitor as shown in FIG. 30A, may sense the capacitance that is changed when the cartridge 3000 is located in system 10. For example, and not by way of limitation, a sensor 3009 that is a capacitor may be coupled with a resistor to create a RC circuit having a fundamental frequency. When the cartridge 3000 is inserted into receptacle 30, the dielectric constant of cartridge 3000 is different than that of air, and thus the fundamental frequency would change. If cartridge 3000 has been used, the residual water in cartridge 3000 would have a different dielectric constant than a dry, unused cartridge 3000. As such, sensor 3009 may aid in determining whether system 10 is being spoofed. Additional and/or different materials may be added to cartridge 3000, either in the outside container or in the filter 3004 that may be read by the sensor 3009 to determine genuineness of cartridge 3000. Sensor 3009 may also be an inductor or other type of sensor without departing from the scope of the present disclosure. Other methods may be used, and/or other additions may be made to the sensing capabilities of the system 10 to aid in determining counterfeit cartridges and/or spoofing system 10 without departing from the scope of the present disclosure.

FIG. 30B illustrates features on a filter paper which may be employed in accordance with an aspect of the present disclosure.

Filter 3004, which may be paper, fabric, and/or other material, comprises a base material 3016. Base material 3016, without alteration, may have a certain reflection and/or refraction of the transmission from emitter 2602.

Additives such as carbon particles and/or other heterogeneous materials (also referred to as “dopant” materials herein) having a different reflection and/or refraction of the transmission from emitter 2602 may be combined with base material 3016 during manufacturing of base material 3016. Such dopants may then provide a unique reflection and/or refraction signature for a given cartridge 3000 to differentiate cartridge 3000 from counterfeit and/or non-reward bearing cartridges in system 10.

Further, during formation of filter 3004, pleats may be pressed into filter 3004. As shown in FIG. 30B, outward facing creases 3012 (i.e., pointing out of the page as viewed in FIG. 30B) and inward facing creases 3014 (i.e., point into the page as viewed in FIG. 30B) may be pressed into filter 3004. During formation of pleats 3012 and 3014, dyes or other variations of reflection and/or refraction may be placed on pleats 3012 and/or 3014. As shown in FIG. 30B, the reflection of inward facing pleats 3014 is unchanged from that of base material 3016, but the outward facing pleats 3012 have a dye, coloration, or other indicia and/or reflective and/or refractive dopant 3018 and/or changing material added. System 10 then would detect, through detector 3004, a specific reflection and/or refraction from a genuine cartridge 3000 that would likely not be present in a counterfeit cartridge 3000. Base material 3016 may also be treated such that after a beverage is brewed, i.e., passes through filter 3004 (which acts as a barrier to the beverage material to reduce and/or prevent the beverage material from exiting the cartridge), such that base material 3016 changes color or has a determined color for reflection from emitter 2002.

In addition to determining genuineness, during brewing, the beverage brewed seeps through filter 3004, and colors the filter 3004 as filter 3004 absorbs some of the oils and/or other dissolved solids as the brewed beverages passes through filter 3004. This change in coloration and/or chemical composition of filter 3004 changes the reflection and/or refraction of filter 3004. Thus, if a consumer were to attempt, accidentally and/or purposefully, to have a genuine cartridge 33/2800/3000 counted more than once by system 10, the change in coloration of filter 3004 would help prevent spoofing of system 10. System 10 would note the change in coloration of filter 3004 as not having the proper reflection and/or refraction as a genuine cartridge 33/2800/3000, and thus not record the usage and/or provide the benefits associated with a genuine cartridge 33/2800/3000. Further, system 10 may selectively remove transmissions from emitter 2602, e.g., chopping the emitter 2602 input signal, etc., and detect the input from detector 2604 to determine whether the signal output from detector 2604 is genuine or being spoofed by the consumer. Other sensors in system 10, such as liquid detection, filter 3604 coloration, changes in reflection during brewing, and/or other factors may be taken into account to determine whether a cartridge 33/2800/3000 is counterfeit or genuine, as well as whether system 10 should count a given cartridge 33/2800/3000 as part of any accounting and/or rewards programs.

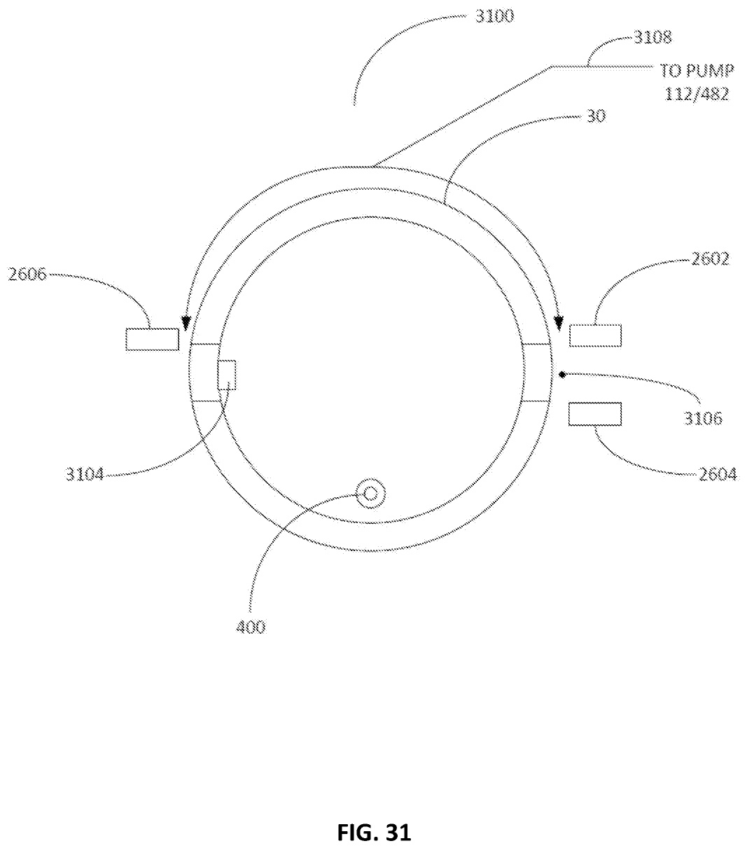

FIG. 31 illustrates a cartridge reader in accordance with an aspect of the present disclosure.

Reader 3100 is shown from a top view in FIG. 31, and shows receptacle 30 with outlet nozzle 400. Emitter 2602 emits into receptacle 30, and once a beverage cartridge 32 (and/or 2800 and/or 3000) is inserted into receptacle 30, asymmetrical rib 3004 position the beverage cartridge 32/2800/3000 into receptacle 30. Asymmetrical rib 3004 may urge the outer diameter of beverage cartridge 32 in close abutment to, engagement with, and/or proximity with emitter 2602 and detector 2604. Such urging of beverage cartridge 32 may provide more consistency of readings from detector 2604, because cartridge 32 may now be at a consistent distance from emitter 2602 and detector 2604. Asymmetrical rib 3004 may be at least one protrusion, rib, and/or other changes in profile of the interior of receptacle 30. Further, asymmetrical rib 3004 may urge beverage cartridge away from the center axis of receptacle 30 and may bring the outside diameter of beverage cartridge 32 closer to emitter 2602 and/or detector 2604. Asymmetrical rib 3004 may be located at any location within receptacle 30 without departing from the scope of the present disclosure.

In an aspect of the present disclosure, asymmetrical rib 3104 may place beverage cartridge 32/2800/3000 in a slightly offset position with respect to the center of receptacle 30. Asymmetrical rib 3104 positions cartridge 32/2800/3000 such that a sidewall of beverage cartridge 32/2800/3000 is positioned closer to emitter 2602 as beverage cartridge 32/2800/3000 is inserted into receptacle 30.

Asymmetrical rib 3104 is shown as much larger than ribs 3102, however, asymmetrical rib may be larger or smaller depending on the sensitivity of detector 2604. Further, asymmetrical rib 3104 may dimple or indent beverage cartridge 32/2800/3000 without departing from the scope of the present disclosure.

Asymmetrical rib 3104 may be placed substantially opposite a midpoint 3106 between emitter 2602 and detector 2604. The placement of asymmetrical rib 3104 may affect the amount of reflections of emissions from emitter 2602 that are received by detector 2604.

Although shown as extended away from receptacle 30 in FIG. 31, emitter 2602, detector 2604, and detector 2606 may be placed within receptacle 30, or at a much smaller distance from receptacle 30, without departing from the scope of the present disclosure. Because emitter 2602, detector 2604, and detector 2606 may be exposed to a variety of environmental conditions, e.g., steam, heat, brewed beverages, etc., in an aspect of the present disclosure, air conduit 3108 may force an air stream from pump 112/482 across the output of emitter 2602 and the input surface(s) of detectors 2604 and 2606, which may reduce the build-up of film on the detectors and emitter(s). Such air flow, or other protective measures, may increase the precision and/or consistency of measurement of the reflections and/or transmissions within system 10.

As beverage cartridge 32/2800/3000 is inserted into receptacle 30, asymmetrical rib 3104 may position beverage cartridge 32/2800/3000 closer to emitter 2602 and detector 2604. Once detector 2604 begins receiving reflections from a sidewall of beverage cartridge 32/2800/3000, and/or once detector 2606 begins receiving reduced reflections because of the presence of beverage cartridge 32/2800/3000, system 10 is receiving information that a beverage cartridge 32/2800/3000 has been inserted into system 10. Further, system 10 has information regarding the position of lid 26 as described with respect to FIGS. 25A-25C. System 10 has information regarding whether a request has been made for a brew cycle and may also have information as to how long of a time period has elapsed since a brew cycle has taken place. Such information, along with whether signals from detectors 2604/2606 have changed, may also assist system 10 in determining whether a given beverage cartridge 32/2800/3000 is genuine and/or being re-used. Such information may also be of assistance to a user of system 10, as a user may be unaware that a beverage cartridge 32/2800/3000 was inadvertently left in receptacle 30.

Other sensors (such as those described with respect to FIGS. 10 and/or 30A) may also be used to determine genuineness and/or re-use of beverage cartridge 32/2800/3000. For example, and not by way of limitation, thermistors and/or infrared detectors may be used to determine the temperature of beverage cartridge 32/2800/3000, which may be useful in determining whether beverage cartridge 32/2800/3000 was recently used in system 10 or elsewhere. Further, if beverage cartridge 32/2800/3000 is not present, emitter 2602 and detector(s) 2604-2606, and/or other sensors, may indicate to a user that no beverage cartridge 32/2800/3000 is present or a used beverage cartridge 32/2800/3000 is present. If a user only wants to brew hot water using system 10, users may be given a choice by system 10 to do so; however, such a choice may be given prior to a brew cycle beginning so any unwanted brewing, or any unwanted second use of a given beverage cartridge 32/2800/3000, takes place.

System 10 may also include a transfer mechanism (e.g., wi-fi, internet, etc.) for the accounting of genuine and/or non-spoofed cartridges 32 that system 10 has verified and/or added to memory. For example, and not by way of limitation, system 10 may transfer the number of genuine cartridges 32 to a user's cellular telephone via wi-fi, text, internet connection, etc., such that the user may bring their cellular telephone to a store for redemption of any credits the user has received.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to brewers. Of course, if the brewer is inverted, above becomes below, and vice versa. Additionally, if oriented sideways, above and below may refer to sides of a brewer. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What is claimed is:

1. An apparatus, comprising:
a receptacle capable of receiving a single-serve beverage cartridge containing at least an outer surface;
at least one transmitter, in which the at least one transmitter transmits at least a first frequency through at least a portion of the receptacle;
at least one receiver, in which the at least receiver receives the at least first frequency from the transmitter after the at least one frequency has been transmitted through the at least a portion of the receptacle, in which the receiver receives at least one of a transmission of the at least first frequency through the outer surface, a reflection of the at least first frequency from the outer surface, and a refraction of the at least first frequency from the outer surface of the beverage cartridge.

2. The apparatus of claim 1, in which the outer surface comprises a topology such that the topology provides a unique amount of reflection, refraction, and/or transmission of the at least first frequency.

3. The apparatus of claim 1, in which the outer surface comprises a variation in color such that the variation in color provides a unique amount of reflection, refraction, and/or transmission of the at least first frequency.

4. The apparatus of claim 1, in which the outer surface comprises a variation in color such that the variation in color provides a unique amount of reflection, refraction, and/or transmission of the at least first frequency.

5. The apparatus of claim 1, in which the single-serve beverage cartridge comprises at least one material such that the at least one material is selected to provide a unique amount of reflection, refraction, and/or transmission of the at least first frequency.

6. The apparatus of claim 1, in which the at least one transmitter selectively transmits the at least first frequency at multiple times during a brew cycle.

7. The apparatus of claim 6, in which at least one of the transmission of the at least first frequency through the outer surface, the reflection of the at least first frequency from the outer surface, and the refraction of the at least first frequency from the outer surface of the beverage cartridge varies during the brew cycle.

8. The apparatus of claim 7, in which the at least one of the transmission of the at least first frequency through the outer surface, the reflection of the at least first frequency from the outer surface, and the refraction of the at least first frequency from the outer surface of the beverage cartridge is reduced during the brew cycle.

9. The apparatus of claim 7, in which the receptacle further comprises at least one window, such that at least one of the at least one transmitter transmits the at least first frequency through the at least one window and the at least one receiver receives the at least first frequency through the at least one window.

10. The apparatus of claim 9, in which the at least one receiver receives at least one of a transmission of the at least first frequency through a second surface of the single-serve beverage cartridge, a reflection of the at least first frequency from the second surface of the single-serve beverage cartridge, and a refraction of the at least first frequency from the second surface of the single-serve beverage cartridge.

11. The apparatus of claim 1, in which the outer surface scatters the at least first frequency, and the at least one receiver receives a portion of the scattered at least first frequency.

12. The apparatus of claim 11, in which the amount of scattering performed by the outer surface varies during a brew cycle.

13. The apparatus of claim 1, further comprising a plunger head, coupled to the receptacle, such that the plunger head is contacted when the single-serve beverage cartridge is placed into the receptacle.

14. The apparatus of claim 1, further comprising in which when the at least one receiver receives at least one of a transmission of the at least first frequency through the outer surface, a reflection of the at least first frequency from the outer surface, and a refraction of the at least first frequency from the outer surface of the beverage cartridge that corresponds to a predetermined response of the at least one receiver, the correspondence is stored in the apparatus.

15. The apparatus of claim 14, in which a predetermined number of correspondences provides for an additional benefit to a user of the apparatus.
